(19) United States
(12) Patent Application Publication
(10) Pub. No.: US 2025/0052673 A1
(43) Pub. Date: Feb. 13, 2025

(54) SPECTROSCOPIC SOLUTION FOR NON-DESTRUCTIVE QUANTIFICATION OF ONE OR MORE CHEMICAL SUBSTANCES IN A MATRIX COMPRISING COATING AND BULK MATERIAL IN A SAMPLE, SUCH AS COATED SEEDS, USING MULTIVARIATE DATA ANALYSIS

(71) Applicant: BAYER AKTIENGESELLSCHAFT, Leverkusen (DE)

(72) Inventors: Andreas IDE, Leverkusen (DE); Danila Monte CONCEICAO, Sao Paulo (BR); Marcus BRAND, Leverkusen (DE)

(21) Appl. No.: 18/719,441

(22) PCT Filed: Dec. 9, 2022
(86) PCT No.: PCT/EP2022/085107

§ 371 Date: Jun. 13, 2024

(30) Foreign Application Priority Data
Dec. 15, 2021 (EP) 21214876.1

(51) Int. Cl. G01N 21/3563; G01N 21/359; G01N 21/65; G01N 21/84

(52) U.S. Cl. CPC G01N 21/3563; G01N 21/359; G01N 21/65; G01N 21/84; G01N 2021/8427; G01N 2021/8466; G01N 2201/1293

(57) ABSTRACT

The present invention relates to a solution for non-destructive quantification of one or more chemical substances in a matrix comprising coating and bulk material in a sample, for example coated seeds, using Infrared Spectroscopy data of the sample and a computer-implemented multivariate data analysis

### FIELD OF THE INVENTION

The present invention relates to a solution for non-destructive quantification of one or more chemical substances in a matrix comprising coating and bulk material in a sample, for example coated seeds, using Infrared Spectroscopy data of the sample and multivariate data analysis.

### BACKGROUND OF THE INVENTION

In order to ensure seed health during storage, seeding, imbibition and in the early phase of plant growth, seeds are usually coated with biological, physical and chemical agents. Formulations of these individual agents or mixtures thereof are often denoted “seed dressings” or “seed coatings”. The applied agents (more generally referred to as chemical substance(s) of interest or active ingredient(s)) may be pesticides, fertilizer, nutrients (including inoculants), biologics, or mixtures thereof. Other compounds may be coated on seeds to provide a specific function which may be, but is not limited to, identification, coloration, drying, flowability, etc.

For all the agents that may be coated on seeds the determination of the actual loading may be necessary for quality, regulatory, efficiency or cost reasons. Several methods are available to quantify or semi-quantify the afore mentioned agents on seeds, e.g. visual inspection, photometric methods, HPLC, GC etc., As for all analytical tools, these described methods strongly differ in their physical nature (read out parameter), accuracy, ease of handling, time demand, steps, etc. If complex mixtures are coated on seeds, the current standard to achieve high accuracy for agent quantification is always based on chromatographic separation (ref. HPLC, UPLC, GC). These methods are also called reference method for analysis. Any chromatographic method for the quantification of actives on seeds will require a solvent extraction step in order to transfer the agent into a measurable form. The extraction process itself is characterized by a couple of disadvantages e.g.: a) high effort in hands-on work and resources, b) requires solvents or water-based extraction mixtures, c) need to consider physico-chemical stability of agent in extraction medium, d) not suitable if non-reproducible or highly time-dependent partitioning of active in the extraction media. Furthermore, currently employed HPLC methods for active analysis often cover one agent (or one active ingredient) in a multi-agent recipe. This is mainly due to the effort of sample preparation, individual partitioning, stability properties of the agent and associated cost.

The use of spectroscopic means for identification and quantification of chemical substances is known for many years. Spectroscopic methods have been described as a non-destructive method (spectroscopic surface measurement—IR either mid-IR or near-IR) with little or no sample preparation for analysis of one pesticide on coated seeds. Pigeon et al. describe such a method wherein spectra of a coated seed sample are acquired from 400 to 2500 nm in reflection mode. Quantification requires calibrations consisting in measuring spectra of reference samples of coated seeds with pesticide of interest; said reference samples are selected based on the repartition of spectra in a multidimension space using Principal Component Analysis (PCA). Said reference samples are analyzed by a reference method (chromatography); NIR Spectra for a reference sample are acquired seed by seed. Collected data are used to establish a predictive model connecting spectral data to reference analytical results (calibration equations) using the Modified Partial Least Square regression method (MPLS). Calibration equations are validated using further samples of known compositions (validation samples and related validation data). The validated calibration equations can be used to analyze unknown samples of the coated seeds; calibration is specific for seed and pesticide. [O. Pigeon et al. “NEAR INFRARED SPECTROSCOPY (NIR): A NON-DESTRUCTIVE, RAPID AND ACCURATE METHOD TO DETERMINE IMIDACLOPRID ON SUGAR BEET PELLETED SEEDS, Proceedings of the 64^{th} IIRB Congress, June 209.1, Bruges (B); O. Pigeon et al., Study of the Quality of Seed Treatments with Plant Protection Products using Near Infrared Spectroscopy. PhD thesis, Faculté Universitaire des Sciences Agronomiques de Gembloux, Belgium (2003)].

However, the method of Pigeon et al. is limited to the quantification of only one active ingredient on coated seeds.

U.S. Pat. No. 5,900,944A describes a solution for indirect quantitative spectral analysis of pesticides with fluorescent pigments, wherein pigment is quantified on cotton seeds coated with a mixture of Gaucho® (imidacloprid) and a fluorescent pigment. The spectral analysis includes the pesticide analysis device emitting white light incident on a seed sample and detecting the transmitted light therefrom, wherein the detected light is in a range of 400-700 nm (for detection of the selected pigment). An analysis of the spectral data is performed to determine absorbance and color saturation data by the pesticide analysis device. Quantification is achieved using linear relationships between color saturation and quantity of pigment or pigment, obtained by conducting series of spectral tests on seeds samples having differing known ratios of pesticide to pigment.

Using a pigment in seed coating for the purpose of quantification is not desirable. Quantification of multiple active ingredients with such linear calibration method is not possible.

Influence of size and form of the seeds, of background, multiple active ingredients and coating components beyond active ingredients are not considered.

### SUMMARY OF THE INVENTION

Considering seed dressings are very often complex mixtures that are applied as a very thin layer (usually few nm to μm) on the seeds, based on volume, most of the spectral information of a sample is related to the seed itself. In addition, the complex mixture of components of the seed dressing will cause a superimposing of the individual compound specific spectra, most challenging for simple data evaluation. As the seeds have a certain variation in size and shape and the treatment is often not 100% equally distributed on the seeds, the spectroscopic method must also be able to handle these inhomogeneities.

There is therefore a need for a solution which is able to distinguish the spectral information originating from the seeds, or more generally originating from the matrix comprising the bulk material and the coating ingredients other that the chemical substance(s) of interest, and the spectral signature of the actual chemical substance(s) of interest. Such solution should be a facile and fast, non-destructive method for full quantification of all active ingredients using data collected in one sample measurement run, solving the problems mentioned above.

The object underlying the invention is achieved by the combination of features according to independent claims. Exemplary embodiments of the invention can be gathered from dependent claims.

The invention is described in more detail without any division within the subject matter of the invention (process and system). The explanations below are intended to be applicable analogously to all the subject matters of the invention, in either context (process or system).

In the present invention the problem mentioned above was overcome by a computer-implemented method for non-destructive quantification of one or more chemical substances of interest on coated bulk material in a matrix, said matrix being defined by its coating components and said bulk material, said method comprising the following steps:
a. Acquiring one or more spectrum representative of a sample of the coated bulk material, wherein said spectrum is a near-infrared, infrared or a Raman spectrum,
b. Selecting one or more calibrations for multivariate data analysis based on the one or more chemical substances to be quantified, wherein the selected calibration is specific to the chemical substance to be quantified in the matrix and wherein said calibration comprises conducting spectrum pretreating steps and a multivariate data analysis using a multivariate correlation model trained for computing a loading value of the chemical substance(s) based on a signature spectrum relevant for the chemical substance(s) at stake in consideration of matrix influences;
c. Computing the spectrum signature relevant for the chemical substance(s) by way of running the spectrum pretreating steps of the one or more calibrations for the one or more spectrum representative of the sample;
d. Computing loading value of the chemical substance(s) using the correlation model(s) of the one or more calibrations;
e. Causing output of the computed loading value of the chemical substance(s), for example display on a user interface or causing transfer said value to a device configured to control a coating process.

The term “loading value” as used herein means weight of active agent or volume of seed treatment composition (also referred to as formulated active agent) per unit coated bulk material. Weight or volume per unit for coated seeds may be defined for 1 seed, 60.000 seeds, kg, dt as needed.

In an example of the invention, spectroscopic data for a sample is acquired by RAMAN, mid-infrared or near-infrared spectroscopy, preferred mid-IR or near-IR, typically by acquiring one or more spectra representative of a sample in a corresponding spectroscopic apparatus in reflection mode. The term “infrared” as used herein is intended to encompass the spectral range above approximately 200 cm⁻¹ and includes both the near IR and the (mid-)IR. The term “-mid-IR”, as used herein, refers to the spectral range from about 200 cm⁻¹ to 4000 cm⁻¹, while the term “near-IR” refers to the spectral range from about 4000 cm⁻¹ to 12000 cm⁻¹ and the term “RAMAN” refers to the spectral range from about 0 nm to 2500 nm

In an example more than one spectrum is acquired for the sample. Such plurality of spectra may be obtained by acquiring spectra from different subsets of a sample, stirring, rotating the sample in the spectroscopic apparatus or a combination thereof, so that more than one spectrum of the sample is representative of the sample. Spectra may be averaged before further treatment or each spectrum can be used for quantification and results can be averaged for the sample loading value.

The term “chemical substance to be quantified” or “chemical substance of interest” as used herein refers to either one active agent of interest in a coating formulation or several active agents in a combination formulation for coating (i.e. CropStar® which comprises Imidacloprid and Thiodicarb). In case a combination formulation is used, seed loading for the combination formulation is quantified. In case a seed treatment package (also called applied plant protection product) comprising multiple seed dressings—single substance dressing, combination formulations or a combination thereof—is used, the loading value for the respective seed dressings can be obtained with the method of the invention. For example, for seeds treated with a standard seed treatment package comprising the combination formulations CropStar® (i.e. Imidacloprid+Thiodicarb), and Derosal Plus® (i. e. Carbendazim+Thiram), loading values for CropStar® and for Derosal Plus® can be obtained with the solution of the invention.

The term “matrix” as used herein is given a broad meaning and comprises all elements other as the chemical substance to be quantified, in particular coating and/or treatment material as well as the bulk material, on which the treatment and/or the coating is applied. The coating is typically applied in a continuous solid phase and comprises one or more binder compounds and vacancies, voids or spaces occupied by the active agent(s) and filler. The term matrix may include what may be viewed as a matrix system, a reservoir system or a microencapsulated system comprising the bulk material. In general a ‘matrix system’ consists of one or more active ingredient(s) and filler uniformly dispersed within a polymer. A “reservoir system” consists of a separate active agent phase, active agent particles physically dispersed within a surrounding, rate limiting polymeric phase. Microencapsulation includes the coating of small particles. The term microencapsulation has not only been applied to coated particles but also to dispersions in a solid matrix. Without being limited to the specific encapsulating system (matrix, reservoir or microencapsulated) the term matrix is meant to be inclusive of the above listed systems.

In an example, the present invention is used for samples of coated seeds. This preferred embodiment is explained in somewhat greater detail below, but without any intention of restricting the invention to this embodiment.

In an example the more than one spectrum is acquired for a sample made of a plurality of seeds.

The term “seed” as used herein refers to the ripened ovule of gymnosperms and angiosperms, which contains an embryo surrounded by a protective cover. In particular, the term covers cereal kernels. The protective cover can comprise the seed coat (testa). Some seeds comprise a pericarp or fruit coat around the seed coat. In particular when this layer is closely adhered to the seed, as in cereal kernels, it is in some cases referred to as a caryopsis or an achene. As used herein, the term “seed coat” includes a caryopsis or an achene. In practical terms, the term “seed” includes but is not restricted to anything that can be planted in agriculture to produce plants, including pelleted seeds, true seeds, plant seedlings, rootstock, plant cuttings and plant parts such as a tuber or bulb.

The seed may be of the order of Monocotyledoneae or Dicotyledoneae. Virtually the sample may be of any plant seed, such as cereals, vegetables, ornamentals, and fruits. Particular plant seeds are selected from the group of corn (sweet and field), soybean, wheat, barley, oats, rice, maize, potato, sugar cane, sugar beet, cotton, sunflower, alfalfa, sorghum, rapeseed, Brassica spp., tomato, pepper, cucumber, melon, watermelon, onion, lettuce, spinach, leek, bean, carrot, tobacco and flower seed, for example, pansy, impatiens, petunia and geranium. Crop plants can be plants which can be obtained by conventional breeding and optimization methods or by biotechnological and genetic engineering methods or combinations of these methods, including the transgenic plants and including the plant varieties which can or cannot be protected by varietal property rights.

A wide range of materials and/chemical substances is used in seed surface treatments or coatings.

The term “surface treatment” as herein refers to a selective modification of the outer surface of the seed, on which a coating can be applied, typically without substantially modifying inner parts of the seed.

The term “coating” as used herein refers broadly to applying material to a surface of a seed, for instance as a layer of a material around a seed. Coating includes but is not limited to formulated active agent, film coating, pelleting, and encrusting. Pellets obtained with pelleting are also known as seed pills. The coating is preferably applied over substantially the entire surface of the seed, such as over 90% or more of the surface area of the seed, to form a layer. However, the coating may be complete or partial, for instance over more than 20%, or more than 50% of the surface area of the seed.

The terms “seed treatment composition”, “seed coating composition” or “formulated active agent” refer to a composition to be used for treatment or coating of seed comprising active agents, possibly after combination of the composition with other compositions, such as Plant Protective Products (PPP) formulations and/or diluents such as water. Hence, the term includes as well as coating formulation which are not yet mixed with PPP formulations and/or not yet applied as treatment or coating. The application of one or more active agent(s) as a dust, slurry or the like is a well-known practice in the art and is considered a coating within the meaning of the term used herein.

In an embodiment the solution of the invention is used for treated seeds, seeds coated with one or more film layers or seeds after treatment and coating process, means treated and coated seeds.

Typically, the one or more chemical substances to be quantified in a non-destructive manner in such seed samples are biological active agents.

The biologically active agent may be an agent selected to protect the seed from pests, bacteria, fungi, nematodes, birds other animals or selected to promote growth, such as an antimicrobial agent, bactericide, pesticide, acaricide, insecticide, fungicide, nematicide, molluscicides, repellent, ovicide, rodenticide, herbicide, herbicidal safener, microbiological, fertilizer, phytotonic, sterilant, safeners, semiochemical, plant defense modulator, plant growth regulator, nutrients, soil conditioning agents selected to promote germination and/or growth.

The biologically active agent may be employed as a mixture comprising one or more active agents. Suitable pesticides include those listed herein and those listed in The Pesticide Manual, 9th Ed., Editor, Charles Worthing, published by the British Crop Protection Council or can be found on the Internet (e.g. http://www.alanwood.net/pesticides). The classification is based on the current IRAC Mode of Action Classification Scheme at the time of filing of this patent application.

A combination of active agents may be coated in separate layers or alternatively may be combined in one or more coating layers.

All named mixing partners can, if their functional groups enable this, optionally form salts with suitable bases or acids, in particular in the form of biologically acceptable salts such as sodium, potassium, ammonium and the like.

Examples for herbicides are:
Acetochlor, acifluorfen, acifluorfen-sodium, aclonifen, alachlor, allidochlor, alloxydim, alloxydim-sodium, ametryn, amicarbazone, amidochlor, amidosulfuron, aminocyclopyrachlor, aminocyclo-pyrachlor-potassium, aminocyclopyrachlor-methyl, aminopyralid, amitrole, ammoniumsulfamate, anilofos, asulam, atrazine, azafenidin, azimsulfuron, beflubutamid, benazolin, benazolin-ethyl, benfluralin, benfuresate, bensulfuron, bensulfuron-methyl, bensulide, bentazone, benzobicyclon, benzofenap, bicyclopyron, bifenox, bilanafos, bilanafos-sodium, bispyribac, bispyribac-sodium, bromacil, bromobutide, bromofenoxim, bromoxynil, bromoxynil-butyrate, -potassium, -heptanoate, and -octanoate, busoxinone, butachlor, butafenacil, butamifos, butenachlor, butralin, butroxydim, butylate, cafenstrole, carbetamide, carfentrazone, carfentrazone-ethyl, chloramben, chlorbromuron, chlorfenac, chlorfenac-sodium, chlorfenprop, chlorflurenol, chlorflurenol-methyl, chloridazon, chlorimuron, chlorimuron-ethyl, chlorophthalim, chlorotoluron, chlorthal-dimethyl, 3-[5-chloro-4-(trifluormethyl)pyridine-2-yl]-4-hydroxy-1-methylimidazolidine-2-on, chlorsulfuron, cinidon, cinidon-ethyl, cinmethylin, cinosulfuron, clacyfos, clethodim, clodinafop, clodinafop-propargyl, clomazone, clomeprop, clopyralid, cloransulam, cloransulam-methyl, cumyluron, cyanamide, cyanazine, cycloate, cyclopyranil, cyclopyrimorate, cyclosulfamuron, cycloxydim, cyhalofop, cyhalofop-butyl, cyprazine, 2,4-D, 2,4-D-butotyl, -butyl, -dimethylammonium, -diolamin, -ethyl, -2-ethylhexyl, -isobutyl, -isooctyl, -isopropylammonium, -potassium, -triisopropanolammonium, and -trolamine, 2,4-DB, 2,4-DB-butyl, -dimethylammonium, -isooctyl, -potassium, and -sodium, daimuron (dymron), dalapon, dazomet, n-decanol, desmedipham, detosyl-pyrazolate (DTP), dicamba, dichlobenil, 2-(2,4-dichlorobenzyl)-4,4-dimethyl-1,2-oxazolidin-3-one, 2-(2,5-dichlorobenzyl)-4,4-dimethyl-1,2-oxazolidin-3-one, dichlorprop, dichlorprop-P, diclofop, diclofop-methyl, diclofop-P-methyl, diclosulam, difenzoquat, diflufenican, diflufenzopyr, diflufenzopyr-sodium, dimefuron, dimepiperate, dimethachlor, dimethametryn, dimethenamid, dimethenamid-P, dimetrasulfuron, dinitramine, dinoterb, diphenamid, diquat, diquat-dibromid, dithiopyr, diuron, DNOC, endothal, EPTC, esprocarb, ethalfluralin, ethametsulfuron, ethametsulfuron-methyl, ethiozin, ethofumesate, ethoxyfen, ethoxyfen-ethyl, ethoxysulfuron, etobenzanid, F-5231, i.e. N-{2-chloro-4-fluoro-5-[4-(3-fluoropropyl)-5-oxo-4,5-dihydro-1H-tetrazol-1-yl]phenyl}ethanesulfonamide, F-7967, i. e. 3-[7-chloro-5-fluoro-2-(trifluoro-methyl)-1H-benzimidazol-4-yl]-1-methyl-6-(trifluoromethyl)pyrimidine-2,4(1H,3H)-dione, fenoxaprop, fenoxaprop-P, fenoxaprop-ethyl, fenoxaprop-P-ethyl, fenoxasulfone, fenquinotrione, fentrazamide, flamprop, flamprop-M-isopropyl, flamprop-M-methyl, flazasulfuron, florasulam, fluazifop, fluazifop-P, fluazifop-butyl, fluazifop-P-butyl, flucarbazone, flucarbazone-sodium, flucetosulfuron, fluchloralin, flufenacet, flufenpyr, flufenpyr-ethyl, flumetsulam, flumiclorac, flumiclorac-pentyl, flumioxazin, fluometuron, flurenol, flurenol-butyl, -dimethylammonium and -methyl, fluoroglycofen, fluoroglycofen-ethyl, flupropanate, flupyrsulfuron, flupyrsulfuron-methyl-sodium, fluridone, flurochloridone, fluroxypyr, fluroxypyr-meptyl, flurtamone, fluthiacet, fluthiacet-methyl, fomesafen, fomesafen-sodium, foramsulfuron, fosamine, glufosinate, glufosinate-ammonium, glufosinate-P-sodium, glufosinate-P-ammonium, glufosinate-P-sodium, glyphosate, glyphosate-ammonium, -isopropylammonium, -diammonium, -dimethylammonium, -potassium, -sodium, and -trimesium, H-9201, i.e. 0-(2,4-dimethyl-6-nitrophenyl) O-ethyl isopropylphosphoramidothioate, halauxifen, halauxifen-methyl, halosafen, halosulfuron, halosulfuron-methyl, haloxyfop, haloxyfop-P, haloxyfop-ethoxyethyl, haloxyfop-P-ethoxyethyl, haloxyfop-methyl, haloxyfop-P-methyl, hexazinone, HW-02, i.e. 1-(dimethoxyphosphoryl) ethyl-(2,4-dichlorophenoxy)acetate, 4-hydroxy-1-methoxy-5-methyl-3-[4-(trifluormethyl)pyridine-2-yl]imidazolidine-2-on, 4-hydroxy-1-methyl-3-[4-(trifluormethyl)pyridine-2-yl]imidazolidine-2-on, imazamethabenz, imazamethabenz-methyl, imazamox, imazamox-ammonium, imazapic, imazapic-ammonium, imazapyr, imazapyr-isopropyl-ammonium, imazaquin, imazaquin-ammonium, imazethapyr, imazethapyr-immonium, imazosulfuron, indanofan, indaziflam, iodosulfuron, iodosulfuron-methyl-sodium, ioxynil, ioxynil-octanoate, -potassium and -sodium, ipfencarbazone, isoproturon, isouron, isoxaben, isoxaflutole, karbutilate, KUH-043, i.e. 3-({[5-(difluoromethyl)-1-methyl-3-(trifluoromethyl)-1H-pyrazol-4-yl]methyl}sulfonyl)-5,5-dimethyl-4,5-dihydro-1,2-oxazole, ketospiradox, lactofen, lenacil, linuron, MCPA, MCPA-butotyl, -dimethylammonium, -2-ethylhexyl, -isopropylammonium, -potassium, and -sodium, MCPB, MCPB-methyl, -ethy,1 and -sodium, mecoprop, mecoprop-sodium, and -butotyl, mecoprop-P, mecoprop-P-butotyl, -dimethylammonium, -2-ethylhexyl, and -potassium, mefenacet, mefluidide, mesosulfuron, mesosulfuron-methyl, mesotrione, methabenzthiazuron, metam, metamifop, metamitron, metazachlor, metazosulfuron, methabenzthiazuron, methiopyrsulfuron, methiozolin, methyl isothiocyanate, metobromuron, metolachlor, S-metolachlor, metosulam, metoxuron, metribuzin, metsulfuron, metsulfuron-methyl, molinat, monolinuron, monosulfuron, monosulfuron-ester, MT-5950, i.e. N-(3-chloro-4-isopropylphenyl)-2-methylpentan amide, NGGC-011, napropamide, NC-310, i.e. [5-(benzyloxy)-1-methyl-1H-pyrazol-4-yl](2,4-dichlorophenyl)methanone, neburon, nicosulfuron, nonanoic acid (pelargonic acid), norflurazon, oleic acid (fatty acids), orbencarb, orthosulfamuron, oryzalin, oxadiargyl, oxadiazon, oxasulfuron, oxaziclomefon, oxyfluorfen, paraquat, paraquat dichloride, pebulate, pendimethalin, penoxsulam, pentachlorphenol, pentoxazone, pethoxamid, petroleum oils, phenmedipham, picloram, picolinafen, pinoxaden, piperophos, pretila-chlor, primisulfuron, primisulfuron-methyl, prodiamine, profoxydim, prometon, prometryn, propachlor, propanil, propaquizafop, propazine, propham, propisochlor, propoxycarbazone, propoxycarbazone-sodium, propyrisulfuron, propyzamide, prosulfocarb, prosulfuron, pyraclonil, pyraflufen, pyraflufen-ethyl, pyrasulfotole, pyrazolynate (pyrazolate), pyrazosulfuron, pyrazosulfuron-ethyl, pyrazoxyfen, pyribambenz, pyribambenz-isopropyl, pyribambenz-propyl, pyribenzoxim, pyri-buticarb, pyridafol, pyridate, pyriftalid, pyriminobac, pyriminobac-methyl, pyrimisulfan, pyrithiobac, pyrithiobac-sodium, pyroxasulfone, pyroxsulam, quinclorac, quinmerac, quinoclamine, quizalofop, quizalofop-ethyl, quizalofop-P, quizalofop-P-ethyl, quizalofop-P-tefuryl, rimsulfuron, saflufenacil, sethoxydim, siduron, simazine, simetryn, SL-261, sulcotrion, sulfentrazone, sulfometuron, sulfometuron-methyl, sulfosulfuron, SYN-523, SYP-249, i.e. 1-ethoxy-3-methyl-1-oxobut-3-en-2-yl 5-[2-chloro-4-(trifluoromethyl)phenoxy]-2-nitrobenzoate, SYP-300, i.e. 1-[7-fluoro-3-oxo-4-(prop-2-yn-1-yl)-3,4-dihydro-2H-1,4-benzoxazin-6-yl]-3-propyl-2-thioxoimidazolidine-4,5-dione, 2,3,6-TBA, TCA (trichloroacetic acid), TCA-sodium, tebuthiuron, tefuryltrione, tembotrione, tepraloxydim, terbacil, terbucarb, terbumeton, terbuthylazin, terbutryn, thenylchlor, thiazopyr, thiencarbazone, thien-carbazone-methyl, thifensulfuron, thifensulfuron-methyl, thiobencarb, tiafenacil, tolpyralate, topra-mezone, tralkoxydim, triafamone, tri-allate, triasulfuron, triaziflam, tribenuron, tribenuron-methyl, triclopyr, trietazine, trifloxysulfuron, trifloxysulfuron-sodium, trifludimoxazin, trifluralin, triflu-sulfuron, triflusulfuron-methyl, tritosulfuron, urea sulfate, vernolate, ZJ-0862, i.e. 3,4-dichloro-N-{2-[(4,6-dimethoxypyrimidin-2-yl)oxy]benzyl}aniline, and the following compounds:

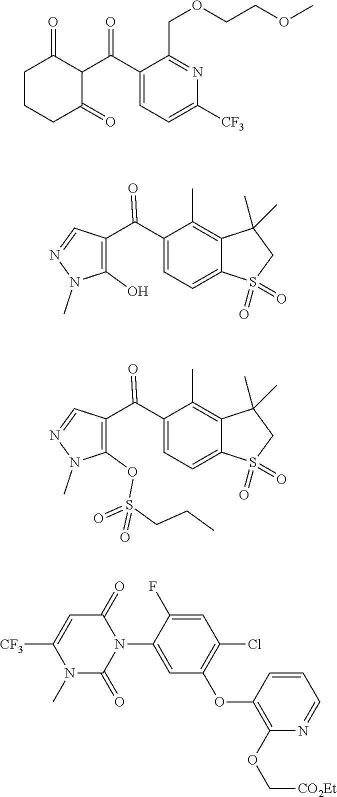 [SMILES: COCCOCc1nc(C(F)(F)F)ccc1C(=O)C1C(=O)CCCC1=O ; Cc1c(C(=O)c2cnn(C)c2O)ccc2c1C(C)(C)CS2(=O)=O ; CCCS(=O)(=O)Oc1c(C(=O)c2ccc3c(c2C)C(C)(C)CS3(=O)=O)cnn1C ; CCOC(=O)COc1ncccc1Oc1cc(-n2c(=O)cc(C(F)(F)F)n(C)c2=O)c(F)cc1Cl]

Examples for plant growth regulators are:
Acibenzolar, acibenzolar-S-methyl, 5-aminolevulinic acid, ancymidol, 6-benzylaminopurine, Brassinolid, catechine, chlormequat chloride, cloprop, cyclanilide, 3-(cycloprop-1-enyl) propionic acid, daminozide, dazomet, n-decanol, dikegulac, dikegulac-sodium, endothal, endothal-dipotassium, -disodium, and -mono(N,N-dimethylalkylammonium), ethephon, flumetralin, flurenol, flurenol-butyl, flurprimidol, forchlorfenuron, gibberellic acid, inabenfide, indol-3-acetic acid (IAA), 4-indol-3-ylbutyric acid, isoprothiolane, probenazole, jasmonic acid, maleic hydrazide, mepiquat chloride, 1-methylcyclopropene, methyljasmonate, 2-(1-naphthyl)acetamide, 1-naphthylacetic acid, 2-naphthyloxyacetic acid, nitrophenolate-mixture, paclobutrazol, N-(2-phenylethyl)-beta-alanine, N-phenylphthalamic acid, prohexadione, prohexadione-calcium, prohydrojasmone, salicylic acid, strigolactone, tecnazene, thidiazuron, triacontanol, trinexapac, trinexapac-ethyl, tsitodef, uniconazole, uniconazole-P.

### Fungicides

Examples of active compounds which may be mentioned as fungicide which are known from the literature are the following (compounds are either described by “common name” in accordance with the International Organization for Standardization (ISO) or by chemical name or by a customary code number), and always comprise all applicable forms such as acids, salts, ester, or modifications such as isomers, like stereoisomers and optical isomers. As an example at least one applicable form and/or modifications can be mentioned.

The active ingredients specified herein by their Common Name are known and described, for example, in The Pesticide Manual (16th Ed.British Crop Protection Council) or can be searched in the internet (e.g. www.alanwood.net/pesticides).

Where a compound (A) or a compound (B) can be present in tautomeric form, such a compound is understood herein above and herein below also to include, where applicable, corresponding tautomeric forms, even when these are not specifically mentioned in each case.

All named mixing partners of the classes (1) to (15) can, if their functional groups enable this, optionally form salts with suitable bases or acids.
1) Inhibitors of the ergosterol biosynthesis, for example (1.001) cyproconazole, (1.002) difenoconazole, (1.003) epoxiconazole, (1.004) fenhexamid, (1.005) fenpropidin, (1.006) fenpropimorph, (1.007) fenpyrazamine, (1.008) fluquinconazole, (1.009) flutriafol, (1.010) imazalil, (1.011) imazalil sulfate, (1.012) ipconazole, (1.013) metconazole, (1.014) myclobutanil, (1.015) paclobutrazol, (1.016) prochloraz, (1.017) propiconazole, (1.018) prothioconazole, (1.019) Pyrisoxazole, (1.020) spiroxamine, (1.021) tebuconazole, (1.022) tetraconazole, (1.023) triadimenol, (1.024) tridemorph, (1.025) triticonazole, (1.026) (1R,2S,5S)-5-(4-chlorobenzyl)-2-(chloromethyl)-2-methyl-1-(1H-1,2,4-triazol-1-ylmethyl)cyclopentanol, (1.027) (1S,2R,5R)-5-(4-chlorobenzyl)-2-(chloromethyl)-2-methyl-1-(1H-1,2,4-triazol-1-ylmethyl)cyclopentanol, (1.028) (2R)-2-(1-chlorocyclopropyl)-4-[(1R)-2,2-dichlorocyclopropyl]-1-(1H-1,2,4-triazol-1-yl)butan-2-ol, (1.029) (2R)-2-(1-chlorocyclopropyl)-4-[(1S)-2,2-dichlorocyclopropyl]-1-(1H-1,2,4-triazol-1-yl)butan-2-ol, (1.030) (2R)-2-[4-(4-chlorophenoxy)-2-(trifluoromethyl)phenyl]-1-(1H-1,2,4-triazol-1-yl)propan-2-ol, (1.031) (2S)-2-(1-chlorocyclopropyl)-4-[(1R)-2,2-dichlorocyclopropyl]-1-(1H-1,2,4-triazol-1-yl)butan-2-ol, (1.032) (2S)-2-(1-chlorocyclopropyl)-4-[(1S)-2,2-dichlorocyclopropyl]-1-(1H-1,2,4-triazol-1-yl)butan-2-ol, (1.033) (2S)-2-[4-(4-chlorophenoxy)-2-(trifluoromethyl)phenyl]-1-(1H-1,2,4-triazol-1-yl)propan-2-ol, (1.034) (R)-[3-(4-chloro-2-fluorophenyl)-5-(2,4-difluorophenyl)-1,2-oxazol-4-yl](pyridin-3-yl)methanol, (1.035) (S)-[3-(4-chloro-2-fluorophenyl)-5-(2,4-difluorophenyl)-1,2-oxazol-4-yl](pyridin-3-yl)methanol, (1.036) [3-(4-chloro-2-fluorophenyl)-5-(2,4-difluorophenyl)-1,2-oxazol-4-yl](pyridin-3-yl)methanol, (1.037) 1-({(2R,4S)-2-[2-chloro-4-(4-chlorophenoxy)phenyl]-4-methyl-1,3-dioxolan-2-yl}methyl)-1H-1,2,4-triazole, (1.038) 1-({(2S,4S)-2-[2-chloro-4-(4-chlorophenoxy)phenyl]-4-methyl-1,3-dioxolan-2-yl}methyl)-1H-1,2,4-triazole, (1.039) 1-{[3-(2-chlorophenyl)-2-(2,4-difluorophenyl)oxiran-2-yl]methyl}-1H-1,2,4-triazol-5-yl thiocyanate, (1.040) 1-{[rel(2R,3R)-3-(2-chlorophenyl)-2-(2,4-difluorophenyl)oxiran-2-yl]methyl}-1H-1,2,4-triazol-5-yl thiocyanate, (1.041) 1-{[rel(2R,3S)-3-(2-chlorophenyl)-2-(2,4-difluorophenyl)oxiran-2-yl]methyl}-1H-1,2,4-triazol-5-yl thiocyanate, (1.042) 2-[(2R,4R,5R)-1-(2,4-dichlorophenyl)-5-hydroxy-2,6,6-trimethylheptan-4-yl]-2,4-dihydro-3H-1,2,4-triazole-3-thione, (1.043) 2-[(2R,4R,5S)-1-(2,4-dichlorophenyl)-5-hydroxy-2,6,6-trimethylheptan-4-yl]-2,4-dihydro-3H-1,2,4-triazole-3-thione, (1.044) 2-[(2R,4S,5R)-1-(2,4-dichlorophenyl)-5-hydroxy-2,6,6-trimethylheptan-4-yl]-2,4-dihydro-3H-1,2,4-triazole-3-thione, (1.045) 2-[(2R,4S,5S)-1-(2,4-dichlorophenyl)-5-hydroxy-2,6,6-trimethylheptan-4-yl]-2,4-dihydro-3H-1,2,4-triazole-3-thione, (1.046) 2-[(2S,4R,5R)-1-(2,4-dichlorophenyl)-5-hydroxy-2,6,6-trimethylheptan-4-yl]-2,4-dihydro-3H-1,2,4-triazole-3-thione, (1.047) 2-[(2S,4R,5S)-1-(2,4-dichlorophenyl)-5-hydroxy-2,6,6-trimethylheptan-4-yl]-2,4-dihydro-3H-1,2,4-triazole-3-thione, (1.048) 2-[(2S,4S,5R)-1-(2,4-dichlorophenyl)-5-hydroxy-2,6,6-trimethylheptan-4-yl]-2,4-dihydro-3H-1,2,4-triazole-3-thione, (1.049) 2-[(2S,4S,5S)-1-(2,4-dichlorophenyl)-5-hydroxy-2,6,6-trimethylheptan-4-yl]-2,4-dihydro-3H-1,2,4-triazole-3-thione, (1.050) 2-[1-(2,4-dichlorophenyl)-5-hydroxy-2,6,6-trimethylheptan-4-yl]-2,4-dihydro-3H-1,2,4-triazole-3-thione, (1.051) 2-[2-chloro-4-(2,4-dichlorophenoxy)phenyl]-1-(1H-1,2,4-triazol-1-yl)propan-2-ol, (1.052) 2-[2-chloro-4-(4-chlorophenoxy)phenyl]-1-(1H-1,2,4-triazol-1-yl)butan-2-ol, (1.053) 2-[4-(4-chlorophenoxy)-2-(trifluoromethyl)phenyl]-1-(1H-1,2,4-triazol-1-yl)butan-2-ol, (1.054) 2-[4-(4-chlorophenoxy)-2-(trifluoromethyl)phenyl]-1-(1H-1,2,4-triazol-1-yl)pentan-2-ol, (1.055) Mefentrifluconazole, (1.056) 2-{[3-(2-chlorophenyl)-2-(2,4-difluorophenyl)oxiran-2-yl]methyl}-2,4-dihydro-3H-1,2,4-triazole-3-thione, (1.057) 2-{[rel(2R,3R)-3-(2-chlorophenyl)-2-(2,4-difluorophenyl)oxiran-2-yl]methyl}-2,4-dihydro-3H-1,2,4-triazole-3-thione, (1.058) 2-{[rel(2R,3S)-3-(2-chlorophenyl)-2-(2,4-difluorophenyl)oxiran-2-yl]methyl}-2,4-dihydro-3H-1,2,4-triazole-3-thione, (1.059) 5-(4-chlorobenzyl)-2-(chloromethyl)-2-methyl-1-(1H-1,2,4-triazol-1-ylmethyl)cyclopentanol, (1.060) 5-(allylsulfanyl)-1-{[3-(2-chlorophenyl)-2-(2,4-difluorophenyl)oxiran-2-yl]methyl}-1H-1,2,4-triazole, (1.061) 5-(allylsulfanyl)-1-{[rel(2R,3R)-3-(2-chlorophenyl)-2-(2,4-difluorophenyl)oxiran-2-yl]methyl}-1H-1,2,4-triazole, (1.062) 5-(allylsulfanyl)-1-{[rel(2R,3S)-3-(2-chlorophenyl)-2-(2,4-difluorophenyl)oxiran-2-yl]methyl}-1H-1,2,4-triazole, (1.063) N′-(2,5-dimethyl-4-{[3-(1,1,2,2-tetrafluoroethoxy)phenyl]sulfanyl}phenyl)-N-ethyl-N-methylimidoformamide, (1.064) N′-(2,5-dimethyl-4-{[3-(2,2,2-trifluoroethoxy)phenyl]sulfanyl}phenyl)-N-ethyl-N-methylimidoformamide, (1.065) N′-(2,5-dimethyl-4-{[3-(2,2,3,3-tetrafluoropropoxy)phenyl]sulfanyl}phenyl)-N-ethyl-N-methylimidoformamide, (1.066) N′-(2,5-dimethyl-4-{[3-(pentafluoroethoxy)phenyl]sulfanyl}phenyl)-N-ethyl-N-methylimidoformamide, (1.067) N′-(2,5-dimethyl-4-{3-[(1,1,2,2-tetrafluoroethyl)sulfanyl]phenoxy}phenyl)-N-ethyl-N-methylimidoformamide, (1.068) N′-(2,5-dimethyl-4-{3-[(2,2,2-trifluoroethyl)sulfanyl]phenoxy}phenyl)-N-ethyl-N-methylimidoformamide, (1.069) N′-(2,5-dimethyl-4-{3-[(2,2,3,3-tetrafluoropropyl)sulfanyl]phenoxy}phenyl)-N-ethyl-N-methylimidoformamide, (1.070) N′-(2,5-dimethyl-4-{3-[(pentafluoroethyl)sulfanyl]phenoxy}phenyl)-N-ethyl-N-methylimidoformamide, (1.071) N′-(2,5-dimethyl-4-phenoxyphenyl)-N-ethyl-N-methylimidoformamide, (1.072) N′-(4-{[3-(difluoromethoxy)phenyl]sulfanyl}-2,5-dimethylphenyl)-N-ethyl-N-methylimidoformamide, (1.073) N′-(4-{3-[(difluoromethyl)sulfanyl]phenoxy}-2,5-dimethylphenyl)-N-ethyl-N-methylimidoformamide, (1.074) N′-[5-bromo-6-(2,3-dihydro-1H-inden-2-yloxy)-2-methylpyridin-3-yl]-N-ethyl-N-methylimidoformamide, (1.075) N′-{4-[(4,5-dichloro-1,3-thiazol-2-yl)oxy]-2,5-dimethylphenyl}-N-ethyl-N-methylimidoformamide, (1.076) N′-{5-bromo-6-[(1R)-1-(3,5-difluorophenyl)ethoxy]-2-methylpyridin-3-yl}-N-ethyl-N-methylimidoformamide, (1.077) N′-{5-bromo-6-[(1S)-1-(3,5-difluorophenyl)ethoxy]-2-methylpyridin-3-yl}-N-ethyl-N-methylimidoformamide, (1.078) N′-{5-bromo-6-[(cis-4-isopropylcyclohexyl)oxy]-2-methylpyridin-3-yl}-N-ethyl-N-methylimidoformamide, (1.079) N′-{5-bromo-6-[(trans-4-isopropylcyclohexyl)oxy]-2-methylpyridin-3-yl}-N-ethyl-N-methylimidoformamide, (1.080) N′-{5-bromo-6-[1-(3,5-difluorophenyl)ethoxy]-2-methylpyridin-3-yl}-N-ethyl-N-methylimidoformamide, (1.081) Ipfentrifluconazole.
2) Inhibitors of the respiratory chain at complex I or II, for example (2.001) benzovindiflupyr, (2.002) bixafen, (2.003) boscalid, (2.004) carboxin, (2.005) fluopyram, (2.006) flutolanil, (2.007) fluxapyroxad, (2.008) furametpyr, (2.009) Isofetamid, (2.010) isopyrazam (anti-epimeric enantiomer 1R,4S,9S), (2.011) isopyrazam (anti-epimeric enantiomer 1S,4R,9R), (2.012) isopyrazam (anti-epimeric racemate 1RS,4SR,9SR), (2.013) isopyrazam (mixture of syn-epimeric racemate 1RS,4SR,9RS and anti-epimeric racemate 1RS,4SR,9SR), (2.014) isopyrazam (syn-epimeric enantiomer 1R,4S,9R), (2.015) isopyrazam (syn-epimeric enantiomer 1S,4R,9S), (2.016) isopyrazam (syn-epimeric racemate 1RS,4SR,9RS), (2.017) penflufen, (2.018) penthiopyrad, (2.019) pydiflumetofen, (2.020) Pyraziflumid, (2.021) sedaxane, (2.022) 1,3-dimethyl-N-(1,1,3-trimethyl-2,3-dihydro-1H-inden-4-yl)-1H-pyrazole-4-carboxamide, (2.023) 1,3-dimethyl-N-[(3R)-1,1,3-trimethyl-2,3-dihydro-1H-inden-4-yl]-1H-pyrazole-4-carboxamide, (2.024) 1,3-dimethyl-N-[(3S)-1,1,3-trimethyl-2,3-dihydro-1H-inden-4-yl]-1H-pyrazole-4-carboxamide, (2.025) 1-methyl-3-(trifluoromethyl)-N-[2′-(trifluoromethyl)biphenyl-2-yl]-1H-pyrazole-4-carboxamide, (2.026) 2-fluoro-6-(trifluoromethyl)-N-(1,1,3-trimethyl-2,3-dihydro-1H-inden-4-yl)benzamide, (2.027) 3-(difluoromethyl)-1-methyl-N-(1,1,3-trimethyl-2,3-dihydro-1H-inden-4-yl)-1H-pyrazole-4-carboxamide, (2.028) 3-(difluoromethyl)-1-methyl-N-[(3R)-1,1,3-trimethyl-2,3-dihydro-1H-inden-4-yl]-1H-pyrazole-4-carboxamide, (2.029) 3-(difluoromethyl)-1-methyl-N-[(3S)-1,1,3-trimethyl-2,3-dihydro-1H-inden-4-yl]-1H-pyrazole-4-carboxamide, (2.030) Fluindapyr, (2.031) 3-(difluoromethyl)-N-[(3R)-7-fluoro-1,1,3-trimethyl-2,3-dihydro-1H-inden-4-yl]-1-methyl-1H-pyrazole-4-carboxamide, (2.032) 3-(difluoromethyl)-N-[(3S)-7-fluoro-1,1,3-trimethyl-2,3-dihydro-1H-inden-4-yl]-1-methyl-1H-pyrazole-4-carboxamide, (2.033) 5,8-difluoro-N-[2-(2-fluoro-4-{[4-(trifluoromethyl)pyridin-2-yl]oxy}phenyl)ethyl]quinazolin-4-amine, (2.034)N-(2-cyclopentyl-5-fluorobenzyl)-N-cyclopropyl-3-(difluoromethyl)-5-fluoro-1-methyl-1H-pyrazole-4-carboxamide, (2.035)N-(2-tert-butyl-5-methylbenzyl)-N-cyclopropyl-3-(difluoromethyl)-5-fluoro-1-methyl-1H-pyrazole-4-carboxamide, (2.036)N-(2-tert-butylbenzyl)-N-cyclopropyl-3-(difluoromethyl)-5-fluoro-1-methyl-1H-pyrazole-4-carboxamide, (2.037)N-(5-chloro-2-ethylbenzyl)-N-cyclopropyl-3-(difluoromethyl)-5-fluoro-1-methyl-1H-pyrazole-4-carboxamide, (2.038)N-(5-chloro-2-isopropylbenzyl)-N-cyclopropyl-3-(difluoromethyl)-5-fluoro-1-methyl-1H-pyrazole-4-carboxamide, (2.039)N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamide, (2.040)N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide, (2.041)N-[1-(2,4-dichlorophenyl)-1-methoxypropan-2-yl]-3-(difluoromethyl)-1-methyl-1H-pyrazole-4-carboxamide, (2.042)N-[2-chloro-6-(trifluoromethyl)benzyl]-N-cyclopropyl-3-(difluoromethyl)-5-fluoro-1-methyl-1H-pyrazole-4-carboxamide, (2.043)N-[3-chloro-2-fluoro-6-(trifluoromethyl)benzyl]-N-cyclopropyl-3-(difluoromethyl)-5-fluoro-1-methyl-1H-pyrazole-4-carboxamide, (2.044)N-[5-chloro-2-(trifluoromethyl)benzyl]-N-cyclopropyl-3-(difluoromethyl)-5-fluoro-1-methyl-1H-pyrazole-4-carboxamide, (2.045)N-cyclopropyl-3-(difluoromethyl)-5-fluoro-1-methyl-N-[5-methyl-2-(trifluoromethyl)benzyl]-1H-pyrazole-4-carboxamide, (2.046)N-cyclopropyl-3-(difluoromethyl)-5-fluoro-N-(2-fluoro-6-isopropylbenzyl)-1-methyl-1H-pyrazole-4-carboxamide, (2.047)N-cyclopropyl-3-(difluoromethyl)-5-fluoro-N-(2-isopropyl-5-methylbenzyl)-1-methyl-1H-pyrazole-4-carboxamide, (2.048)N-cyclopropyl-3-(difluoromethyl)-5-fluoro-N-(2-isopropylbenzyl)-1-methyl-1H-pyrazole-4-carbothioamide, (2.049)N-cyclopropyl-3-(difluoromethyl)-5-fluoro-N-(2-isopropylbenzyl)-1-methyl-1H-pyrazole-4-carboxamide, (2.050)N-cyclopropyl-3-(difluoromethyl)-5-fluoro-N-(5-fluoro-2-isopropylbenzyl)-1-methyl-1H-pyrazole-4-carboxamide, (2.051)N-cyclopropyl-3-(difluoromethyl)-N-(2-ethyl-4,5-dimethylbenzyl)-5-fluoro-1-methyl-1H-pyrazole-4-carboxamide, (2.052)N-cyclopropyl-3-(difluoromethyl)-N-(2-ethyl-5-fluorobenzyl)-5-fluoro-1-methyl-1H-pyrazole-4-carboxamide, (2.053) N-cyclopropyl-3-(difluoromethyl)-N-(2-ethyl-5-methylbenzyl)-5-fluoro-1-methyl-1H-pyrazole-4-carboxamide, (2.054)N-cyclopropyl-N-(2-cyclopropyl-5-fluorobenzyl)-3-(difluoromethyl)-5-fluoro-1-methyl-1H-pyrazole-4-carboxamide, (2.055)N-cyclopropyl-N-(2-cyclopropyl-5-methylbenzyl)-3-(difluoromethyl)-5-fluoro-1-methyl-1H-pyrazole-4-carboxamide, (2.056)N-cyclopropyl-N-(2-cyclopropylbenzyl)-3-(difluoromethyl)-5-fluoro-1-methyl-1H-pyrazole-4-carboxamide, (2.057) pyrapropoyne.
3) Inhibitors of the respiratory chain at complex III, for example (3.001) ametoctradin, (3.002) amisulbrom, (3.003) azoxystrobin, (3.004) coumethoxystrobin, (3.005) coumoxystrobin, (3.006) cyazofamid, (3.007) dimoxystrobin, (3.008) enoxastrobin, (3.009) famoxadone, (3.010) fenamidone, (3.011) flufenoxystrobin, (3.012) fluoxastrobin, (3.013) kresoxim-methyl, (3.014) metominostrobin, (3.015) orysastrobin, (3.016) picoxystrobin, (3.017) pyraclostrobin, (3.018) pyrametostrobin, (3.019) pyraoxystrobin, (3.020) trifloxystrobin, (3.021) (2E)-2-{2-[({[(1E)-1-(3-{[(E)-1-fluoro-2-phenylvinyl]oxy}phenyl)ethylidene]amino}oxy)methyl]phenyl}-2-(methoxyimino)-N-methylacetamide, (3.022) (2E,3Z)-5-{[1-(4-chlorophenyl)-1H-pyrazol-3-yl]oxy}-2-(methoxyimino)-N,3-dimethylpent-3-enamide, (3.023) (2R)-2-{2-[(2,5-dimethylphenoxy)methyl]phenyl}-2-methoxy-N-methylacetamide, (3.024) (2S)-2-{2-[(2,5-dimethylphenoxy)methyl]phenyl}-2-methoxy-N-methylacetamide, (3.025) (3S,6S,7R,8R)-8-benzyl-3-[({3-[(isobutyryloxy)methoxy]-4-methoxypyridin-2-yl}carbonyl)amino]-6-methyl-4,9-dioxo-1,5-dioxonan-7-yl 2-methylpropanoate, (3.026) mandestrobin, (3.027)N-(3-ethyl-3,5,5-trimethylcyclohexyl)-3-formamido-2-hydroxybenzamide, (3.028) (2E,3Z)-5-{[1-(4-chloro-2-fluorophenyl)-1H-pyrazol-3-yl]oxy}-2-(methoxyimino)-N,3-dimethylpent-3-enamide, (3.029) methyl {5-[3-(2,4-dimethylphenyl)-1H-pyrazol-1-yl]-2-methylbenzyl}carbamate, (3.030) metyltetraprole, (3.031) florylpicoxamid.
4) Inhibitors of the mitosis and cell division, for example (4.001) carbendazim, (4.002) diethofencarb, (4.003) ethaboxam, (4.004) fluopicolide, (4.005) pencycuron, (4.006) thiabendazole, (4.007) thiophanate-methyl, (4.008) zoxamide, (4.009) 3-chloro-4-(2,6-difluorophenyl)-6-methyl-5-phenylpyridazine, (4.010) 3-chloro-5-(4-chlorophenyl)-4-(2,6-difluorophenyl)-6-methylpyridazine, (4.011) 3-chloro-5-(6-chloropyridin-3-yl)-6-methyl-4-(2,4,6-trifluorophenyl)pyridazine, (4.012) 4-(2-bromo-4-fluorophenyl)-N-(2,6-difluorophenyl)-1,3-dimethyl-1H-pyrazol-5-amine, (4.013) 4-(2-bromo-4-fluorophenyl)-N-(2-bromo-6-fluorophenyl)-1,3-dimethyl-1H-pyrazol-5-amine, (4.014) 4-(2-bromo-4-fluorophenyl)-N-(2-bromophenyl)-1,3-dimethyl-1H-pyrazol-5-amine, (4.015) 4-(2-bromo-4-fluorophenyl)-N-(2-chloro-6-fluorophenyl)-1,3-dimethyl-1H-pyrazol-5-amine, (4.016) 4-(2-bromo-4-fluorophenyl)-N-(2-chlorophenyl)-1,3-dimethyl-1H-pyrazol-5-amine, (4.017) 4-(2-bromo-4-fluorophenyl)-N-(2-fluorophenyl)-1,3-dimethyl-1H-pyrazol-5-amine, (4.018) 4-(2-chloro-4-fluorophenyl)-N-(2,6-difluorophenyl)-1,3-dimethyl-1H-pyrazol-5-amine, (4.019) 4-(2-chloro-4-fluorophenyl)-N-(2-chloro-6-fluorophenyl)-1,3-dimethyl-1H-pyrazol-5-amine, (4.020) 4-(2-chloro-4-fluorophenyl)-N-(2-chlorophenyl)-1,3-dimethyl-1H-pyrazol-5-amine, (4.021) 4-(2-chloro-4-fluorophenyl)-N-(2-fluorophenyl)-1,3-dimethyl-1H-pyrazol-5-amine, (4.022) 4-(4-chlorophenyl)-5-(2,6-difluorophenyl)-3,6-dimethylpyridazine, (4.023)N-(2-bromo-6-fluorophenyl)-4-(2-chloro-4-fluorophenyl)-1,3-dimethyl-1H-pyrazol-5-amine, (4.024)N-(2-bromophenyl)-4-(2-chloro-4-fluorophenyl)-1,3-dimethyl-1H-pyrazol-5-amine, (4.025)N-(4-chloro-2,6-difluorophenyl)-4-(2-chloro-4-fluorophenyl)-1,3-dimethyl-1H-pyrazol-5-amine.
5) Compounds capable to have a multisite action, for example (5.001) bordeaux mixture, (5.002) captafol, (5.003) captan, (5.004) chlorothalonil, (5.005) copper hydroxide, (5.006) copper naphthenate, (5.007) copper oxide, (5.008) copper oxychloride, (5.009) copper(2+) sulfate, (5.010) dithianon, (5.011) dodine, (5.012) folpet, (5.013) mancozeb, (5.014) maneb, (5.015) metiram, (5.016) metiram zinc, (5.017) oxine-copper, (5.018) propineb, (5.019) sulfur and sulfur preparations including calcium polysulfide, (5.020) thiram, (5.021) zineb, (5.022) ziram, (5.023) 6-ethyl-5,7-dioxo-6,7-dihydro-5H-pyrrolo[3′,4′:5,6][1,4]dithiino[2,3-c][1,2]thiazole-3-carbonitrile.
6) Compounds capable to induce a host defence, for example (6.001) acibenzolar-S-methyl, (6.002) isotianil, (6.003) probenazole, (6.004) tiadinil.
7) Inhibitors of the amino acid and/or protein biosynthesis, for example (7.001) cyprodinil, (7.002) kasugamycin, (7.003) kasugamycin hydrochloride hydrate, (7.004) oxytetracycline, (7.005) pyrimethanil, (7.006) 3-(5-fluoro-3,3,4,4-tetramethyl-3,4-dihydroisoquinolin-1-yl)quinoline.
8) Inhibitors of the ATP production, for example (8.001) silthiofam.
9) Inhibitors of the cell wall synthesis, for example (9.001) benthiavalicarb, (9.002) dimethomorph, (9.003) flumorph, (9.004) iprovalicarb, (9.005) mandipropamid, (9.006) pyrimorph, (9.007) valifenalate, (9.008) (2E)-3-(4-tert-butylphenyl)-3-(2-chloropyridin-4-yl)-1-(morpholin-4-yl)prop-2-en-1-one, (9.009) (2Z)-3-(4-tert-butylphenyl)-3-(2-chloropyridin-4-yl)-1-(morpholin-4-yl)prop-2-en-1-one.
10) Inhibitors of the lipid and membrane synthesis, for example (10.001) propamocarb, (10.002) propamocarb hydrochloride, (10.003) tolclofos-methyl.
11) Inhibitors of the melanin biosynthesis, for example (11.001) tricyclazole, (11.002) 2,2,2-trifluoroethyl {3-methyl-1-[(4-methylbenzoyl)amino]butan-2-yl}carbamate.
12) Inhibitors of the nucleic acid synthesis, for example (12.001) benalaxyl, (12.002) benalaxyl-M (kiralaxyl), (12.003) metalaxyl, (12.004) metalaxyl-M (mefenoxam).
13) Inhibitors of the signal transduction, for example (13.001) fludioxonil, (13.002) iprodione, (13.003) procymidone, (13.004) proquinazid, (13.005) quinoxyfen, (13.006) vinclozolin.
14) Compounds capable to act as an uncoupler, for example (14.001) fluazinam, (14.002) meptyldinocap.
15) Further compounds, for example (15.001) Abscisic acid, (15.002) benthiazole, (15.003) bethoxazin, (15.004) capsimycin, (15.005) carvone, (15.006) chinomethionat, (15.007) cufraneb, (15.008) cyflufenamid, (15.009) cymoxanil, (15.010) cyprosulfamide, (15.011) flutianil, (15.012) fosetyl-aluminium, (15.013) fosetyl-calcium, (15.014) fosetyl-sodium, (15.015) methyl isothiocyanate, (15.016) metrafenone, (15.017) mildiomycin, (15.018) natamycin, (15.019) nickel dimethyldithiocarbamate, (15.020) nitrothal-isopropyl, (15.021) oxamocarb, (15.022) Oxathiapiprolin, (15.023) oxyfenthiin, (15.024) pentachlorophenol and salts, (15.025) phosphorous acid and its salts, (15.026) propamocarb-fosetylate, (15.027) pyriofenone (chlazafenone), (15.028) tebufloquin, (15.029) tecloftalam, (15.030) tolnifanide, (15.031) 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.032) 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.033) 2-(6-benzylpyridin-2-yl)quinazoline, (15.034) dipymetitrone, (15.035) 2-[3,5-bis(difluoromethyl)-1H-pyrazol-1-yl]-1-[4-(4-{5-[2-(prop-2-yn-1-yloxy)phenyl]-4,5-dihydro-1,2-oxazol-3-yl}-1,3-thiazol-2-yl)piperidin-1-yl]ethanone, (15.036) 2-[3,5-bis(difluoromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl)piperidin-1-yl]ethanone, (15.037) 2-[3,5-bis(difluoromethyl)-1H-pyrazol-1-yl]-1-[4-(4-{5-[2-fluoro-6-(prop-2-yn-1-yloxy)phenyl]-4,5-dihydro-1,2-oxazol-3-yl}-1,3-thiazol-2-yl)piperidin-1-yl]ethanone, (15.038) 2-[6-(3-fluoro-4-methoxyphenyl)-5-methylpyridin-2-yl]quinazoline, (15.039) 2-{(5R)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.040) 2-{(5S)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.041) Ipflufenoquin, (15.042) 2-{2-fluoro-6-[(8-fluoro-2-methylquinolin-3-yl)oxy]phenyl}propan-2-ol, (15.043) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.044) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}phenyl methanesulfonate, (15.045) 2-phenylphenol and salts, (15.046) 3-(4,4,5-trifluoro-3,3-dimethyl-3,4-dihydroisoquinolin-1-yl)quinoline, (15.047) quinofumelin, (15.048) 4-amino-5-fluoropyrimidin-2-ol (tautomeric form: 4-amino-5-fluoropyrimidin-2(1H)-one), (15.049) 4-oxo-4-[(2-phenylethyl)amino]butanoic acid, (15.050) 5-amino-1,3,4-thiadiazole-2-thiol, (15.051) 5-chloro-N′-phenyl-N′-(prop-2-yn-1-yl)thiophene-2-sulfonohydrazide, (15.052) 5-fluoro-2-[(4-fluorobenzyl)oxy]pyrimidin-4-amine, (15.053) 5-fluoro-2-[(4-methylbenzyl)oxy]pyrimidin-4-amine, (15.054) 9-fluoro-2,2-dimethyl-5-(quinolin-3-yl)-2,3-dihydro-1,4-benzoxazepine, (15.055) but-3-yn-1-yl {6-[({[(Z)-(1-methyl-1H-tetrazol-5-yl)(phenyl)methylene]amino}oxy)methyl]pyridin-2-yl}carbamate, (15.056) ethyl (2Z)-3-amino-2-cyano-3-phenylacrylate, (15.057) phenazine-1-carboxylic acid, (15.058) propyl 3,4,5-trihydroxybenzoate, (15.059) quinolin-8-ol, (15.060) quinolin-8-ol sulfate (2:1), (15.061) tert-butyl {6-[({[(1-methyl-1H-tetrazol-5-yl)(phenyl)methylene]amino}oxy)methyl]pyridin-2-yl}carbamate, (15.062) 5-fluoro-4-imino-3-methyl-1-[(4-methylphenyl)sulfonyl]-3,4-dihydropyrimidin-2(1H)-one, (15.063) aminopyrifen.

### Safener:

Following groups of compounds are, for example, to be considered as safeners:
S1) compounds of the group of heterocyclic carboxylic acid derivatives:
S1^{a}) compounds of the type of dichlorophenylpyrazoline-3-carboxylic acid (S1^{a}), preferably compounds such as 1-(2,4-dichlorophenyl)-5-(ethoxycarbonyl)-5-methyl-2-pyrazoline-3-carboxylic acid, ethyl 1-(2,4-dichlorophenyl)-5-(ethoxycarbonyl)-5-methyl-2-pyrazoline-3-carboxylate (S1-1) (“mefenpyr(-diethyl)”), and related compounds, as described in WO-A-91/07874;
S1^{b}) derivatives of dichlorophenylpyrazolecarboxylic acid (S1^{b}), preferably compounds such as ethyl 1-(2,4-dichlorophenyl)-5-methylpyrazole-3-carboxylate (S1-2), ethyl 1-(2,4-dichlorophenyl)-5-isopropylpyrazole-3-carboxylate (S1-3), ethyl 1-(2,4-dichlorophenyl)-5-(1,1-dimethylethyl)pyrazole-3-carboxylate (S1-4) and related compounds, as described in EP-A-333 131 and EP-A-269 806;
S1^{c}) derivatives of 1,5-diphenylpyrazole-3-carboxylic acid (S1^{c}), preferably compounds such as ethyl 1-(2,4-dichlorophenyl)-5-phenylpyrazole-3-carboxylate (S1-5), methyl 1-(2-chlorophenyl)-5-phenylpyrazole-3-carboxylate (S1-6) and related compounds, as described, for example, in EP-A-268554;
S1^{d}) compounds of the type of triazolecarboxylic acids (S1^{d}), preferably compounds such as fenchlorazole(-ethyl), i.e. ethyl 1-(2,4-dichlorophenyl)-5-trichloromethyl-(1H)-1,2,4-triazole-3-carboxylate (S1-7), and related compounds, as described in EP-A-174 562 and EP-A-346 620;
S1^{e}) compounds of the type of 5-benzyl- or 5-phenyl-2-isoxazoline-3-carboxylic acid or 5,5-diphenyl-2-isoxazoline-3-carboxylic acid (S1^{e}), preferably compounds such as ethyl 5-(2,4-dichlorobenzyl)-2-isoxazoline-3-carboxylate (S1-8) or ethyl 5-phenyl-2-isoxazoline-3-carboxylate (S1-9) and related compounds, as described in WO-A-91/08202, or 5,5-diphenyl-2-isoxazolinecarboxylic acid (S1-10) or ethyl 5,5-diphenyl-2-isoxazolinecarboxylate (S1-11) (“isoxadifen-ethyl”) or n-propyl 5,5-diphenyl-2-isoxazolinecarboxylate (S1-12) or ethyl 5-(4-fluorophenyl)-5-phenyl-2-isoxazoline-3-carboxylate (S1-13), as described in the patent application WO-A-95/07897.
S2) Compounds of the group of 8-quinolinoxy derivatives (S2):
S2^{a}) compounds of the type of 8-quinolinoxyacetic acid (S2T), preferably
1-methylhexyl (5-chloro-8-quinolinoxy)acetate (common name “cloquintocet-mexyl” (S2-1),
1,3-dimethyl-but-1-yl (5-chloro-8-quinolinoxy)acetate (S2-2),
4-allyloxybutyl (5-chloro-8-quinolinoxy)acetate (S2-3),
1-allyloxyprop-2-yl (5-chloro-8-quinolinoxy)acetate (S2-4),
ethyl (5-chloro-8-quinolinoxy)acetate (S2-5),
methyl (5-chloro-8-quinolinoxy)acetate (S2-6),
allyl (5-chloro-8-quinolinoxy)acetate (S2-7),
2-(2-propylideneiminoxy)-1-ethyl (5-chloro-8-quinolinoxy)acetate (S2-8),
   2-oxo-prop-1-yl (5-chloro-8-quinolinoxy)acetate (S2-9) and related compounds, as described in EP-A-86 750, EP-A-94 349 and EP-A-191 736 or EP-A-0 492 366, and also (5-chloro-8-quinolinoxy)acetic acid (S2-10), its hydrates and salts, for example its lithium, sodium, potassium, calcium, magnesium, aluminium, iron, ammonium, quaternary ammonium, sulphonium or phosphonium salts, as described in WO-A-2002/34048;
   S2^{b}) compounds of the type of (5-chloro-8-quinolinoxy)malonic acid (S2^{b}), preferably compounds such as diethyl (5-chloro-8-quinolinoxy)malonate, diallyl (5-chloro-8-quinolinoxy)malonate, methyl ethyl (5-chloro-8-quinolinoxy)malonate and related compounds, as described in EP-A-0 582 198.
   S3) Active compounds of the type of dichloroacetamides (S3) which are frequently used as pre-emergence safeners (soil-acting safeners), such as, for example,
      “dichlormid” (N,N-diallyl-2,2-dichloroacetamide) (S3-1),
      “R-29148” (3-dichloroacetyl-2,2,5-trimethyl-1,3-oxazolidine) from Stauffer (S3-2),
      “R-28725” (3-dichloroacetyl-2,2-dimethyl-1,3-oxazolidine) from Stauffer (S3-3),
      “benoxacor” (4-dichloroacetyl-3,4-dihydro-3-methyl-2H-1,4-benzoxazine) (S3-4),
      “PPG-1292” (N-allyl-N-[(1,3-dioxolan-2-yl)methyl]dichloroacetamide) from PPG Industries (S3 5),
      “DKA-24” (N-allyl-N-[(allylaminocarbonyl)methyl]dichloroacetamide) from Sagro-Chem (S3-6),
      “AD-67” or “MON 4660” (3-dichloroacetyl-1-oxa-3-aza-spiro[4,5]decane) from Nitrokemia or Monsanto (53-7),
      “TI-35” (1-dichloroacetylazepane) from TRI-Chemical RT (S3-8)
      “diclonon” (dicyclonon) or “BAS145138” or “LAB145138” (S3-9)
      ((RS)-1-dichloroacetyl-3,3,8a-trimethylperhydropyrrolo[1,2-a]pyrimidin-6-one) from BASF, furilazole” or “MON 13900” ((RS)-3-dichloroacetyl-5-(2-furyl)-2,2-dimethyloxazolidine) (S3-10), and also its (R)-isomer (S3-11).
   S4) Compounds of the class of acylsulphonamides (S4):
   S4^{a}) N-acylsulphonamides of the formula (S4^{a}) and salts thereof, as described in WO-A-97/45016

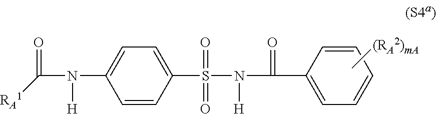

in which
R_{A}¹ is (C₁-C₆)-alkyl, (C₃-C₆)-cycloalkyl, where the 2 last-mentioned radicals are substituted by v_{A} substituents from the group consisting of halogen, (C₁-C₄)-alkoxy, halo-(C₁-C₆)-alkoxy and (C₁-C₄)-alkylthio and, in the case of cyclic radicals, also (C₁-C₄)-alkyl and (C₁-C₄)-haloalkyl;
R_{A}² is halogen, (C₁-C₄)-alkyl, (C₁-C₄)-alkoxy, CF₃,
m_{A} is 1 or 2; v_{D} is 0, 1, 2 or 3;
S4^{b}) compounds of the type of 4-(benzoylsulphamoyl)benzamides of the formula (S4^{b}) and salts thereof, as described in WO-A-99/16744,

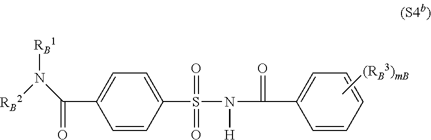

in which
R_{B}¹, R_{B}² independently of one another are hydrogen, (C₁-C₆)-alkyl, (C₃-C₆)-cycloalkyl, (C₃-C₆)-alkenyl, (C₃-C₆)-alkynyl,
R_{B}³ is halogen, (C₁-C₄)-alkyl, (C₁-C₄)-haloalkyl or (C₁-C₄)-alkoxy,
m_{B} is 1 or 2;
for example those in which
R_{B}¹=cyclopropyl, R_{B}²=hydrogen and (R_{B}³)=2-OMe (“cyprosulfamide”, S4-1),
R_{B}¹=cyclopropyl, R_{B}²=hydrogen and (R_{B}³)=5-Cl-2-OMe (S4-2),
R_{B}¹=ethyl, R_{B}²=hydrogen and (R_{B}³)=2-OMe (S4-3),
R_{B}¹=isopropyl, R_{B}²=hydrogen and (R_{B}³)=5-Cl-2-OMe (S4-4) and
   R_{B}¹=isopropyl, R_{B}²=hydrogen and (R_{B}³)=2-OMe (S4-5);
S4^{c}) compounds of the class of benzoylsulphamoylphenylureas of the formula (S4^{c}) as described in EP-A-365484,

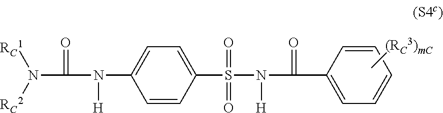

in which
R_{C}¹, R_{C}² independently of one another are hydrogen, (C₁-C₈)-alkyl, (C₃-C₈)-cycloalkyl, (C₃-C₆)-alkenyl, (C₃-C₆)-alkynyl,
R_{C}³ is halogen, (C₁-C₄)-alkyl, (C₁-C₄)-alkoxy, CF₃,
m_{C} is 1 or 2;
for example
1-[4-(N-2-methoxybenzoylsulphamoyl)phenyl]-3-methylurea (,,metcamifen“, S4-6),
1-[4-(N-2-methoxybenzoylsulphamoyl)phenyl]-3,3-dimethylurea,
1-[4-(N-4,5-dimethylbenzoylsulphamoyl)phenyl]-3-methylurea;
   S4^{d}) compounds of the type of N-phenylsulphonylterephthalamides of the formula (S4^{d}) and salts thereof, which are known, for example, from CN 101838227,

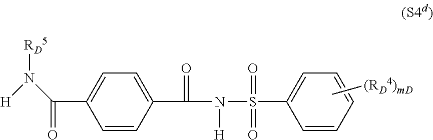

in which
R_{D}⁴ is halogen, (C₁-C₄)-alkyl, (C₁-C₄)-alkoxy, CF₃;
m_{D} is 1 or 2;
R_{D}⁵ is hydrogen, (C₁-C₆)-alkyl, (C₃-C₆)-cycloalkyl, (C₂-C₆)-alkenyl, (C₂-C₆)-alkynyl, (C₅-C₆)-cycloalkenyl.
S5) Active compounds from the class of hydroxyaromatics and aromatic-aliphatic carboxylic acid derivatives (S5), for example ethyl 3,4,5-triacetoxybenzoate, 3,5-dimethoxy-4-hydroxybenzoic acid, 3,5-dihydroxybenzoic acid, 4-hydroxysalicylic acid, 4-fluorosalicyclic acid, 2-hydroxycinnamic acid, 2,4-dichlorocinnamic acid, as described in WO-A-2004/084631, WO-A-2005/015994, WO-A-2005/016001.
S6) Active compounds from the class of 1,2-dihydroquinoxalin-2-ones (S6), for example 1-methyl-3-(2-thienyl)-1,2-dihydroquinoxalin-2-one, 1-methyl-3-(2-thienyl)-1,2-dihydroquinoxaline-2-thione, 1-(2-aminoethyl)-3-(2-thienyl)-1,2-dihydroquinoxalin-2-one hydrochloride, 1-(2-methylsulphonylaminoethyl)-3-(2-thienyl)-1,2-dihydroquinoxalin-2-one, as described in WO-A-2005/112630.
S7) Compounds from the class of diphenylmethoxyacetic acid derivatives (S7), for example methyl diphenylmethoxyacetate (CAS-Reg.Nr. 41858-19-9) (S7-1), ethyl diphenylmethoxyacetate, or diphenylmethoxyacetic acid, as described in WO-A-98/38856.
S8) Compounds of the formula (S8), as described in WO-A-98/27049,
   where the symbols and indices have the following meanings:

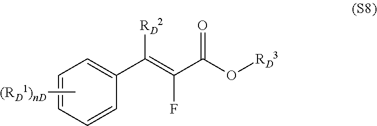

R_{D}¹ is halogen, (C₁-C₄)-alkyl, (C₁-C₄)-haloalkyl, (C₁-C₄)-alkoxy, (C₁-C₄)-haloalkoxy,
   R_{D}² is hydrogen or (C₁-C₄)-alkyl,
   R_{D}³ is hydrogen, (C₁-C₅)-alkyl, (C₂-C₄)-alkenyl, (C₂-C₄)-alkynyl or aryl, where each of the carbon-containing radicals mentioned above is unsubstituted or substituted by one or more, preferably by up to three, identical or different radicals from the group consisting of halogen and alkoxy; or salts thereof,
   n_{D} is an integer from 0 to 2.
S9) Active compounds from the class of 3-(5-tetrazolylcarbonyl)-2-quinolones (S9), for example 1,2-dihydro-4-hydroxy-1-ethyl-3-(5-tetrazolylcarbonyl)-2-quinolone (CAS Reg. No.: 219479-18-2), 1,2-dihydro-4-hydroxy-1-methyl-3-(5-tetrazolylcarbonyl)-2-quinolone (CAS Reg. No.: 95855-00-8), as described in WO-A-1999/000020.
S10) Compounds of the formula (S10^{a}) or (S10^{b}) as described in WO-A-2007/023719 and WO-A-2007/023764 in which

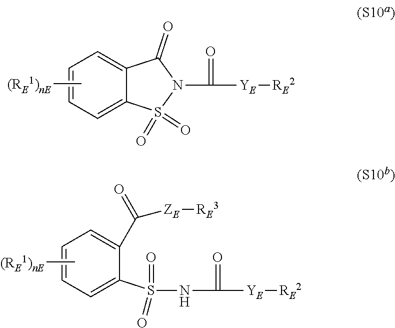

R_{E}¹ is halogen, (C₁-C₄)-alkyl, methoxy, nitro, cyano, CF₃, OCF₃
Y_{E}, Z_{E} independently of one another are O or S,
n_{E} is an integer from 0 to 4,
R_{E}² is (C₁-C₁₆)-alkyl, (C₂-C₆)-alkenyl, (C₃-C₆)-cycloalkyl, aryl; benzyl, halobenzyl,
R_{E}³ is hydrogen or (C₁-C₆)-alkyl.
S11) Active compounds of the type of oxyimino compounds (S11), which are known as seed dressings, such as, for example,
   “oxabetrinil” ((Z)-1,3-dioxolan-2-ylmethoxyimino(phenyl)acetonitrile) (S11-1), which is known as seed dressing safener for millet against metolachlor damage,
   “fluxofenim” (1-(4-chlorophenyl)-2,2,2-trifluoro-1-ethanone O-(1,3-dioxolan-2-ylmethyl)oxime) (S11-2), which is known as seed dressing safener for millet against metolachlor damage, and
   “cyometrinil” or “CGA-43089” ((Z)-cyanomethoxyimino(phenyl)acetonitrile) (S11-3), which is known as seed dressing safener for millet against metolachlor damage.
S12) Active compounds from the class of isothiochromanones (S12), such as, for example, methyl [(3-oxo-1H-2-benzothiopyran-4(3H)-ylidene)methoxy]acetate (CAS Reg. No.: 205121-04-6) (512-1) and related compounds from WO-A-1998/13361.
S13) One or more compounds from group (S13):
   “naphthalic anhydrid” (1,8-naphthalenedicarboxylic anhydride) (S13-1), which is known as seed dressing safener for corn against thiocarbamate herbicide damage,
   “fenclorim” (4,6-dichloro-2-phenylpyrimidine) (S13-2), which is known as safener for pretilachlor in sown rice,
   “flurazole” (benzyl 2-chloro-4-trifluoromethyl-1,3-thiazole-5-carboxylate) (S13-3), which is known as seed dressing safener for millet against alachlor and metolachlor damage,
   “CL 304415” (CAS Reg. No.: 31541-57-8)
   (4-carboxy-3,4-dihydro-2H-1-benzopyran-4-acetic acid) (S13-4) from American Cyanamid, which is known as safener for corn against imidazolinone damage,
   “MG 191” (CAS Reg. No.: 96420-72-3) (2-dichloromethyl-2-methyl-1,3-dioxolane) (S13-5) from Nitrokemia, which is known as safener for corn,
   “MG 838” (CAS Reg. No.: 133993-74-5)
   (2-propenyl 1-oxa-4-azaspiro[4.5]decane-4-carbodithioate) (S13-6) from Nitrokemia,
   “disulphoton” (0,0-diethyl S-2-ethylthioethyl phosphorodithioate) (S13-7),
   “dietholate” (0,0-diethyl 0-phenyl phosphorothioate) (S13-8),
   “mephenate” (4-chlorophenyl methylcarbamate) (S13-9).
S14) Active compounds which, besides a herbicidal effect against harmful plants, also have a safener effect on crop plants such as rice, such as, for example, “dimepiperate” or “MY 93” (S-1-methyl-1-phenylethyl piperidine-1-carbothioate), which is known as safener for rice against molinate herbicide damage,
   “daimuron” or “SK 23” (1-(1-methyl-1-phenylethyl)-3-p-tolylurea), which is known as safener for rice against imazosulphuron herbicide damage,
   “cumyluron”=“JC 940” (3-(2-chlorophenylmethyl)-1-(1-methyl-1-phenylethyl)urea, see JP-A-60087254), which is known as safener for rice against some herbicide damage,
   “methoxyphenone” or “NK 049” (3,3′-dimethyl-4-methoxybenzophenone), which is known as safener for rice against some herbicide damage,
   “CSB” (1-bromo-4-(chloromethylsulphonyl)benzene) from Kumiai (CAS Reg. No. 54091-06-4), which is known as safener against some herbicide damage in rice.
S15) Compounds of the formula (S15) or its tautomers,

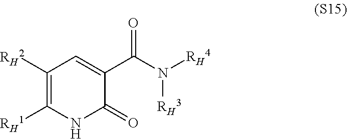

as described in WO-A-2008/131861 and WO-A-2008/131860,
in which
R_{H}¹ is (C₁-C₆)-haloalkyl,
R_{H}² is hydrogen or halogen,
R_{H}³, R_{H}⁴ independently of one another are hydrogen, (C₁-C₁₆)-alkyl, (C₂-C₁₆)-alkenyl or (C₂-C₁₆)-alkynyl,
   where each of the 3 last-mentioned radicals is unsubstituted or substituted by one or more radicals from the group consisting of halogen, hydroxy, cyano, (C₁-C₄)-alkoxy, (C₁-C₄)-haloalkoxy, (C₁-C₄)-alkylthio, (C₁-C₄)-alkylamino, di-[(C₁-C₄)-alkyl]-amino, [(C₁-C₄)-alkoxy]-carbonyl, [(C₁-C₄)-haloalkoxy]-carbonyl, unsubstituted or substituted (C₃-C₆)-cycloalkyl, unsubstituted or substituted phenyl, and unsubstituted or substituted heterocyclyl;
or (C₃-C₆)-cycloalkyl, (C₄-C₆)-cycloalkenyl, (C₃-C₆)-cycloalkyl which is at one site of the ring condensed with a 4 to 6-membered saturated or unsaturated carbocyclic ring, or (C₄-C₆)-cycloalkenyl which is at one site of the ring condensed with a 4 to 6-membered saturated or unsaturated carbocyclic ring,
   where each of the 4 last-mentioned radicals is unsubstituted or substituted by one or more radicals from the group consisting of halogen, hydroxy, cyano, (C₁-C₄)-alkyl, (C₁-C₄)-haloalkyl, (C₁-C₄)-alkoxy, (C₁-C₄)-haloalkoxy, (C₁-C₄)-alkylthio, (C₁-C₄)-alkylamino, di-(C₁-C₄)-alkyl]-amino, [(C₁-C₄)-alkoxy]-carbonyl, [(C₁-C₄)-haloalkoxy]-carbonyl, unsubstituted or substituted (C₃-C₆)-cycloalkyl, unsubstituted or substituted phenyl, and unsubstituted or substituted heterocyclyl; or
R_{H}³ is (C₁-C₄)-alkoxy, (C₂-C₄)-alkenyloxy, (C₂-C₆)-alkynyloxy or (C₂-C₄)-haloalkoxy, and
R_{H}⁴ is hydrogen or (C₁-C₄)-alkyl, or
R_{H}³ and R_{H}⁴ together with the directly bound N-atom are a 4 to 8-membered heterocyclic ring, which can contain further hetero ring atoms besides the N-atom, preferably up to two further hetero ring atoms from the group consisting of N, O and S, and which is unsubstituted or substituted by one or more radicals from the group consisting of halogen, cyano, nitro, (C₁-C₄)-alkyl, (C₁-C₄)-haloalkyl, (C₁-C₄)-alkoxy, (C₁-C₄)-haloalkoxy, and (C₁-C₄)-alkylthio.
S16) Active compounds which are primarily used as herbicides, but also have safener effect on crop plants, for example
(2,4-dichlorophenoxy)acetic acid (2,4-D),
(4-chlorophenoxy)acetic acid,
(R,S)-2-(4-chloro-o-tolyloxy)propionic acid (mecoprop),
4-(2,4-dichlorophenoxy)butyric acid (2,4-DB),
(4-chloro-o-tolyloxy)acetic acid (MCPA),
4-(4-chloro-o-tolyloxy)butyric acid,
4-(4-chlorophenoxy)butyric acid,
3,6-dichloro-2-methoxybenzoic acid (dicamba),
1-(ethoxycarbonyl)ethyl 3,6-dichloro-2-methoxybenzoate (lactidichlor-ethyl).

### Insecticides/Acaricides/Nematicides:

The active ingredients specified herein by their “common name” are known and described, for example, in the Pesticide Manual (“The Pesticide Manual”, 14th Ed., British Crop Protection Council 2006) or can be searched in the internet (e.g. http://www.aluiwoodiet/pesticides).
(1) Acetylcholinesterase (AChE) inhibitors, for example carbamates, e.g. Alanycarb, Aldicarb, Bendiocarb, Benfuracarb, Butocarboxim, Butoxycarboxim, Carbaryl, Carbofuran, Carbosulfan, Ethiofencarb, Fenobucarb, Formetanate, Furathiocarb, Isoprocarb, Methiocarb, Methomyl, Metolcarb, Oxamyl, Pirimicarb, Propoxur, Thiodicarb, Thiofanox, Triazamate, Trimethacarb, XMC and Xylylcarb or organophosphates, e.g. Acephate, Azamethiphos, Azinphos-ethyl, Azinphos-methyl, Cadusafos, Chlorethoxyfos, Chlorfenvinphos, Chlormephos, Chlorpyrifos, Chlorpyrifos-methyl, Coumaphos, Cyanophos, Demeton-S-methyl, Diazinon, Dichlorvos/DDVP, Dicrotophos, Dimethoate, Dimethylvinphos, Disulfoton, EPN, Ethion, Ethoprophos, Famphur, Fenamiphos, Fenitrothion, Fenthion, Fosthiazate, Heptenophos, Imicyafos, Isofenphos, Isopropyl O-(methoxyaminothio-phosphoryl)salicylate, Isoxathion, Malathion, Mecarbam, Methamidophos, Methidathion, Mevinphos, Monocrotophos, Naled, Omethoate, Oxydemeton-methyl, Parathion, Parathion-methyl, Phenthoate, Phorate, Phosalone, Phosmet, Phosphamidon, Phoxim, Pirimiphos-methyl, Profenofos, Propetamphos, Prothiofos, Pyraclofos, Pyridaphenthion, Quinalphos, Sulfotep, Tebupirimfos, Temephos, Terbufos, Tetrachlorvinphos, Thiometon, Triazophos, Trichlorfon and Vamidothion.
(2) GABA-gated chloride channel antagonists, for example cyclodiene organochlorines, e. g. Chlordane and Endosulfan, or phenylpyrazoles (fiproles), e. g. Ethiprole and Fipronil.
(3) Sodium channel modulators/voltage-dependent sodium channel blockers, for example pyrethroids, e.g. Acrinathrin, Allethrin, d-cis-trans Allethrin, d-trans Allethrin, Bifenthrin, Bioallethrin, Bioallethrin S-cyclopentenyl isomer, Bioresmethrin, Cycloprothrin, Cyfluthrin, beta-Cyfluthrin, Cyhalothrin, lambda-Cyhalothrin, gamma-Cyhalothrin, Cypermethrin, alpha-Cypermethrin, beta-Cypermethrin, theta-Cypermethrin, zeta-Cypermethrin, Cyphenothrin [(1R)-trans isomers], Deltamethrin, Empenthrin [(EZ)-(1R) isomers), Esfenvalerate, Etofenprox, Fenpropathrin, Fenvalerate, Flucythrinate, Flumethrin, tau-Fluvalinate, Halfenprox, Imiprothrin, Kadethrin, Momfluorothrin, Permethrin, Phenothrin [(1R)-trans isomer), Prallethrin, Pyrethrine (pyrethrum), Resmethrin, Silafluofen, Tefluthrin, Tetramethrin, Tetramethrin [(1R) isomers)], Tralomethrin and Transfluthrin or DDT or Methoxychlor.
(4) Nicotinic acetylcholine receptor (nAChR) agonists, for example neonicotinoids, e. g. Acetamiprid, Clothianidin, Dinotefuran, Imidacloprid, Nitenpyram, Thiacloprid and Thiamethoxam or Nicotine or Sulfoxaflor or Flupyridafurone.
(5) Nicotinic acetylcholine receptor (nAChR) allosteric activators, for example spinosyns, e. g. Spinetoram and Spinosad.
(6) Chloride channel activators, for example avermectins/milbemycins, e. g. Abamectin, Emamectin benzoate, Lepimectin and Milbemectin.
(7) Juvenile hormone mimics, for example juvenile hormon analogues, e. g. Hydroprene, Kinoprene and Methoprene or Fenoxycarb or Pyriproxyfen.
(8) Miscellaneous non-specific (multi-site) inhibitors, for example alkyl halides, e. g. Methyl bromide and other alkyl halides; or Chloropicrin or Sulfuryl fluoride or Borax or Tartar emetic.
(9) Selective homopteran feeding blockers, e. g. Pymetrozine or Flonicamid.
(10) Mite growth inhibitors, e. g. Clofentezine, Hexythiazox and Diflovidazin or Etoxazole.
(11) Microbial disruptors of insect midgut membranes, e. g. Bacillus thuringiensis subspecies israelensis, Bacillus sphaericus, Bacillus thuringiensis subspecies aizawai, Bacillus thuringiensis subspecies kurstaki, Bacillus thuringiensis subspecies tenebrionis and BT crop proteins: Cry1Ab, Cry1Ac, Cry1Fa, Cry2Ab, mCry3A, Cry3Ab, Cry3Bb, Cry34/35Ab1.
(12) Inhibitors of mitochondrial ATP synthase, for example Diafenthiuron or organotin miticides, e. g. Azocyclotin, Cyhexatin and Fenbutatin oxide or Propargite or Tetradifon.
(13) Uncouplers of oxidative phoshorylation via disruption of the proton gradient, for example Chlorfenapyr, DNOC and Sulfluramid.
(14) Nicotinic acetylcholine receptor (nAChR) channel blockers, for example Bensultap, Cartap hydrochloride, Thiocyclam and Thiosultap-sodium.
(15) Inhibitors of chitin biosynthesis, type 0, for example Bistrifluron, Chlorfluazuron, Diflubenzuron, Flucycloxuron, Flufenoxuron, Hexaflumuron, Lufenuron, Novaluron, Noviflumuron, Teflubenzuron and Triflumuron.
(16) Inhibitors of chitin biosynthesis, type 1, for example Buprofezin.
(17) Moulting disruptors, for example Cyromazine.
(18) Ecdysone receptor agonists, for example Chromafenozide, Halofenozide, Methoxyfenozide and Tebufenozide.
(19) Octopamine receptor agonists, for example Amitraz.
(20) Mitochondrial complex III electron transport inhibitors, for example Hydramethylnon or Acequinocyl or Fluacrypyrim.
(21) Mitochondrial complex I electron transport inhibitors, for example METI acaricides, e. g. Fenazaquin, Fenpyroximate, Pyrimidifen, Pyridaben, Tebufenpyrad and Tolfenpyrad or Rotenone (Derris).
(22) Voltage-dependent sodium channel blockers, e. g. Indoxacarb or Metaflumizone.
(23) Inhibitors of acetyl CoA carboxylase, for example tetronic and tetramic acid derivatives, e. g. Spirobudiclofen, Spirodiclofen, Spiromesifen and Spirotetramat.
(24) Mitochondrial complex IV electron transport inhibitors, for example phosphines, e. g. Aluminium phosphide, Calcium phosphide, Phosphine and Zinc phosphide or Cyanide.
(25) Mitochondrial complex II electron transport inhibitors, for example Cyenopyrafen and Cyflumetofen.
(28) Ryanodine receptor modulators, for example diamides, e. g. Chlorantraniliprole, Cyantraniliprole, Flubendiamide and Tetrachloroantraniliprole.

Further active ingredients with unknown or uncertain mode of action, for example Afidopyropen, Afoxolaner, Azadirachtin, Benclothiaz, Benzoximate, Bifenazate, Broflanilide, Bromopropylate, Chinomethionat, Cryolite, Cyclaniliprole, Cycloxaprid, Cyhalodiamide Dicloromezotiaz, Dicofol, Diflovidazin, Flometoquin, Fluazaindolizine, Fluensulfone, Flufenerim, Flufenoxystrobin, Flufiprole, Fluhexafon, Fluopyram, Fluralaner, Fluxametamide, Fufenozide, Guadipyr, Heptafluthrin, Imidaclothiz, Iprodione, Lotilaner, Meperfluthrin, Paichongding, Pyflubumide, Pyridalyl, Pyrifluquinazon, Pyriminostrobin, Sarolaner, Tetramethylfluthrin, Tetraniliprole, Tetrachlorantraniliprole, Tioxazafen, Thiofluoximate, Triflumezopyrim and Iodomethane; furthermore products based on Bacillus firmus (including but not limited to strain CNCM I-1582, such as, for example,VOTiVO TM, BioNem) or one of the following known active compounds: 1-{2-fluoro-4-methyl-5-[(2,2,2-trifluorethyl)sulfinyl]phenyl}-3-(trifluoromethyl)-1H-1,2,4-triazol-5-amine (known from WO2006/043635), {1′-[(2E)-3-(4-chlorophenyl)prop-2-en-1-yl]-5-fluorospiro[indole-3,4′-piperidin]-1(2H)-yl}(2-chloropyridin-4-yl)methanone (known from WO2003/106457), 2-chloro-N-[2-{1-[(2E)-3-(4-chlorophenyl)prop-2-en-1-yl]piperidin-4-yl}-4-(trifluoromethyl)phenyl]isonicotinamide (known from WO2006/003494), 3-(2,5-dimethylphenyl)-4-hydroxy-8-methoxy-1,8-diazaspiro[4.5]dec-3-en-2-one (known from WO2009/049851), 3-(2,5-dimethylphenyl)-8-methoxy-2-oxo-1,8-diazaspiro[4.5]dec-3-en-4-yl ethyl carbonate (known from WO2009/049851), 4-(but-2-yn-1-yloxy)-6-(3,5-dimethylpiperidin-1-yl)-5-fluoropyrimidine (known from WO2004/099160), 4-(but-2-yn-1-yloxy)-6-(3-chlorophenyl)pyrimidine (known from WO2003/076415), PF1364 (CAS-Reg.No. 1204776-60-2), methyl 2-[2-({[3-bromo-1-(3-chloropyridin-2-yl)-1H-pyrazol-5-yl]carbonyl}amino)-5-chloro-3-methylbenzoyl]-2-methylhydrazinecarboxylate (known from WO2005/085216), methyl 2-[2-({[3-bromo-1-(3-chloropyridin-2-yl)-1H-pyrazol-5-yl]carbonyl}amino)-5-cyano-3-methylbenzoyl]-2-ethylhydrazinecarboxylate (known from WO2005/085216), methyl 2-[2-({[3-bromo-1-(3-chloropyridin-2-yl)-1H-pyrazol-5-yl]carbonyl}amino)-5-cyano-3-methylbenzoyl]-2-methylhydrazinecarboxylate (known from WO2005/085216), methyl 2-[3,5-dibromo-2-({[3-bromo-1-(3-chloropyridin-2-yl)-1H-pyrazol-5-yl]carbonyl}amino)benzoyl]-2-ethylhydrazinecarboxylate (known from WO2005/085216), N-[2-(5-amino-1,3,4-thiadiazol-2-yl)-4-chloro-6-methylphenyl]-3-bromo-1-(3-chloropyridin-2-yl)-1H-pyrazole-5-carboxamide (known from CN102057925), 8-chloro-N-[(2-chloro-5-methoxyphenyl)sulfonyl]-6-(trifluoromethyl)imidazo[1,2-a]pyridine-2-carboxamide (known from WO2009/080250), N-[(2E)-1-[(6-chloropyridin-3-yl)methyl]pyridin-2(1H)-ylidene]-2,2,2-trifluoroacetamide (known from WO2012/029672), 1-[(2-chloro-1,3-thiazol-5-yl)methyl]-4-oxo-3-phenyl-4H-pyrido[1,2-a]pyrimidin-1-ium-2-olate (known from WO2009/099929), 1-[(6-chloropyridin-3-yl)methyl]-4-oxo-3-phenyl-4H-pyrido[1,2-a]pyrimidin-1-ium-2-olate (known from WO2009/099929), 4-(3-{2,6-dichloro-4-[(3,3-dichloroprop-2-en-1-yl)oxy]phenoxy}propoxy)-2-methoxy-6-(trifluoromethyl)pyrimidine (known from CN101337940), N-[2-(tert-butylcarbamoyl)-4-chloro-6-methylphenyl]-1-(3-chloropyridin-2-yl)-3-(fluoromethoxy)-1H-pyrazole-5-carboxamide (known from WO2008/134969), butyl [2-(2,4-dichlorophenyl)-3-oxo-4-oxaspiro[4.5]dec-1-en-1-yl]carbonate (known from CN 102060818), 3E)-3-[1-[(6-chloro-3-pyridyl)methyl]-2-pyridylidene]-1,1,1-trifluoro-propan-2-one (known from WO2013/144213), N-(methylsulfonyl)-6-[2-(pyridin-3-yl)-1,3-thiazol-5-yl]pyridine-2-carboxamide (known from WO2012/000896), N-[3-(benzylcarbamoyl)-4-chlorophenyl]-1-methyl-3-(pentafluoroethyl)-4-(trifluoromethyl)-1H-pyrazole-5-carboxamide (known from WO2010/051926), 5-bromo-4-chloro-N-[4-chloro-2-methyl-6-(methylcarbamoyl)phenyl]-2-(3-chloro-2-pyridyl)pyrazole-3-carboxamido (known from CN103232431), ), Tioxazafen, 4-[5-(3,5-dichlorophenyl)-4,5-dihydro-5-(trifluoromethyl)-3-isoxazolyl]-2-methyl-N-(cis-1-oxido-3-thietanyl)-benzamide, 4-[5-(3,5-dichlorophenyl)-4,5-dihydro-5-(trifluoromethyl)-3-isoxazolyl]-2-methyl-N-(trans-1-oxido-3-thietanyl)-benzamide and 4-[(5S)-5-(3,5-dichlorophenyl)-4,5-dihydro-5-(trifluoromethyl)-3-isoxazolyl]-2-methyl-N-(cis-1-oxido-3-thietanyl)benzamide (known from WO 2013050317 A1), N-[3-chloro-1-(3-pyridinyl)-1H-pyrazol-4-yl]-N-ethyl-3-[(3,3,3-trifluoropropyl)sulfinyl]-propanamide, (+)-N-[3-chloro-1-(3-pyridinyl)-1H-pyrazol-4-yl]-N-ethyl-3-[(3,3,3-trifluoropropyl)sulfinyl]-propanamide and (−)-N-[3-chloro-1-(3-pyridinyl)-1H-pyrazol-4-yl]-N-ethyl-3-[(3,3,3-trifluoropropyl)sulfinyl]-propanamide (known from WO 2013162715 A2, WO 2013162716 A2, US 20140213448 A1), 5-[[(2E)-3-chloro-2-propen-1-yl]amino]-1-[2,6-dichloro-4-(trifluoromethyl)phenyl]-4-[(trifluoromethyl)sulfinyl]-1H-pyrazole-3-carbonitrile (known from CN 101337937 A), 3-bromo-N-[4-chloro-2-methyl-6-[(methylamino)thioxomethyl]phenyl]-1-(3-chloro-2-pyridinyl)-1H-pyrazole-5-carboxamide, (Liudaibenjiaxuanan, known from CN 103109816 A); N-[4-chloro-2-[[(1,1-dimethylethyl)amino]carbonyl]-6-methylphenyl]-1-(3-chloro-2-pyridinyl)-3-(fluoromethoxy)-1H-Pyrazole-5-carboxamide (known from WO 2012034403 A1), N-[2-(5-amino-1,3,4-thiadiazol-2-yl)-4-chloro-6-methylphenyl]-3-bromo-1-(3-chloro-2-pyridinyl)-1H-pyrazole-5-carboxamide (known from WO 2011085575 A1), 4-[3-[2,6-dichloro-4-[(3,3-dichloro-2-propen-1-yl)oxy]phenoxy]propoxy]-2-methoxy-6-(trifluoromethyl)-pyrimidine (known from CN 101337940 A); (2E)- and 2(Z)-2-[2-(4-cyanophenyl)-1-[3-(trifluoromethyl)phenyl]ethylidene]-N-[4-(difluoromethoxy)phenyl]-hydrazinecarboxamide (known from CN 101715774 A); 3-(2,2-dichloroethenyl)-2,2-dimethyl-4-(1H-benzimidazol-2-yl)phenyl-cyclopropanecarboxylic acid ester (known from CN 103524422 A); (4aS)-7-chloro-2,5-dihydro-2-[[(methoxycarbonyl)[4-[(trifluoromethyl)thio]phenyl]amino]carbonyl]-indeno[1,2-e][1,3,4]oxadiazine-4a(3H)-carboxylic acid methyl ester (known from CN 102391261 A).

Preferred active compounds are selected from the group comprising SDH-Inhibitors, nAChR-Agonists (including neonicotinoides), chlorotica including PDS inhibitors (HRAC F1) and HPPD inhibitors (HRAC F2) and thiadiazole carboxamides/host defence inducers.

Typical bactericidal agents include streptomycin, penicillins, tetracyclines, ampicillin, and oxolinic acid.

Coating compositions are often packaged, stored and/or transported and only thereafter combined with formulations such as plant enhancing agents, for example growth regulators and/or plant stimulants.

The loading of active agent to be added in the seed coating composition typically ranges from about 0.001 to about 10% of the weight of the seed and preferably from about 0.01 to 2.0%. However, for a particular situation the amounts may be greater or less. For example, a fungicide can be included in the seed coating composition in an amount of 0.0001-10 wt. %, based on the total weight of/kg of the coated seed.

Biological treatment may also be used to enhance seed performance and help in the control of harmful organisms.

In an example, the matrix may also comprise biocontrol agents such as bacteria of the genera Rhizobium, Bacillus, Pseudomonas, and Serratia, fungi of the genera Trichoderma, Glomus, and Gliocladium and mycorrhizal fungi.

The above summarized lists are necessarily not exhaustive, new active agents and or active ingredients are continuously developed and can be incorporated in a seed treatment or coating composition.

Seed treatment or coating compositions and therefore the matrix in the sense of the present invention typically also comprise one or more binders, one or more filler (s), and an effective amount of one or more active agents.

The binder serves as a matrix for the one or more active agents and is preferably present in the seed coating in an amount adequate to ensure adherence of the entire matrix and all active agents to the seed and/or prevent or reduce the levels of phytotoxicity caused by the one or more active agent(s). The specific binder(s) will depend on the properties of the one or more active agents.

The binder component of the coating is composed preferably of an adhesive polymer that may be natural or synthetic and shows no negative, adverse effects to environment, seeds or human safety. The binder may be selected from polyvinyl acetates, polyvinyl acetate copolymers (-ethylene), polyvinyl alcohols, polyvinyl alcohol copolymers, celluloses, including ethylcelluloses and methylcelluloses, hydroxymethylcelluloses, hydroxypropylcellulose, hydroxymethylpropylcelluloses, polyvinylpyrolidones, dextrins, maltodextrins, polysaccharides, fats, oils, proteins, gum arabics, shellacs, vinylidene chloride, vinylidene chloride copolymers, calcium lignosulfonates, acrylic copolymers, starches, polyacrylates, polyvinylacrylates, polyurethans, zeins, gelatin, carboxymethylcellulose, chitosan, polyethylene oxide, polystyrenes, polybutadienes, acrylimide polymers and copolymers, polyhydroxyethyl acrylate, methylacrylimide monomers, alginate, ethylcellulose, polychloroprene and syrups, combinations of polyvinyl alcohol and sucrose or mixtures thereof. Preferred binders include polymers and copolymers of vinyl acetate, methyl cellulose, polyvinyl alcohol, vinylidene chloride, acrylic, cellulose, polyvinylpyrrolidone and polysaccharide or combination thereof. Particularly used classes of polymers include polymers and copolymers of vinylidene chloride and vinyl acetateethylene copolymers. Further binders may be molasses, granulated sugar, alginates, karaya gum, jaguar gum, tragacanth gum, polysaccharide gum, mucilage or combination thereof.

The amount of binder in the coating may be in the range of about 0.01 to 15% of the weight of the seed. A preferred range will be about 0.1 to 10.0% of the weight of the seed.

The matrix of the present invention may comprise fillers for seed coatings, which may be absorbent or inert fillers. Fillers are known in the art and may include wood-flours, clays, activated carbon, sugars, diatomaceous earth, cereal flours, fine-grain inorganic solids, calcium carbonate and the like. Clays and inorganic solids which may be used include calcium bentonite, kaolin, china clay, talcum, perlite, vermiculite, mica, silicas, quartz powder, montmorillonite, other state of the art gloss components and mixtures thereof. Sugars which may be used include dextrin and maltodextrin. Cereal flours include wheat flour, oat flour and barley flour. Preferred fillers include diatomaceous earth, perlite, silica and calcium carbonates and mixtures thereof. One skilled in the art will appreciate that this is a non-exhaustive list of materials and that other recognized filler materials may be used depending on the seed to be coated and the one or more active agent(s) used in the coating.

If present, the filler is typically chosen so that it will provide a proper microclimate for the seed, for example the filler is used to increase the loading rate of the active ingredient and to adjust the control-release of the active ingredient. A filler aids in the production or process of coating the seed. The effect varies, because in some instances formulated active agent compounds will comprise a filler. The amount of filler used may vary, but generally the weight of the filler components will be in the range of about 0.005 to 70% of the seed weight, more preferably about 0.01 to 50% and most preferably about 0.1 to 15%.

In an example the coated seed comprises one or more binder(s) in an amount from about 0.01 to about 15% of the weight of the seed, a filler in an amount of up to about 70% of the weight of the seed, one or more active agents in an amount from about 0.005 to about 50% of the weight of the seed.

In some embodiments the matrix may comprise a plasticizer. Plasticizers are typically used to make the film that is formed by the coating layer more flexible, improve adhesion, spreadability and improve the speed during processing. The improved film flexibility is important to minimize chipping, breakage or flaking during handling or sowing processes. Many plasticizers may be used however, most common plasticizers include polyethylene glycol, glycerol, butylbenzylphthalate, glycol benzoates, propylene glycol, polyglycols and related compounds.

Conventional means of coating may be used for carrying out the coating; various coating machines are available to one skilled in the art. Three well known techniques include the use of drum coaters, fluidized bed techniques or spouted beds. After coating the dried seeds are optionally sized by transfer to a sizing machine before or after coating.

Film-forming compositions for enveloping coated seeds are well known in the art, and a film overcoating can be optionally applied to the coated seeds. The film overcoat protects the coating layers and optionally allows for easy identification of the treated seeds. In general, additives are dissolved or dispersed in a liquid adhesive, usually a polymer into or with which seeds are dipped or sprayed before drying. Alternatively, a powder adhesive can be used. Various materials are suitable for overcoating including but not limited to, methyl cellulose, hydroxypropylmethylcellulose, dextrin, gums, waxes, vegetable or paraffin oils; water soluble or water disperse polysaccharides and their derivatives such as alginates, starch, and cellulose; and synthetic polymers such as polyethylene oxide, polyvinyl alcohol and polyvinylpyrrolidone and their copolymers and related polymers and mixtures of these. Further materials may be added to the overcoat including optionally plasticizers, colorants, brighteners, wetting agents and surface active agents such as, dispersants, emulsifiers and flow agents including for example, calcium stearate, talcum and vermiculite.

The matrix may further comprise antifoaming agents, antiseptics, thickening agents, dispersants, anti-freeze agents, adhesive agents, and the like. Additives and said further material are also together referred to as functional agents. The skilled person will appreciate that the above components are listed as examples and are not intended to be an exhaustive list of components that can be used in one or more seed coating layers. However, the examples listed above show the extreme variability of a matrix in the sense of the present invention and one skilled in the art will recognize that a facile and useable method for quantification of one or more chemical substances in such complex matrices should be able to cope with such complexity.

The solution of the present invention makes use of a multivariate correlation model trained for computing a loading value of the chemical substance(s) of interest based on a signature spectrum relevant for the chemical substance(s) at stake in consideration of matrix influences.

The term “matrix influences” as used herein comprises information related to the sample in relation with:
Seed variety, hybrids or traits, gender (male/female), seed size (range) or shape, geographical origin area, surface roughness,
Production date, storage stability,
Wear resistance or coating strength,
Coating composition, coating components and their dosage (including additional functional agents),
Form or formulation of the coating components in the seed coating composition, for example as a solid, such as a (wettable) powder, water-soluble formulations, liquid formulations, applicable liquids, aqueous suspensions, dispersions or emulsions, microcapsule preparations, just to give a few examples, mean particle size of solid components (D50 or D90) for example as measured by laser obscuration time technology,
Pre-coating treatment(s) such as removing part of the cuticle, removing part of the pericarp, in particular the epicarp, surface treatment such as seed abrasion, degreasing, plasma treatment, application of a primer layer, soaking or exposure to hot/humid air, etc.;
Coating method, coating equipment such as but not limited to drum coaters, fluidized beds, rotary coaters, side vended pan, tumble mixers and spouted beds, chemical pre-coating-treatments of the seed,
Coating layers, arrangement and composition thereof,
Post-coating treatments and/or conditions of storage, or
a combination thereof.

Further “matrix influences” information may relate to physical property parameters of seeds such as bulk flowing properties, dust binding strength or dust value, for example as measured using a Heubach dust-meter device according to Euroseeds reference method “Assessment of free-floating dust and abrasion particles of treated seeds as a parameter of the quality of treated seeds”.

Most relevant matrix influences on the spectroscopic evaluation were found to be seed variety, hybrids or traits, seed size, shape and coating composition, coating components and their dosage.

The skilled person understands that features of various embodiments may be combined with each other. For the correlation of the results of the spectroscopic measurements to the loading of the chemical substance of interest on the seeds, the actual amount of the chemical substance of interest is very important. This actual amount is measured for training and validation samples using one of the reference quantification methods established in the field, in particular, using chromatographic methods such as High Pressure Liquid Chromatography (HPLC), Ultra Performance Liquid Chromatography (UPLC) or Gas Chromatography (GC), gravimetric methods based on the applied product masses, or mass spectrometry.

Correlating a loading value with high error in the reference quantification method may lead to misinterpretation of the results. The method therefore requires accurate calibration depending on the matrix and the chemical substance to be quantified. A multivariate calibration was developed which comprises conducting spectrum pre-treating steps and a multivariate data analysis using a multivariate correlation model trained for computing a loading value of the chemical substance(s) based on a signature spectrum relevant for the chemical substance(s) at stake in consideration of matrix influences.

For simultaneous analysis of multiple active agents, individual calibration for each chemical substance to be quantified or for each combination formulation to be quantified, as the case may be, is used. Validations were designed and carefully developed to prove cross-insensitivity between the chemical substance/combination formulation to be quantified and the matrix components. In other words, several, individual calibrations are used if more than one chemical substance or combination formulation is to be quantified.

A further object of the present invention is therefore a computer-implemented method for provision of a calibration for a chemical substance to be quantified in a matrix, said matrix being defined by its further coating components and said bulk material, according to Claim 10. Exemplary embodiments of the method can be gathered from Claims 11 to 12.

Said calibration comprises conducting spectrum pre-treating steps and a multivariate data analysis using a multivariate correlation model for the correlation of a near-infrared, infrared or a Raman spectrum signature relevant for the chemical substance in the matrix and a reference loading value for the chemical substance in said matrix in consideration of matrix influences Said method comprises the following steps:
a. Acquiring a training data set comprising a plurality of spectrum representative of training samples and reference loading values measured for the chemical substance in the training samples, wherein the training samples are selected using a method for design of experiments so that the reference loading values for the chemical substance and matrix influences are distributed homogeneously within a variation room delimited by its boundaries;
b. Normalizing the plurality of spectrum of the training data set and selecting normalized spectrum signatures within a range of interest for the chemical substance;
c. Computing a trained multivariate correlation model based on the normalized spectrum signatures and the reference loading values of the training data set under consideration of the matrix influences using multivariate data analysis;
d. Computing a standard deviation for predictions provided by the multivariate correlation model from the reference loading values;
e. Reiterating step b. to d. until minimal standard deviation for prediction is achieved;
f. Saving the normalizing steps and the trained multivariate correlation model with minimal standard deviation for prediction as the calibration for multivariate data analysis for the chemical substance to be quantified in the matrix.

In an example and for the selection of the training data the matrix influences taken into consideration for the setting of the design of experiment (DoE) may comprise the following samples groups:

### 1. Batch Variation of Formulated Active Agent

Multiple-active compositions might show variations of the active agents within the specification. This might lead to a change in the ratio of the active agents and possibly to an influence on the readout of the spectroscopic methods.

### 2. Different Hybrids or Varieties

The seed itself may bring a strong background information into the spectra. As there are many hybrids or varieties available that could be used for seed treatment, it is preferred to clarify a possible influence of this variation.

In an example, ten other varieties of seeds with high market share can be measured both with and without treatment.

### 3. Seed Weight or Size

The size or weight of the seed itself may bring variation into the spectra. It is preferred to clarify a possible influence of this variation.

### 4. Drying Agents and Gloss Finishing if Used—

Drying agents and/or components of gloss finishing may bring a strong background information into the spectra. In an example, to check a possible influence of use of talcum alone and/or in a gloss finishing, respective samples, in which talcum comprising gloss finishing is used, can be considered in the training samples and in DoE reference samples.

The method for DoE can be chosen to ensure independent variation if the matrix influences. For the Design of Experiment method, the solution for “Calibration design” in the software OPUS from the company Bruker Corporate can be used to determine the optimal training loading distribution for the components without collinearity for a certain range. Random independent loading values are provided for the individual components.

In an example, the training examples can also comprise reference samples coated/treated with pure active agent of interest or pure other matrix components. Signals in the spectra of the coated/treated seeds can thus be correlated to the individual active agents, enabling a robust interpretation of the data.

In an example the training samples can also comprise pure seed sample without treatment/coating.

In an example normalizing the plurality of spectrum of the training data set can be achieved by way of at least first derivation, second derivation, straight line subtraction, offset correction, standard normal variate (SNV), detrend (DET), standard normal variate and detrend (SNVD), Minimum-Maximum normalization (MIN/MAX), multiplicative scatter correction (MSC), weighed multiplicative scatter correction (WMSC) or a combination thereof.

Preferred methods of pre-treatment are MCS and/or MIN/MAX, optionally in combination with first derivation.

In an example a spectral range of interest for one or more active agent(s) may be predefined or determined by way of variance analysis of the spectral signatures of the reference samples spectra or by way of comparison between spectra of samples with formulated active agent(s) and spectra of samples with pure active agent. Adequate method for variance analysis may be selected from the group comprising Principle Component Analysis (PCA), Singular Value Decomposition (SVD), Multivariate Curve Resolution (MCR) and others. Preferred method is PCA.

“Multivariate data analysis” as used herein comprises a set of statistical techniques used for analysis of data such as Partial Least Square Regression (PLS), Multi Linear Regression (MLR), Support Vector Machine Regression (SVM) and others. Method PLS was chosen because it is commonly used in the field of spectroscopy in chemical analysis.

In an example, optimization of step e) comprises varying the normalizing method or the combination of normalizing methods mentioned above and reiterating training steps (c and d) mentioned above based on the newly normalized spectrum signatures.

In a further example, optimization of step e) may also comprise varying the spectral range of interest.

In a further example, optimization of step e) may also comprise reducing the complexity of the multivariate correlation model for example by way of eliminating matrix influences. Such elimination may be achieved by way of excluding spectral ranges from the multivariate calibration models which have no information or information not relevant for the chemical substance of interest.

In a further example, optimization of step e) may also comprise reducing the complexity of the multivariate correlation model for example by way of reducing the number of independent main components being used in the multivariate correlation model. Such reduction may be achieved by interpretation of the independent main components and influence thereof on the loading prediction, selection of these independent main components in the calibration method neglecting the ones only showing non-relevant information like noise.

In a further example, optimization of step e) may comprise modifying the training data by eliminating samples showing weak correlation between the readout of the multivariate calibration model and the reference method (outlier elimination). Such elimination can be justified for example by identification of errors in the reference method or low spectral quality of the sample spectrum.

In an embodiment the multivariate correlation model is validated using a method comprising the following steps:
g. Acquiring a validation data set comprising a plurality of spectrum representative of validation samples and reference loading values measured for the chemical substance in the validation samples, wherein validation samples are representative for samples collected from a production plant and/or selected by design of experiment to be at the boundaries of the variation room;
h. Selecting the calibration for multivariate data analysis characteristic for the chemical substance to be quantified in the matrix;
i. Computing prediction values for the loading of the chemical substance in the validation samples using the one or more calibration;
j. Computing an average standard deviation between the prediction values for the loading of the chemical substance and the reference loading values measured for the chemical substance in the validation samples;
k. Reiterating step b. to f. of the method for provision of a calibration and steps h. to j. of the validation in case the average standard deviation for the loading of the chemical substance in the validation samples is out of a predefined range.

In an example the method of the invention further comprises validating the computed loading value of the chemical substance(s) by conducting the following steps:
computing a value for comparability between the computed signature spectrum relevant for the chemical substance(s) in the sample and the distribution of signature spectra relevant for the chemical substance(s) from a training data set; and
   marking outputted loading values as invalid in case the computed value for comparability is out of an acceptable range.

Preferred value for comparability is the mahanalobis distance, describing the difference of the computed spectral signature of the sample and the distribution of the spectral signatures of the whole set of calibration samples is computed.

Use of validation samples which are representative for samples collected from a production plant can ensure that the method is robust in the common loading ranges of interest and in the common variation range for the sample matrix.

Use of validation samples selected by design of experiment to be at the boundaries of the variation room can be used to validate the robustness of the method outside of the common production ranges.

A further aspect of the invention is to determine both the accuracy and the robustness of the spectroscopic methods of the invention. As the accuracy of the existing method HPLC, including of sample preparation per extraction, is not easy to determine and not available in many cases it was agreed to aim for a correlation between the spectroscopic methods and HPLC in a region acceptable in the field. Acceptable in the field of seed treatment is an accuracy from 0.1 to 10%.

The solution of the invention may be used not only for active quantification in these complex films but also for quantification of any functional compound of the seed treatment or coating. The thoroughly developed multivariate data analysis method of the invention, applied to the acquired infrared spectra, was shown to be able to cope with the spectral diversity of a multicomponent seed treatment and/or coating and enable the quantification of the loading of single chemical substance/active agent in a single agent or in a combination formulation at the required high accuracy (<10% standard deviation).

Surprisingly, it was found, that using specific ranges of interest of the spectrum and carefully selecting the main matrix influences for the multi-variate data approach, eliminating redundant or least-influencing matrix influences, minimizes the risk of false active quantification. In this way, even broader natural and man-made variations of the sample matrix were shown to have nearly no influence on the accuracy of the readout.

The here described approach may be used with RAMAN, Mid-Infrared (MIR) and Near-Infrared (NIR) spectroscopy or a combination thereof as far as data for all three spectral ranges are available. Preferred is acquiring one or more spectrum representative of a sample using MIR- or NIR-spectroscopy. Most preferred is using NIR spectroscopy. NIR-technology was found to be superior to the MIR for the following reasons:
1. The time demand of the analysis is significantly lower with NIR
   4 minutes per sample compared to 15 min with MIR (for soy)
   6 minutes per sample compared to 15 min with MIR (for corn)
2. The handling effort is significantly lower when using NIR
   For acquisition of NIR-spectra, a sample of multiple seeds may be used, for example filled into a rotating cup. For the acquisition of MIR-spectra, single seeds are measured, requiring multiple adjusting and fixing of single seeds on the MIR-ATR crystal.
3. The accuracy of the multivariate calibration for NIR-spectra based approach is at least comparable with multivariate calibration for MIR-spectra based approach, in most cases even better
4. The validation results of the samples with variation of certain treatment components showed significantly better results with NIR

A further object of the present invention is a system for non-destructive quantification of one or more chemical substances of interest coated on bulk material in a matrix, said matrix being defined by its further coating components and said bulk material, according to independent Claim 13. Exemplary embodiments of the method and apparatus according to the invention can be gathered from the Claims dependent on Claim 13.

The system of the invention comprises:
a memory storing one or more instructions;
a database storing one or more calibrations, wherein said calibration is specific for the chemical substances to be quantified in the matrix and wherein said calibration comprises conducting spectrum pre-treating steps and a multivariate data analysis using a multivariate correlation model trained for computing a loading value of the chemical substance(s) based on a signature spectrum relevant for the chemical substance(s) at stake in consideration of matrix influences;
one or more processors configured to execute the one or more instructions which, when executed by the one or more processors, cause performance of:
a. Acquiring one or more spectrum representative of the sample, wherein said spectrum is a near-infrared, infrared or a Raman spectrum,
b. Selecting one or more calibration for multivariate data analysis based on the one or more chemical substances to be quantified;
c. Computing the spectrum signature relevant for the chemical substance(s) by way of running the spectrum pre-treating steps of the one or more calibration(s) for the one or more spectrum representative of the sample;
d. Computing a loading value of the chemical substance(s) using the correlation model(s) of the one or more calibrations;
e. Causing displaying on a user interface of the computed loading value of the chemical substance(s).

In an embodiment, the one or more instructions when, executed by the one or more processors, further cause performance of:
computing a value for comparability between the computed signature spectrum relevant for the chemical substance(s) in the sample and the distribution of signature spectra relevant for the chemical substance(s) from a training data set; and
marking outputted loading values as invalid on the user interface in case the computed value for comparability is out of an acceptable range.

In an embodiment, the one or more instructions when, executed by the one or more processors, further cause performance of:
a. Acquiring a training data set comprising a plurality of spectrum representative of training samples and reference loading values measured for the chemical substance in the training samples, wherein the training samples are selected using a method for design of experiments so that the loading values for the chemical substance and matrix parameters are distributed homogeneously within a variation room delimited by its boundaries;
b. Normalizing the plurality of spectrum of the training data set [by way of at least min-max normalization, first derivation, second derivation, straight line subtraction, offset correction, or a combination thereof] and selecting normalized spectrum signatures within the range of interest for the chemical substance;
c. Computing a correlation model based on the selected normalized spectrum signatures within the range of interest for the chemical substance and the reference loading values of the training data set under consideration of the matrix parameters using multivariate data analysis
d. Computing a standard deviation for predictions provided by the correlation model to from the reference loading values;
e. Reiterating step b. to d. until minimal standard deviation of for prediction is achieved;
f. Saving in the database storing one or more calibrations the normalizing steps and the trained correlation model as a calibration for multivariate data analysis characteristic for the chemical substance to be quantified in the matrix.

In an embodiment, the one or more instructions when, executed by the one or more processors, further cause performance of:
g. Acquiring a validation data set comprising a plurality of spectrum representative of validation samples and reference loading values measured for the chemical substance in the validation samples, wherein validation samples are either representative for samples collected from a production plant and/or selected by design of experiment to be at the boundaries of the variation room;
h. Selecting the calibration for multivariate data analysis characteristic for the chemical substance to be quantified in the matrix from the database storing one or more calibrations;
i. Computing prediction values for the loading of the chemical substance in the validation samples using the one or more calibration;
j. Computing an average standard deviation between the prediction values for the loading of the chemical substance and the reference loading values measured for the chemical substance in the validation samples;
k. Reiterating step b. to j. in case the average standard deviation for the loading of the chemical substance in the validation samples is out of a predefined range.

In an embodiment the system of the invention may further comprise one or more features selected from:
A database for storage of spectroscopic spectrums;
A database for storage of results from primary analysis of reference samples;
A database for algorithms for pretreatment of spectrum;
A database for storage of calibrations categorized by seed and ingredients in the coatings selected from the group active ingredients; and/or
The one or more processing units configured to cause performance of one or more of the following steps:
   A Design of Experiments for a training data set and/or a validation data set;
   Averaging the spectrum related to the one sample to be analyzed and/or averaging the loading values of the chemical substance(s) computed from the several spectra acquired for the one sample to be analyzed;
   Conducting a pretreatment of an acquired spectroscopic spectrum according to a selected calibration by way of normalizing and selecting normalized spectrum signatures within a range of interest for the chemical substance;
   Optimizing the pretreatment and the selected spectral range of interest by way of computing a standard deviation for the computed loading value provided by the multivariate correlation model to the reference loading values and reiterating normalization in case said standard deviation is outside of an acceptable range;
   Optimizing preferences for multivariate analysis by way of selecting the main matrix influences for the multivariate analysis.
      Or a combination thereof.

The system of the invention may comprises or be connected to a user interface in particular for the selection of the chemical substance(s) of interest and display of the computed results A further object of the invention is a computer program element for conducting a non-destructive quantification of one or more chemical substances of interest coated on bulk material in a matrix, said matrix being defined by its further coating components and said bulk material, which when executed by a processor is configured to carry out the steps of the method described above.

A further object of the invention is a computer program element for provision of a calibration for a chemical substance to be quantified in a matrix, said matrix being defined by its further coating components and said bulk material, which when executed by a processor is configured to carry out the steps of the method described above.

A further object of the invention is a non-transitory computer readable medium having stored one or more of the computer program elements mentioned above.

It is clear to the person skilled in the art that spectrums can be analysed with the methods of the invention independently of the acquisition system provided specifications, for example resolution, signal-to-noise ratio, wavelength accuracy, is good enough for acceptable accuracy.

It is also clear to the person skilled in the art that the solutions of the present inventions are primarily usable for analysis of seed coatings but may be application to the analysis of other coated bulk material.

The use of terms “a” and “an” and “the” and similar referents in the context of describing the invention (especially in the context of the following claims) are to be construed to cover both the singular and the plural, unless otherwise indicated herein or clearly contradicted by context. The terms “comprising”, “including”, “having”, and “containing” are to be construed as open-ended terms (i.e. meaning “including but not limited to”) unless otherwise noted.

The use of any and all examples, or exemplary language (e.g., “such as”) provided herein, is intended merely to better illuminate the invention and does not pose a limitation on the scope of the invention unless otherwise claimed. No language in the specifications should be constructed as indicating any non-claimed element as essential to the practice of the invention.

Preferred embodiments of this invention are described, including the best mode known to the inventors for carrying out the invention. Variations of those preferred embodiments can become apparent to those of ordinary skilled artisans to employ such variations as appropriate, and the inventors intend for the inventions to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context. The claims are to be construed to include alternative embodiments to the extent permitted by the prior art.

The invention will now be further illustrated by the following non-limiting drawings and examples.

### BRIEF DESCRIPTION OF THE DRAWINGS

Exemplary embodiments will be described in the following with reference to the following drawings:

FIG. 1 shows a schematic representation of the system of the present invention and its components

FIG. 2 show flow diagram of an exemplary embodiments of the method of the invention for quantification of an active agent.

FIG. 3 shows a flow diagram of the method of the invention for provision and validation of calibration

FIG. 4 shows raw NIR spectra of treated and non-treated soybean seeds according to example 1 (calibration samples).

FIG. 5 shows for soybean seeds treated according to example 1 a correlation between the quantification in ml/kg seeds obtained by HPLC reference analytics for Imidacloprid (x-axis) and the quantification in ml/kg seeds calculated using the NIR (also called NIR-readout) cross-validation of the invention (y-axis) for Cropstar®, based on the corresponding model.

FIG. 6 shows for the quantification of CropStar® in the soybean seeds treated according to example 1 the correlation of the standard error of cross validation RMSECV (y-axis) vs. number of main components (x-axis).

FIG. 7 shows for soybean seeds treated according to example 1 the correlation between the quantification in ml/kg seed obtained by HPLC reference analytics for Carbendazim (x-axis) and the quantification Derosal Plus® in ml/kg seed calculated using the NIR cross-validation of the invention based on the corresponding model (y-axis).

FIG. 8 shows for the quantification of Derosal Plus® in the soybean seeds treated according to example 1 the correlation of the standard error of cross validation RMSECV (y-axis) vs. number of main components (x-axis).

FIG. 9 shows raw NIR spectra of treated and non-treated maize seeds according to example 2 (calibration samples, samples).

FIG. 10 shows for maize seeds treated according to example 2, the correlation between the quantification obtained by HPLC reference analytics for Clothianidin (x-axis) and the quantification for Poncho® calculated using the NIR cross-validation of the invention based on the corresponding model [ml/60,000 seeds].

FIG. 11 shows for maize seeds treated according to example 2 the correlation between the quantification obtained by HPLC reference analytics for Chlorantraniliprol (x-axis) and the quantification for Dermacor® calculated using the NIR cross-validation of the invention based on the corresponding model [ml/60,000 seeds].

FIG. 12 shows for maize seeds treated according to example 2 the correlation between the quantification obtained by HPLC reference analytics for Carbendazim (x-axis) and the quantification for Derosal Plus® calculated using the NIR cross-validation of the invention based on the corresponding model [ml/60,000 seeds].

FIG. 13 shows for maize seeds treated according to example 2 the correlation between the quantification obtained by HPLC reference analytics for Metalaxyl-M (x-axis) and the quantification for Maxim Advance® calculated using the NIR cross-validation of the invention based on the corresponding model [ml/100 kg].

FIG. 14 shows for maize seeds treated according to example 3 the correlation between the quantification obtained by HPLC reference analytics for Clothianidine (x-axis) and the quantification for Poncho® calculated using the NIR cross-validation of the invention.

FIG. 15 shows for maize seeds treated according to example 3 the correlation between the quantification obtained by HPLC reference analytics for Prothioconazole (x-axis) and the quantification for Proline calculated using the NIR cross-validation of the invention.

FIG. 16 shows for maize seeds treated according to example 3 the correlation between the quantification obtained by HPLC reference analytics for Fluoxastrobin (x-axis) and the quantification for Fluoxastrobin ST calculated using the NIR cross-validation of the invention.

FIG. 17 shows the correlation between the quantification for Scenic Gold® in ml/dt seed obtained by gravimetric analysis during sample preparation of OSR seeds treated as mentioned above (x-axis) and the quantification obtained using NIR cross-validation in ml/dt seeds based on the corresponding model (y-axis).

FIG. 18 shows the correlation of the quantification for Buteo Start®, applied product in ml/dt obtained by gravimetric analysis (x-axis) during sample preparation of OSR seeds treated according to example 4; and the quantification calculated based on NIR data (y-axis) in ml/dt seeds based on the corresponding model; R2 was found to be 79.6 and the standard deviation 105 ml/dt.

FIG. 19 shows mid-JR-spectra of the calibration samples for soy treated according to example 1.

FIG. 20 shows for the soybean seeds of example 1 the correlation between the quantification in ml/kg seed obtained by HPLC reference analytics for Imidacloprid (x-axis) and the quantification of CropStar® in ml/kg seed calculated based on mid-IR spectra using the method of the invention based on the corresponding model.

FIG. 21 shows for the soybean seeds of example 1 the correlation of Derosal Plus® between the quantification in ml/kg seed obtained by HPLC reference analytics for Carbendazim) and the quantification of Derosal Plus® in ml/kg seedsbased on mid-IR spectra using the the corresponding model.

### DETAILED DESCRIPTION OF THE INVENTION

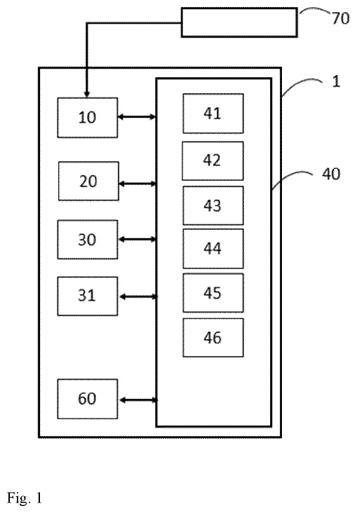

FIG. 1 shows a schematic representation of the system of the present invention and its components.

### REFERENCES

1 System according to the invention
10 Database for storage of spectroscopic spectrums
20 Database for algorithms for pretreatment of spectrum
30 Database for storage of results from primary analysis of reference samples
31 Database for storage of calibrations categorized by seed and ingredients in the coatings selected from the group active agent, functional agent, . . .
40 Processing unit comprising the following modules:
41 Module configured for Design of Experiments
42 Module configured for avering the spectrum related to one sample to be analyzed
43 Module configured for conducting a pretreatment of spectrum according to a selected calibration
44 Module configured to optimize the pretreatment of spectrum
45 Module configured for optimization of preferences for multivariate analysis
46 Module configured for the calculation of loadings using new spectrum and selected calibration and configured for calculation of validity factor for said calculation of loading
60 User interface
70 Spectrometer

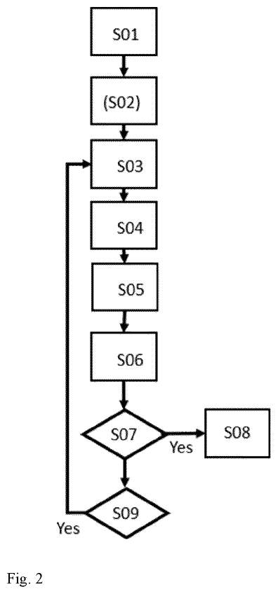

FIG. 2 shows a flow diagram of a preferred embodiment the method of the invention for identification and quantification of one or more active agent(s) on a coated seed, wherein the following steps are conducted:
S01 Acquiring several spectra representative of a sample comprising a plurality of seeds
S02 Optional averaging the acquired spectra
S03 Selecting the calibration for multivariate data analysis based on the active agent to be quantified
S04 Computing the spectrum signature relevant for the active agent by way of running the spectrum pretreating steps of the calibration on each spectrum of S01 (S04A) or on the average spectrum representative of the sample (S04B) if used
S05 Computing a loading value of the active agent using the correlation model of the calibration based on the spectrum signatures S04A or S04B
S05A Averaging the computed loading values into an average loading value
S06 Causing displaying of the computed loading value(s) of the active agent on a user interface
S07 Computing a value for comparability (for example the Mahanalobis distance) between the computed signature spectrum relevant for the active agent in the sample and the distribution of signature spectra relevant for the active agent from a training data set
S08 Marking displayed loading value as invalid in case the computed value for comparability is out of an acceptable range
S09 Reiterate for next active agent to be quantified in the seed sample if any

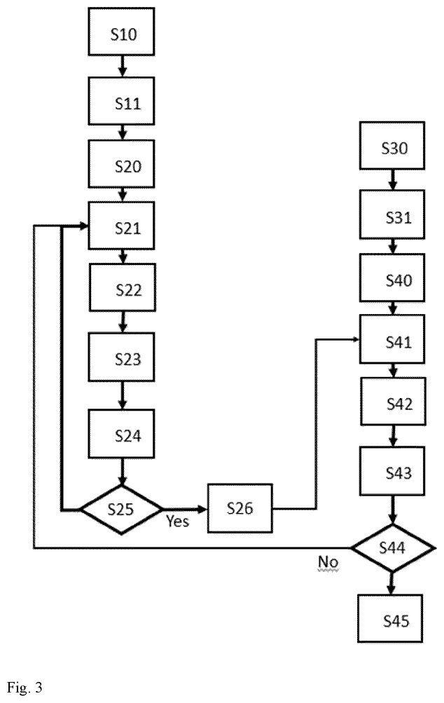

FIG. 3 shows a flow diagram of the method of the invention for provision and validation of the calibration for computer-implemented method for identification and quantification of an active agent in a matrix of coated seed, wherein the following steps are conducted for the provision of a calibration:
S10 Computing training samples using a method for design of experiments so that their spectrum signature is within the range of interest for the active agent at stake, wherein the training samples are selected so that reference loading values for the active agent and matrix parameters influences are distributed homogeneously within a variation room delimited by its boundaries
S11 Preparing training samples and conducting spectroscopic measurements as well as measurement of reference loading values for the active agent according to a selected reference method;
S20 Acquiring a training data set comprising the plurality of spectrum representative of the training samples and the reference loading values measured for the active agent in the training samples;
S21 Normalizing the plurality of spectrum of the training data set using one or more spectrum normalization methods of the art
S22 Selecting normalized spectrum signatures within a range of interest for the chemical substance
S23 Computing a multivariate correlation model based on the normalized spectrum and the reference loading values of the training data set under consideration of the matrix parameters using multivariate data analysis
S24 Computing a standard deviation for predictions provided by the multivariate correlation model from the reference loading values
S25 Reiterating step S21, S22 and S23, by way of varying the normalization procedure and/or the selected range of interest for the bioactive agent until minimal standard deviation for prediction and optimal number of main matrix influences is achieved
S26 Saving the normalization procedure and/or the selected range of interest for the bioactive agent and the trained correlation model as a calibration for multivariate data analysis characteristic for the chemical substance to be quantified in the matrix

And wherein the following steps are conducted for the validation of the computed calibration:
S30 Selecting validation samples which are representative for samples collected from a production plant and/or computing by way of design of experiment validation samples to be at the boundaries of the variation room
S31 Preparing validation samples and conducting spectroscopic measurements as well as measurement of reference loading values for the active agent according to a selected reference method;
S40 Acquiring a validation data set comprising the plurality of spectrum representative of the validation samples and reference loading values measured for the active agent in the validation samples;
S41 Selecting the calibration for multivariate data analysis characteristic for the active agent to be quantified in the matrix
S42 Computing prediction values for the loading of the active agent in the validation samples using the one or more calibration
S43 Computing an average standard deviation between the prediction values for the loading of the active agent and the reference loading values measured for the active agent in the validation samples
S44 Reiterating step S21 to S26 in case the average standard deviation for the loading of the active agent in the validation samples is out of a predefined range
S45 Approval of the calibration for the active agent if the average standard deviation is within a predefined range by marking calibration as approved.

It is preferred that for each validated calibration identifiers for both training data and validation data set for the active agenet are saved together with confirmation of validation for later use in the value for comparability for a new sample.

### EXAMPLES

The solution of the invention was used for the following examples without being limited thereto. Multi-active quantifications using near-IR and mid-IR(ATR—attenuated total reflection) are exemplarily described for soybean, maize, cotton and oilseed rape using the method of the invention. Spectral scans were collected from calibration samples and obtained data was subsequently used for identifying the correlation consequently establishing the calibration. Additionally, independent validation samples, which were not presented to the spectrometer as part of the calibration, proved the high quality of the calibration.

For NIR analysis a Bruker Tango-R equipped with a rotation sample cup was used. Acquisition parameters were as follows: FT interferometer, Tungsten source, InGaAs diode detector, spectral range: 11.500-4.000 cm−1, 64 scans.

The resolution for the NIR measurement was set to 8 cm⁻¹. To improve the signal to noise ratio 8, 16, 32, 64, 128 and 256 acquisition for a single sample were tested, and the optimal number of resolution vs time was found to be 64 acquisitions. In addition, 8 physical repetitions per sample, i.e. new sub-sample aliquots were presented to the spectrometer and averaged. The examples described hereafter were obtained by averaging all 8 physical repetitions even though it was found that a minimum of 2 repetitions may be sufficient to achieve a reasonable accuracy that will be sufficient for process control requirements (data not shown).

The treated seeds were analyzed by NIR in the following sequence. 100 g of a sample of seeds was filled into the sample cup of the NIR spectrometer. The sampling cup was placed on the analyzer and the measurement started by entering the sample description and initiating the actual measurement using the predefined acquisition data as said. After completed measurement, the seeds were removed and the sampling cup cleaned with a soft tissue.

For mid-IR analysis (ATR) a Bruker Alpha II was used. Acquisition parameters were as follows: IR source, DTGS detector, spectral range: 350-8.000 cm⁻¹, resolution 4 cm⁻¹, circa 64 scans per acquisition. A number of specific spectral ranges were identified and selected for calibration and quantification of said actives, predominantly containing information which can be used to quantify respective actives of interest in the seed treatment. The specified regions were determined from 1st derivative and amplitude studies using the acquired spectra of seed and relevant reference samples proving the relevance of said spectral regions for active quantification, while excluding spectral ranges which are dominated by matrix effects. Specified spectral regions are described for each example separately.

Background signal correction, i.e. subtraction of spectrum of non-treated seeds was not done for any part of this method instead the following normalization was used to ensure high quality, comparable data sets. Said normalization was vector normalization. A spectrum is normalized by calculating a mean value for the y values (spectral absorbances at the different wavelengths) and then subtracting this value from the spectrum. Then the sum of the squares of all y values is calculated and then the corresponding spectrum is divided by the square root of this sum. In this manner, baseline and pathlength effects were corrected.

For all validation studies, deviations of NIR versus HPLC in percent were calculated for all samples using following equation:

$$Deviation [ \% ] = ( ( result NIR - result HPLC ) / ( result HPLC ) ) * 100 \qquad ( Formula I )$$

HPLC/UPLC reference analytics were done using standard liquid chromatography instruments equipped with UV/VIS detection. Analysis were done using certified analytical references and dedicated qualified methods using commonly applied liquid chromatography routines.

### Example 1—Soybean Seeds

A NIR analysis routine for soybean was established and validated using a standard seed treatment package (also called applied plant protection product) comprising the combination formulations CropStar®, i.e. Imidacloprid and Thiodicarb, and Derosal Plus® containing Carbendazim and Thiram. The concentrations of active agents in the applied respective seeds dressings were as follows, ref. Table 1:

TABLE 1
Active composition of applied commercial products;
full composition is proprietary.

| Applied plant protection | | |
|---|---|---|
| product | Active 1 | Active 2 |
| CropStar ® (2 insecticides) | 150 g/L Imidaclopride | 450 g/L Thiodicarb |
| Derosal Plus ® | 150 g/L Carbendazim | 350 g/L Thiram |
| (2 fungicides) | | |

The entire seed treatment application recipe for soybeans (also denoted seed treatment dressing) is characterized by its active agents or its combination of active agents and ratios thereof, means said insecticides and fungicides, and additional components comprising sticker & colorant, for example Peridiam 306, talcum gloss, micro-nutrients, inoculants and root enhancer, ref Table 2. Calibration samples and validation samples were calculated per DoE. The corresponding seed treatment dressings were applied in 1 kg scale using a pilot scale batch treater. For high precision all components were weighed in each dressing. Densities are available to the public, therefore not mentioned here.

TABLE 2
Study of the sample for treated soybean according to example 1

| | | | | | | | Dosage |
|---|---|---|---|---|---|---|---|
| | | | Derosal | Peridiam | Talkum | | additional |
| | | Cropstar | Plus | 306 | Gloss | Additional | component |
| A | B | [ml/kg] | [ml/kg] | [ml/kg] | [g/kg] | component | [ml/kg] |
| Calibration | Variation | 0.00 | 0.00 | 2.00 | 3.00 | — | — |
| samples | of | 8.57 | 1.91 | 2.00 | 3.00 | — | — |
| | active | 8.47 | 0.62 | 2.00 | 3.00 | — | — |
| | agent | 6.79 | 3.90 | 2.00 | 3.00 | — | — |
| | loading | 3.47 | 1.68 | 2.00 | 3.00 | — | — |
| | | 5.06 | 2.89 | 2.00 | 3.00 | — | — |
| | | 7.06 | 1.69 | 2.00 | 3.00 | — | — |
| | | 4.25 | 0.34 | 2.00 | 3.00 | — | — |
| | | 4.24 | 1.99 | 2.00 | 3.00 | — | — |
| | | 3.79 | 2.89 | 2.00 | 3.00 | — | — |
| | | 6.42 | 3.04 | 2.00 | 3.00 | — | — |
| | | 5.24 | 0.27 | 2.00 | 3.00 | — | — |
| | | 4.42 | 1.00 | 2.00 | 3.00 | — | — |
| | | 8.21 | 0.41 | 2.00 | 3.00 | — | — |
| | | 8.59 | 2.58 | 2.00 | 3.00 | — | — |
| | | 7.22 | 2.08 | 2.00 | 3.00 | — | — |
| | | 5.00 | 2.01 | 2.00 | 3.00 | — | — |
| | | 6.00 | 1.75 | 2.00 | 3.00 | — | — |
| | | 6.01 | 2.26 | 2.00 | 3.00 | — | — |
| | | 7.01 | 2.00 | 2.00 | 3.00 | — | — |
| Validation | batch | 6.00 | 2.00 | 2.00 | 3.00 | Derosal batch 1 | — |
| samples | variation | 6.00 | 2.01 | 2.00 | 3.00 | Derosal batch 2 | — |
| | | 6.00 | 2.00 | 2.00 | 3.00 | Derosal batch 3 | — |
| | | 6.00 | 2.01 | 2.00 | 3.00 | Derosal batch 4 | — |
| | | 6.01 | 2.01 | 2.00 | 3.00 | Derosal batch 5 | — |
| | | 6.00 | 2.00 | 2.00 | 3.00 | Derosal batch 6 | — |
| | | 6.00 | 2.01 | 2.00 | 3.00 | Derosal batch 7 | — |
| | | 6.00 | 1.99 | 2.00 | 3.00 | Derosal batch 8 | — |
| | Diff | 0.00 | 0.00 | 0.00 | 0.00 | Variety 1 | — |
| | | 0.00 | 0.00 | 0.00 | 0.00 | Variety 2 | — |
| | | 0.00 | 0.00 | 0.00 | 0.00 | Variety 3 | — |
| | | 0.00 | 0.00 | 0.00 | 0.00 | Variety 4 | — |
| | | 0.00 | 0.00 | 0.00 | 0.00 | Variety 5 | — |
| | | 0.00 | 0.00 | 0.00 | 0.00 | Variety 6 | — |
| | | 0.00 | 0.00 | 0.00 | 0.00 | Variety 7 | — |
| | | 0.00 | 0.00 | 0.00 | 0.00 | Variety 8 | — |
| | | 0.00 | 0.00 | 0.00 | 0.00 | Variety 9 | — |
| | | 0.00 | 0.00 | 0.00 | 0.00 | Variety 10 | — |
| | | 0.00 | 0.00 | 0.00 | 0.00 | Variety 11 | — |
| | Different | 6.01 | 2.01 | 2.00 | 3.00 | Variety 2 | — |
| | variaties - | 5.99 | 2.00 | 2.00 | 3.00 | Variety 3 | — |
| | standard | 6.00 | 2.01 | 2.00 | 3.00 | Variety 4 | — |
| | treatment | 6.01 | 2.01 | 2.00 | 3.00 | Variety 5 | — |
| | | 6.01 | 2.01 | 2.00 | 3.00 | Variety 6 | — |
| | | 6.01 | 2.01 | 2.00 | 3.00 | Variety 7 | — |
| | | 6.01 | 2.01 | 2.00 | 3.00 | Variety 8 | — |
| | | 6.01 | 2.01 | 2.00 | 3.00 | Variety 9 | — |
| | | 6.00 | 2.00 | 2.00 | 3.00 | Variety 10 | — |
| | | 6.00 | 2.01 | 2.00 | 3.00 | Variety 11 | — |
| | TSW | 6.01 | 2.00 | 2.00 | 3.00 | low TSW (<100 g) | — |
| | | 6.01 | 2.00 | 2.00 | 3.00 | high TSW (>100 g) | — |
| | | 4.01 | 1.50 | 2.00 | 3.00 | low TSW (<100 g) | — |
| | | 7.00 | 2.49 | 2.00 | 3.00 | high TSW (>100 g) | — |
| | Micronutrients | 6.00 | 2.01 | 2.00 | 4.00 | Supa Moly | 1.00 |
| | | 6.00 | 2.00 | 2.00 | 4.00 | COMo Premier | 2.00 |
| | | 6.01 | 2.01 | 2.00 | 4.00 | Primer como Bio 33 | 1.00 |
| | | 6.00 | 2.01 | 2.00 | 4.00 | Fertactyl | 2.00 |
| | Talkum | 6.01 | 2.01 | 2.00 | — | Talkum Gloss | 3.00 |
| | Gloss | 6.01 | 2.00 | 2.00 | — | LabSec | 3.00 |
| | | 6.01 | 2.01 | 2.00 | — | Fluidus 028 | 2.00 |
| | | 6.01 | 2.01 | 2.00 | — | Polyseed | 2.00 |
| | Ino | 6.01 | 2.01 | 2.00 | 4.00 | CTS500 | 5.70 |
| | | 6.00 | 2.00 | 2.00 | 4.00 | BiAgroNG | 2.16 |
| | | 6.00 | 2.01 | 2.00 | 4.00 | CTS200 | 5.70 |
| | Root | 6.00 | 2.00 | 2.00 | 4.00 | Booster | 1.00 |
| | | 6.01 | 2.01 | 2.00 | 4.00 | TSnCo | 2.00 |
| | | 6.01 | 2.01 | 2.00 | 4.00 | Spin | 2.00 |

It is noted that identifiers (variety x, validation sample VSx, etc) for the samples are merely for orientation within an example. In other words, variety 1 of example 1 is not the same as variety 1 of example x, and VS1 of example 1 is not the same as VS1 of example x, unless explicitly mentioned.

Table 2 describes the compositions of the samples prepared for calibration and validation respectively in order to evaluate the influence of active agent and matrix variations on the quantification of the active agents by NIR; sub-categories of variations as depicted in Table 2, column B were assigned to the samples for better overview. This step is also referred to as “study of the sample”. Further details on the additional components are described in Table 3.

### Influence of Batch Variation on the Actual Ratio of the Active Agents in Multiple-Active Products

Depending on the actual ratio of the active agents in combination formulations, e.g. Cropstar® and Derosal Plus® the spectral signature was found to be subjected to changes, thus NIR-readout. Product specifications of Cropstar® allow variation of the loading ratios of Imidacloprid and Thiodicarb between batches within a range from 2.9-3.2 to 1 (weight, Thiodicarb/weight, Imidacloprid).

Similarly, the product specifications of Derosal Plus® allow variations of the loading ratios of Carbendazim and Thiram between batches within a range from 2.9-3.2 to 1 (w/w).

For this reason, several commercial batches of combination formulation within the said ranges were included into the validation samples.

### Influence of Seed Varieties

The soybean seed itself significantly contributes to the acquired spectral signature. To check the sensitivity/insensitivity of the method of the invention related to seed varieties, samples issued from 10 different varieties were considered in the samples for calibration and for validation.

The method was found to be tolerant toward spectral signature variations related to soybean seed varieties.

Influence of Thousand-Seed-Weight (TSW), Typically Measured in [g/1000 Seeds]

Because of changes of available surface area, variation of the TSW was expected to influence the loading of active agent(s) on each seed. This parameter was taken into consideration in the samples for calibration and in the samples for validation.

### Influence of Used Micronutrients

Four common micronutrients formulations were considered in the validation samples to check sensitivity of the NIR-method of the invention when using commonly applied micronutrient products on treated seeds. The calibration was found to be insensitive to micronutrients in the seed treatment dressing.

### Influence of Talcum Gloss

Common Talcum Gloss formulations were considered in the validation samples check sensitivity of described NIR-method when using different talcum drying and/or gloss enhancing products for the corresponding treatments. The method was found to be insensitive to these components.

### Influence of Inoculants

Common inoculants formulations were used in the validation samples to check sensitivity of the described NIR-method when using different inoculants for the corresponding treatments. The method was found to be insensitive to these components.

### Influence of Root Enhancers

Common root enhancers formulations were used in the validation samples to check sensitivity of the described NIR-method when using different root enhancers for the corresponding treatments. The method was found to be insensitive to these components.

In case wherein the validation shows the method being sensitive to further components, it may be advantageous to consider introducing variations of these components in the calibration samples.

It is to be noted that when quantifying seed loading with CropStar®, matrix variations related to the Derosal Plus® seed dressing are important variables that should be considered in both calibration and validation samples.

TABLE 3
Summary of applied matrix components on soybean

| | | | | State of |
|---|---|---|---|---|
| No. | Component | Type | Original state | measurement |
| 1 | Supa Moly CoMo | Fertilizer: Co, Mo | Liquid, colored | Not dryable |
| 2 | Como Primer | Fertilizer: P, Co, Mo | Liquid, colored | Dried |
| 3 | Primer CoMo Bio 33 | Fertilizer: N, Co, Mo | Suspension | Dried |
| 4 | Fertiacyl Leg | Fertilizer: C org, Co, Mo | Liquid, colored | Not dryable |
| 5 | Booster | Fertilizer: Mo | Liquid | Dried |
| 6 | Tsn CoMo | Fertilizer: Co, Mo | Suspension | Dried |
| 7 | Spin | Fertilizer: P, Mo, K, N | Suspension | Not completely dried |
| 8 | Nitragen Optimize 200 | Inocculant | Solid | Already solid |
| 9 | Nitragen Optimize 500 | Inocculant | Solid | Already solid |
| 10 | CRI | Bacterial additive | Liquid | Not dryable |
| 11 | Nitragen Power 200 | Bacterial additive | Liquid | Not dryable |
| 12 | Talkum Gloss | Drying Powder | Solid | Already solid |
| 13 | LabSec | Drying Powder | Solid | Already solid |
| 14 | Fluidus 028 | Drying Powder | Solid | Already solid |
| 15 | Polyseed | Drying Powder | Solid | Already solid |
| 16 | Biagro NG | Inocculant | Suspension | Not dryable |

FIG. 4 shows raw NIR spectra of treated and non-treated soybean seeds according to example 1 (calibration samples); different product concentrations/loadings are reflected by changes of amplitude at specific spectral ranges. Spectral differences for non-treated and treated seeds are well-defined and different loadings are reflected by amplitude changing at specific spectral ranges.

### Calibration

Spectra for the calibration samples were acquired using the acquisition parameters mentioned above.

The spectra were evaluated by using the multivariate evaluation method “Quant2” in the OPUS software of Bruker.

For Cropstar®, the spectra pretreatment with Multiple Scatter Correction was found to be most suitable. The spectral ranges of 9000 to 8200 cm⁻¹, 6104 to 5444 cm⁻¹ and 5076 to 4400 cm⁻¹ have been used.

For Derosal Plus®, vector normalization and 1′ derivative was found to be most suitable. The spectral ranges of 7236 to 7112 cm⁻¹, 6104 to 5444 cm⁻¹ and 5076 to 4400 cm⁻¹ have been used.

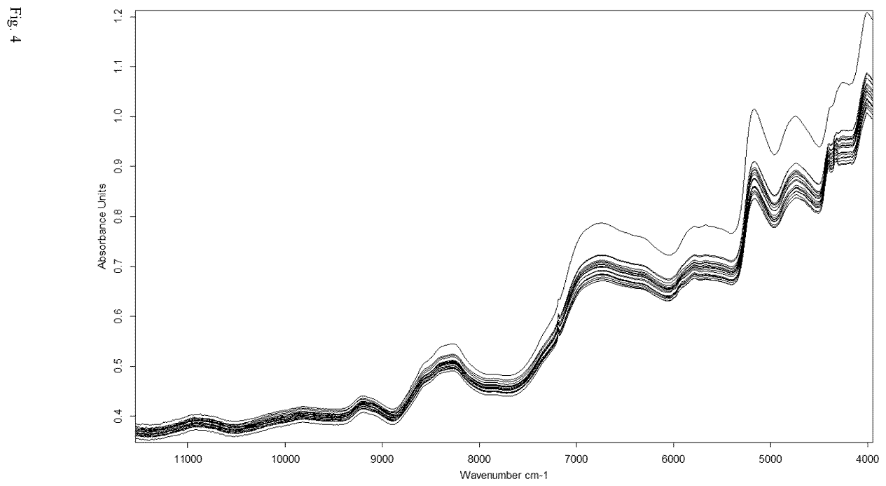

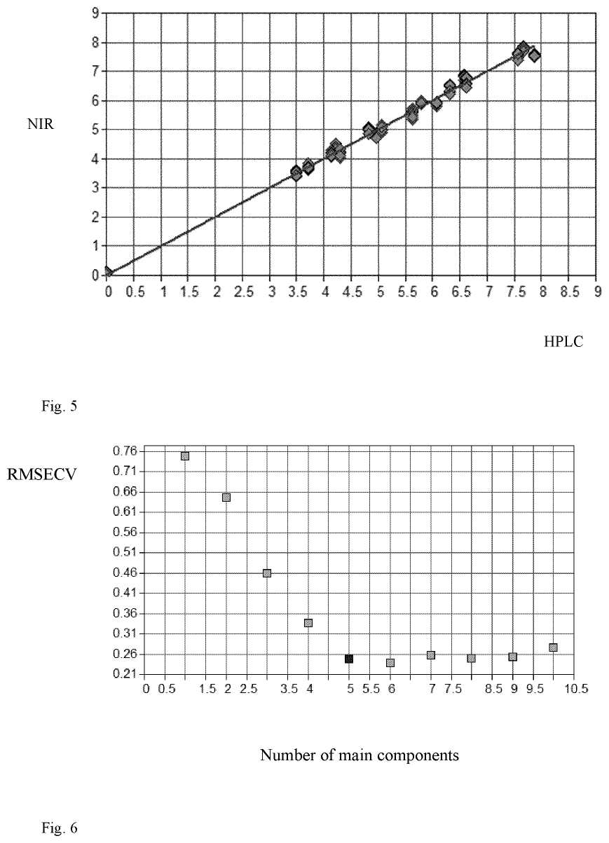

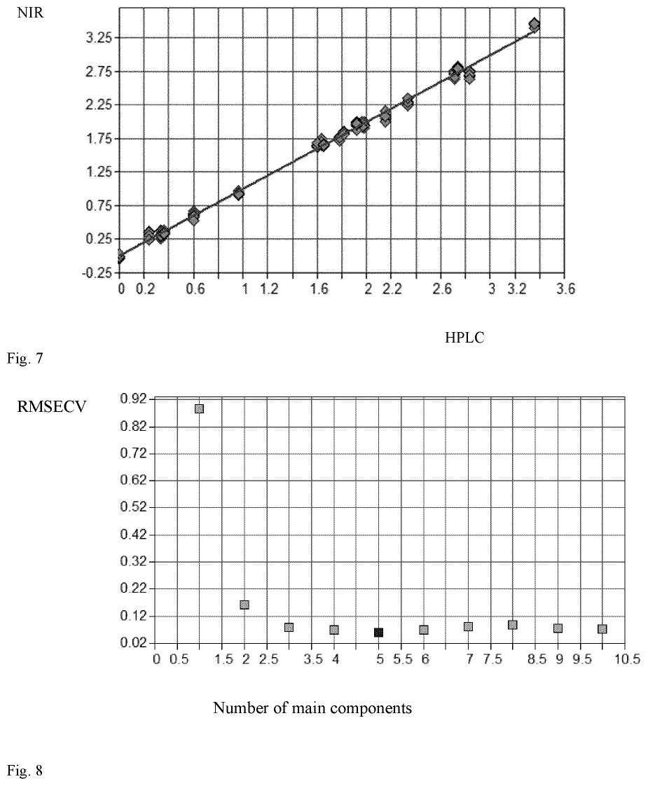

Upon spectral pretreatment and calibration based on the first 5 main components, quantifications of CropStar® and Derosal Plus® based on NIR data (y-axis) show an excellent correlation with the values obtained by HPLC reference analytics (x-axis), ref. FIG. 5 and FIG. 7). The calibration was rated by using cross validation.

The optimal number of main components, i. e. matrix influences considered for adequate calibration, was determined by using the first minimum of RMSECV (root mean standard error of cross validation, y-axis) over number of main components (x-axis) (see FIG. 6 and FIG. 8).

FIG. 5 shows for soybean seeds treated according to example 1 a correlation between the quantification in ml/kg seeds obtained by HPLC reference analytics for Imidacloprid (x-axis) and the quantification in ml/kg seeds calculated using the NIR (also called NIR-readout) cross-validation of the invention (y-axis) for Cropstar®, based on the corresponding model.

R2 (coefficient of determination) was found to be 99.3 and the standard deviation 0.15 ml/kg.

FIG. 6 shows for the quantification of CropStar® in the soybean seeds treated according to example 1 the correlation of the standard error of cross validation RMSECV (y-axis) vs. number of main components (x-axis). Consideration of the 5 main components in the calibration were found to be optimal.

FIG. 7 shows for soybean seeds treated according to example 1 the correlation between the quantification in ml/kg seed obtained by HPLC reference analytics for Carbendazim (x-axis) and the quantification Derosal Plus® in ml/kg seed calculated using the NIR cross-validation of the invention based on the corresponding model (y-axis).

R2 was found to be 99.6 and the standard deviation 0.10 ml/kg.

FIG. 8 shows for the quantification of Derosal Plus® in the soybean seeds treated according to example 1 the correlation of the standard error of cross validation RMSECV (y-axis) vs. number of main components (x-axis). Consideration of the 5 main components in the calibration were found to be optimal.

### Validation

The performance of the determined calibration was evaluated with the validation samples, ref. Table 2. The identified fluctuations in NIR-readout provided a measure for the robustness and accuracy of the calibration, ref. Table 4.

TABLE 4
Validation results using NIR active quantification on treated soybeans.
Deviation of NIR-found versus HPLC reference analytics.

Δ NIR to HPLC

| Sample | Δ Cropstar ® | Δ Derosal ® |
|---|---|---|
| Description | [% abs] | [% abs] |
| Lot 1 | 4.40 | 3.30 |
| Lot 2 | 10.48 | 1.96 |
| Lot 3 | 5.77 | 0.80 |
| Lot 4 | 20.70 | 2.91 |
| Lot 5 | 1.45 | 2.74 |
| Lot 6 | 1.64 | 2.04 |
| Lot 7 | 3.12 | 3.78 |
| Lot 8 | 4.60 | 1.29 |
| Variety 1 | 16.39 | 1.87 |
| Variety 2 | 9.13 | 6.84 |
| Variety 3 | 3.14 | 36.66 |
| Variety 4 | 2.38 | 11.17 |
| Variety 5 | 3.03 | 8.07 |
| Variety 6 | 0.45 | 2.67 |
| Variety 7 | 5.22 | 11.90 |
| Variety 8 | 6.28 | 2.48 |
| Variety 9 | 2.70 | 7.53 |
| Variety 10 | 2.54 | 3.65 |
| low TSW (<100 g) | 0.37 | 4.31 |
| high TSW (>100 g) | 5.92 | 6.47 |
| low TSW (<100 g) | 1.46 | 11.39 |
| high TSW (>100 g) | 5.50 | 8.70 |
| Supa Moly | 10.78 | 1.20 |
| COMo Premier | 5.96 | 9.15 |
| Primer como Bio 33 | 2.61 | 0.29 |
| Fertactyl | 5.55 | 2.97 |
| Talkum Gloss | 0.22 | 0.11 |
| LabSec | 9.45 | 0.64 |
| Fluidus 028 | 1.96 | 18.32 |
| Polyseed | 1.79 | 17.26 |
| CTS500 | 4.85 | 26.44 |
| BiAgroNG | 11.73 | 1.07 |
| CTS200 | 3.11 | 17.45 |
| Booster | 3.78 | 0.13 |
| TSnCo | 2.30 | 8.42 |
| Spin | 6.89 | 1.21 |

### Example 2—Maize Seeds BRA

A NIR analysis routine for maize seeds was established and validated using a complex seed treatment package comprising the formulations 1) Poncho® (Clothanidine), 2) Dermacor® (Chlorantraniliprole), 3) Maxim Advanced (Metalaxyl co-applied with Tiabendazim) and 4) Derosal Plus® (Carbendazim and Thiram). The concentrations of the active agents in the respectively applied seed treatment dressings were as follows, Table 5:

TABLE 5
Active agents in applied commercial seed treatment
dressings; full composition is proprietary.

| Applied plant protection | | |
|---|---|---|
| product | Active 1 | Active 2 |
| Derosal Plus ® (2 active agents) | 150 g/L Carbendazim | 350 g/L Thiram |
| Poncho ® (1 active agent) | 600 g/L Clothianidin | — |
| Dermacor ® (1 active agent) | 625 g/L Chlorantraniliprol | — |
| Maxim Advanced ® (2 active | 20 g/L Metalaxyl-M | 150 g/L Thiabendazole |
| agents) | | |
| Actellic ® (1 active agent) #not | 500 g/L Pirimiphos methyl | — |
| quantified | | |
| K-Obiol ® (1 active agent + | 25 g/L Deltamethrin | 225 g/L Piperonylbutoxid* |
| adjuvant*) #not quantified | | |

The study of the sample for maize seeds was established by design of experiment (DoE) as exemplarily described in example 1, Table 2. Samples as summarized in Table 7 were prepared in 1 kg scale using a pilot scale batch treater. For high precision all products were weighed in. Densities are available to the public, therefore not mentioned here. The following sub-categories were considered for better overview: Batch variation of each dressing, hybrids variation (varieties), Thousand-Seed-Weight (TSW) variation, Talcum Gloss variation.

NIR-spectra for the samples were acquired using the acquisition parameters mentioned above.

FIG. 9 shows raw NIR spectra of treated and non-treated maize seeds according to example 2 (calibration samples, samples). Spectral differences for non-treated and treated seeds are well-defined and different loadings are reflected by amplitude changing at specific spectral ranges.

### Calibration

The spectra acquired for the calibration samples were evaluated by using the multivariate evaluation method “Quant2” in the OPUS software of Bruker. Characteristics of the calibration are summarized in Table 6.

TABLE 6
Characteristics of calibrations established for Maize BRA

| | | Spectral | Number of | R² | |
|---|---|---|---|---|---|
| | Data | range(s) | main | of cross | |
| Product | pretreatment | [cm⁻¹] | components | validation | RMSECV* |
| Poncho ® | Vector | 7260-7196 | 4 | 96.7 | 2.45 |
| | normalization | 4760-4360 | | | |
| Dermacor ® | Vector | 7260-7196 | 7 | 95.4 | 1.98 |
| | normalization | 4760-4360 | | | |
| Derosal | Vector | 7260-7196 | 6 | 99.8 | 1.29 |
| Plus ® | normalization | 4760-4360 | | | |
| Maxim | Multiple | 7260-7132 | 6 | 92.0 | 9.04 |
| Advance ® | scattering | 6004-5396 | | | |
| | correction + 1. | 4524-4100 | | | |
| | Derivative | | | | |

*RMSECV = root mean square error of cross validation

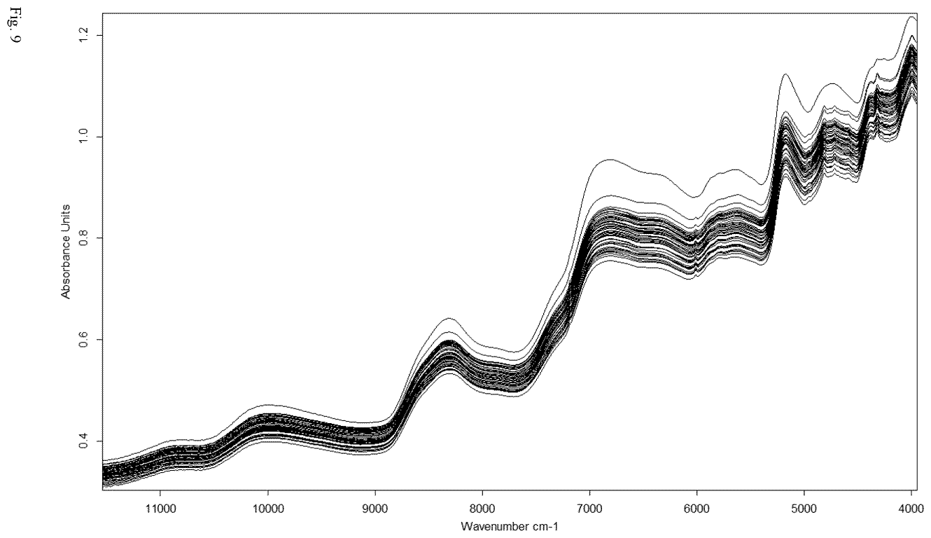

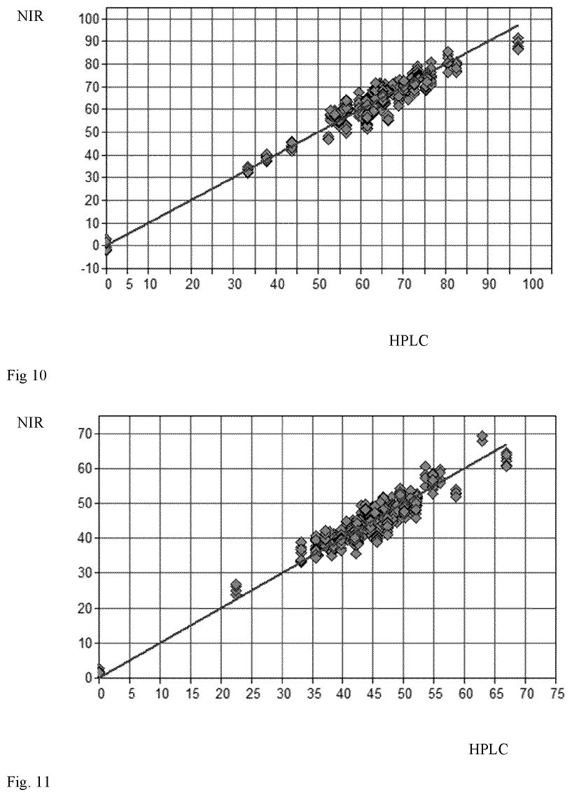

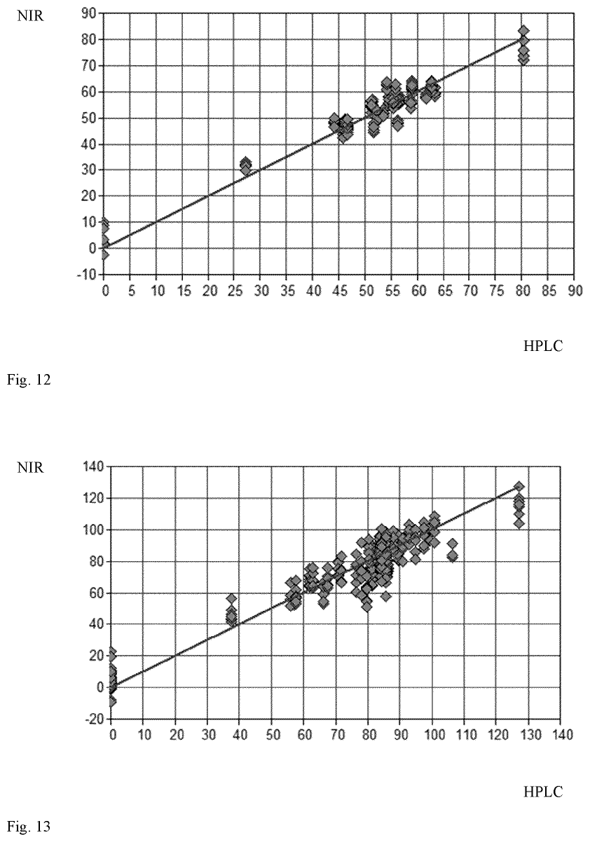

Using these parameters, the quantification of the respective dressings Poncho®, Dermacor® and Derosal Plus® on the treated maize seeds calculated based on NIR data showed a strong correlation with the quantification obtained using the HPLC reference analytics, ref. FIG. 10, FIG. 11, FIG. 12. Respective numbers of main components, R2 and RMSECV are summarized in Table 6.

FIG. 10 shows for maize seeds treated according to example 2, the correlation between the quantification obtained by HPLC reference analytics for Clothianidin (x-axis) and the quantification for Poncho® calculated using the NIR cross-validation of the invention based on the corresponding model [ml/60,000 seeds].

FIG. 11 shows for maize seeds treated according to example 2 the correlation between the quantification obtained by HPLC reference analytics for Chlorantraniliprol (x-axis) and the quantification for Dermacor® calculated using the NIR cross-validation of the invention based on the corresponding model [ml/60,000 seeds].

FIG. 12 shows for maize seeds treated according to example 2 the correlation between the quantification obtained by HPLC reference analytics for Carbendazim (x-axis) and the quantification for Derosal Plus® calculated using the NIR cross-validation of the invention based on the corresponding model [ml/60,000 seeds].

FIG. 13 shows for maize seeds treated according to example 2 the correlation between the quantification obtained by HPLC reference analytics for Metalaxyl-M (x-axis) and the quantification for Maxim Advance® calculated using the NIR cross-validation of the invention based on the corresponding model [ml/100 kg].

### Validation

The performance of the established calibrations was evaluated using all validation samples established in the DoE. Identified fluctuations in NIR-readout provided a measure for the robustness and accuracy of the calibration, ref. Table 7.

Deviations of NIR-readouts vs reference analysis HPLC were found to be low proving the validity of the method despite changes in the matrix.

TABLE 7
Validation results NIR for maize BRA.

| | | | | | Maxim |
|---|---|---|---|---|---|
| | | Poncho ® | Dermacor ® | Derosal Plus ® | Advance ® |
| | Sample | [%] Dev. | [%] Dev. | [%] Dev. | [%] Dev. |
| Group | Description | NIR-HPLC | NIR-HPLC | NIR-HPLC | NIR-HPLC |
| Validation | VS 1 | 6.37 | 7.61 | n.a. | n.a. |
| samples - | VS 2 | 0.94 | 2.24 | n.a. | n.a. |
| wrong | VS 3 | 1.23 | 0.84 | n.a. | n.a. |
| dosage of | VS 4 | 5.79 | 5.92 | n.a. | n.a. |
| one product | VS 5 | 1.27 | 0.45 | n.a. | 6.52 |
| within spec | VS 6 | 1.19 | 1.14 | n.a. | 18.77 |
| | VS 7 | 6.65 | 6.65 | 10.92 | 2.69 |
| | VS 8 | 5.06 | 4.95 | 8.46 | 8.79 |
| Batch | VS 9 | 1.08 | 0.87 | 0.45 | 2.61 |
| variation of | VS 10 | 2.14 | 0.24 | 3.50 | 12.14 |
| active | VS 11 | 0.28 | 2.53 | 3.64 | 2.89 |
| products | VS 12 | 1.27 | 0.59 | 1.73 | 10.24 |
| Top 10 | Hybrid 1 | 5.88 | 7.92 | 5.32 | 6.84 |
| hybrids, | Hybrid 2 | 10.87 | 5.12 | 3.96 | 0.04 |
| standard | Hybrid 3 | 2.43 | 2.04 | 0.40 | 11.21 |
| treatment | Hybrid 4 | 2.61 | 1.01 | 2.82 | 0.62 |
| | Hybrid 5 | 5.91 | 8.70 | 12.22 | 8.70 |
| | Hybrid 6 | 10.14 | 8.50 | 7.37 | 4.90 |
| | Hybrid 7 | 5.21 | 0.65 | 3.26 | 7.73 |
| | Hybrid 8 | 1.98 | 2.70 | 1.73 | 2.71 |
| | Hybrid 9 | 2.31 | 0.49 | 0.97 | 36.91 |
| | Hybrid 10 | 0.29 | 4.54 | 2.45 | 24.99 |
| Treatment | VS 13 | 0.57 | 0.49 | 2.96 | 26.32 |
| without | VS 14 | 0.99 | 0.64 | 5.76 | 37.31 |
| Talkum | VS 15 | 2.01 | 3.95 | 2.90 | 34.12 |
| Gloss | | | | | |

### Example 3—Maize Seeds NA

A second NIR analysis routine was established and validated for maize seeds treated with a standard seed treatment package comprising Poncho®, Poncho Votivo®, Allegiance FL, Proline, Fluoxastrobin ST and Acceleron® B360. The concentrations of the actives in the applied seed dressings were as follows, Table 8:

TABLE 8
Active composition of applied seed dressings;
full composition is proprietary

| Applied plant protection | | |
|---|---|---|
| product | Active 1 | Active 2 |
| Poncho ® (1 active agent) | 600 g/L Clothianidin | — |
| Poncho Votivo ® (2 active | 500 g/L Clothianidin | 100 g/L Bacillus |
| agents) | | firmus I-1582 |
| Allegiance FL (1 active | 312 g/L Metalaxyl | — |
| agent - not quantified) | | |
| Proline (Acceleron ® | 480 g/L Prothioconazole | — |
| D-342) (1 active agent) | | |
| Fluoxastrobin | 480 g/L Fluoxastrobin | — |
| ST(Acceleron ® D-281) | | |
| (1 active agent) | | |
| Acceleron ® B360 - not | Lowly concentrated | — |
| quantified | biostimulant | |

Not quantified active agents are considered components of the matrix. Influences on the spectral were evaluated in the calibration and in the validation samples.

The entire seed treatment sample matrix for maize was established by design of experiment (DoE) as exemplarily described in example 1. Insecticides, fungicides and, if required additional products. E.g. Acceleron© E007 SAT, were applied using the sticker Peridiam Precise 1006 and a green pigment Color Coat Green (BASF). The treatment was applied in 1 kg scale using a pilot scale batch treater. For high precision all products were weighed in.

In order to evaluate the influence of variations on the quantification by NIR, sub-categories were established and used. Considered variables were categorized as followed: Batch variation of active products, Hybrids variation (varieties), Thousand-Seed-Weight (TSW) variation, variation of polymer, pigment and drying agent.

NIR-Spectra of 70 samples were acquired using the acquisition parameters mentioned above. The spectra were evaluated by using the multivariate evaluation method “Quant2” in the OPUS software of Bruker. Characteristics of the established calibrations are summarized in Table 9.

TABLE 9
Characteristics of calibration Maize NA

| | | Spectral | Number |
|---|---|---|---|
| | | range(s) | of main |
| Product | Data pretreatment | [cm⁻¹] | components |
| Poncho ® | Vector normalization | 4900-4360 | 2 |
| Proline ® | Vector normalization | 4640-4168 | 7 |
| Fluoxastrobin | Multiple scattering | 5084-4140 | 6 |
| ST ® | correction + 1. | | |
| | Derivative | | |

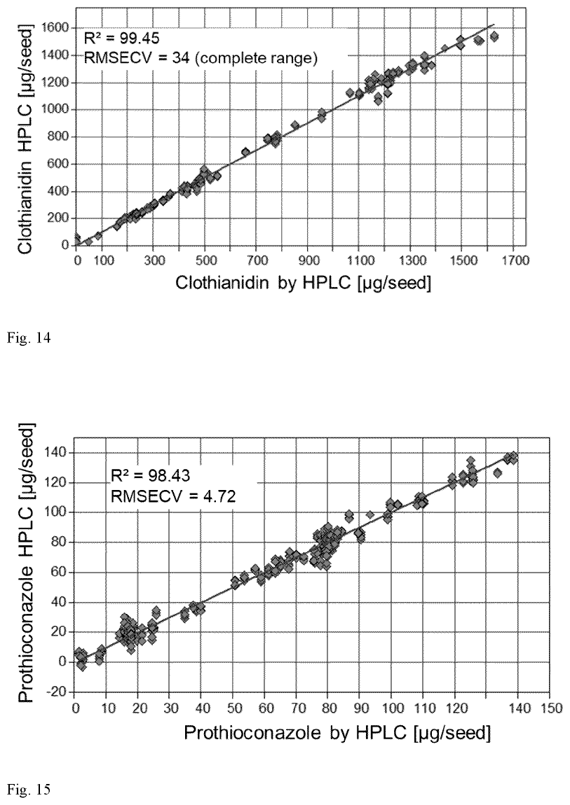

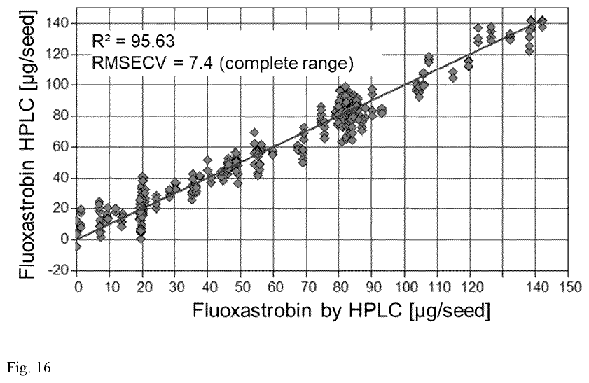

Using the calibrations of Table 9, the quantifications of Clothianidine, Prothioconazole, Fluoxastrobin in the seed treatment showed a strong correlation between NIR data versus HPLC reference analytics, ref. FIG. 14, FIG. 15, FIG. 16.

FIG. 14 shows for maize seeds treated according to example 3 the correlation between the quantification obtained by HPLC reference analytics for Clothianidine (x-axis) and the quantification for Poncho® calculated using the NIR cross-validation of the invention.

FIG. 15 shows for maize seeds treated according to example 3 the correlation between the quantification obtained by HPLC reference analytics for Prothioconazole (x-axis) and the quantification for Proline calculated using the NIR cross-validation of the invention.

FIG. 16 shows for maize seeds treated according to example 3 the correlation between the quantification obtained by HPLC reference analytics for Fluoxastrobin (x-axis) and the quantification for Fluoxastrobin ST calculated using the NIR cross-validation of the invention.

In addition, or alternatively to HPLC as reference analytics, the weigh-ins of all active agents containing seed dressings may be used for referencing. These weights of applied seed dressings are effortlessly accessible and showed a similarly high correlation, hence, allowing use of gravimetric referencing for NIR-based quantification of multiple active agents, ref. Table 10.

TABLE 10
Correlation results for all active agents applied according to example
3 and comparison of correlation using HPLC reference analytics with
correlation using gravimetric referencing (grav. = gravimetric).

| | R² | RMSECV | R² | RMSECV |
|---|---|---|---|---|
| Active | NIR_{(GRAV)} | NIR_{(GRAV.μg/seed)} | NIR_{(HPLC)} | NIR_{(HPLC.μg/seed)} |
| Clothianidine | 99.38 | 37 | 99.45 | 34 |
| 0-1.7 mg/seed | | | | |
| calibrated | | | | |
| Prothioconazole | 98.23 | 5.3 | 98.43 | 4.72 |
| 0-0.15 mg/seed | | | | |
| calibrated | | | | |
| Fluoxastrobin | 95.54 | 7.8 | 98.63 | 7.4 |
| 0-0.15 mg/seed | | | | |
| calibrated | | | | |

### Validation

The performance of the calibrations mentioned above was evaluated on 68 independent validation samples. Ten different corn varieties have been selected und used for preparing three different samples per hybrids, giving 30 validation samples for this variation. Identified relative deviations in NIR-readout versus HPLC-reference provided a measure for the robustness and accuracy of the calibration, ref Table 11. In general, deviations of NIR vs HPLC-reverence were found to be low proving the insensitivity of the method against changes in the matrix.

TABLE 11
Deviation of Clothianidine NIR-readout vs HPLC reference.

| | | Poncho | Proline | Fluoxastrobin |
|---|---|---|---|---|
| | | [%] Dev. | [%] Dev. | [%] Dev. |
| | | NIR- | NIR- | NIR- |
| Group | Description | HPLC | HPLC | HPLC |
| Different ratio | VS 1 | 5.34 | 6.09 | 1.67 |
| of Votivo part | VS 2 | 5.63 | 1.29 | 1.69 |
| | VS 3 | 6.68 | 1.53 | 3.32 |
| | VS 4 | 2.71 | 27.94 | 6.89 |
| | VS 5 | 0.73 | 4.99 | 7.82 |
| | VS 6 | 1.43 | 12.23 | 10.11 |
| Different batch | VS 7 | 0.25 | 32.90 | 2.14 |
| of Poncho | VS 8 | 0.14 | 3.65 | 0.32 |
| | VS 9 | 2.25 | 18.80 | 3.02 |
| Higher amount | VS 10 | 8.27 | 6.72 | 109.43 |
| of E-007 | VS 11 | 1.65 | 0.75 | 2.07 |
| | VS 12 | 3.01 | 433.49 | 55.43 |
| | VS 13 | 1.95 | 12.11 | 3.66 |
| | VS 14 | 11.30 | 0.47 | 15.62 |
| | VS 15 | 0.12 | 29.39 | 7.37 |
| | VS 16 | 13.73 | 7.73 | 18.19 |
| | VS 17 | 10.01 | 4.50 | 7.25 |
| Extreme values | VS 18 | 7.72 | 9.06 | 19.88 |
| of Precise | VS 19 | 3.11 | 8.10 | 6.31 |
| | VS 20 | 0.79 | 11.75 | 60.03 |
| | VS 21 | 4.34 | 64.41 | 6.74 |
| | VS 22 | 1.51 | 35.31 | 6.50 |
| | VS 23 | 2.50 | 7.18 | 17.31 |
| Variations of | VS 24 | 10.00 | 13.49 | 22.74 |
| water | VS 25 | 7.11 | 0.34 | 0.97 |
| | VS 26 | 2.80 | 3.73 | 25.61 |
| | VS 27 | 2.07 | 17.90 | 1.94 |
| | VS 28 | 0.87 | 5.93 | 9.24 |
| | VS 29 | 2.20 | 2.16 | 17.42 |
| Strong over- or | VS 30 | 8.28 | 52.10 | 47.97 |
| undertreatment | VS 31 | 10.51 | 7.12 | 36.72 |
| of fungizides | VS 32 | 6.23 | 69.44 | 2.49 |
| | VS 33 | 2.12 | 22.07 | 7.39 |
| | VS 34 | 2.36 | 0.00 | 42.10 |
| | VS 35 | 4.11 | 12.34 | 0.00 |
| Higher amount | VS 36 | 3.62 | 8.99 | 5.00 |
| of colorant | VS 37 | 4.43 | 0.44 | 26.54 |
| | VS 38 | 7.11 | 28.22 | 7.33 |
| Different | Hybrid 1 | 23.82 | 2.54 | 103.06 |
| hybrids, 3 | Hybrid 1 | 29.09 | 21.69 | 6.15 |
| samples each | Hybrid 1 | 19.59 | 20.12 | 17.07 |
| | Hybrid 2 | 0.85 | 41.44 | 46.21 |
| | Hybrid 2 | 3.42 | 4.94 | 1.80 |
| | Hybrid 2 | 4.93 | 0.02 | 3.02 |
| | Hybrid 3 | 10.32 | 34.25 | 41.85 |
| | Hybrid 3 | 4.96 | 1.59 | 7.11 |
| | Hybrid 3 | 6.70 | 6.93 | 0.29 |
| | Hybrid 4 | 9.10 | 16.03 | 11.35 |
| | Hybrid 4 | 9.14 | 1.86 | 7.50 |
| | Hybrid 4 | 7.76 | 14.06 | 30.05 |
| | Hybrid 5 | 7.01 | 9.50 | 21.42 |
| | Hybrid 5 | 12.67 | 6.02 | 7.17 |
| | Hybrid 5 | 0.79 | 1.87 | 7.81 |
| | Hybrid 6 | 0.38 | 15.08 | 24.87 |
| | Hybrid 6 | 1.71 | 1.22 | 3.28 |
| | Hybrid 6 | 0.78 | 10.81 | 6.93 |
| | Hybrid 7 | 4.81 | 28.03 | 6.54 |
| | Hybrid 7 | 4.39 | 4.31 | 3.68 |
| | Hybrid 7 | 2.57 | 1.13 | 0.72 |
| | Hybrid 8 | 2.17 | 0.78 | 31.96 |
| | Hybrid 8 | 3.77 | 0.41 | 12.12 |
| | Hybrid 8 | 2.27 | 5.14 | 3.13 |
| | Hybrid 9 | 21.82 | 0.67 | 38.47 |
| | Hybrid 9 | 14.66 | 19.37 | 0.59 |
| | Hybrid 9 | 4.42 | 11.67 | 5.45 |
| | Hybrid 10 | 6.01 | 42.26 | 2.03 |
| | Hybrid 10 | 4.54 | 3.34 | 0.81 |
| | Hybrid 10 | 1.24 | 1.95 | 3.70 |

### Example 4—Oil Seed Rape (OSR)

A general feasibility for NIR analysis of treated oil seed rape was carried out using a standard seed treatment package comprising the seed dressings Scenic Gold® and Buteo Start®. The concentrations of the active agents in the applied seed dressings were as follows:

TABLE 12
Active composition of applied seed dressings;
full composition is proprietary

| Applied plant protection | | |
|---|---|---|
| product | Active 1 | Active 2 |
| Scenic Gold ® | Fluoxastrobin 150 g/l | Fluopicolide 200 g/l |
| (2 actives) | | |
| Buteo Start ® | Flupyradifurone 480 g/L | — |
| (1 active) | | |

This seed treatment was applied in 2 kg scale using a pilot scale batch treater. For high precision all products were weighed in. Densities are available to the public, therefore not mentioned here.

TABLE 13
Reduced study of the samples for treated OSR

| | Scenic | Fluency | Peridiam | Buteo |
|---|---|---|---|---|
| | Gold ® | blue ® | Quality | Start ® |
| Sample# | [ml/dt] | [g/dt] | 208 [ml/dt] | [ml/dt] |
| 1 | 600 | 250 | 0 | 0 |
| 2 | 800 | 250 | 0 | 0 |
| 3 | 1000 | 250 | 0 | 0 |
| 4 | 1200 | 250 | 0 | 0 |
| 5 | 800 | 250 | 50 | 0 |
| 6 | 1000 | 250 | 50 | 0 |
| 7 | 0 | 250 | 0 | 625 |
| 8 | 0 | 250 | 0 | 833 |
| 9 | 0 | 250 | 0 | 1042 |
| 10 | 0 | 250 | 0 | 1250 |
| 11 | 0 | 250 | 50 | 833 |
| 12 | 0 | 250 | 50 | 1042 |

The reduced number of samples described above were not sufficient to develop a calibration that is suitable to compensate the variations in routine analytics for seed treatment but were used to evaluate the general usability of the NIR method of the invention for oil seed rape.

### Calibration

Spectra for the calibration samples were acquired using the acquisition parameters mentioned above. The spectra were evaluated by using the multivariate evaluation method “Quant2” in the OPUS software of Bruker.

For Scenic Gold®, the spectra pretreatment with vector normalization was found to be most suitable. The spectral ranges of 5948 to 5344 cm⁻¹ and 4988 to 4120 cm⁻¹ have been used. For Buteo Start®, vector normalization was found to be most suitable. Spectral ranges of 6140 to 5352 cm⁻¹ and 5028 to 4140 cm⁻¹ have been used.

The calibration was rated by using cross validation.

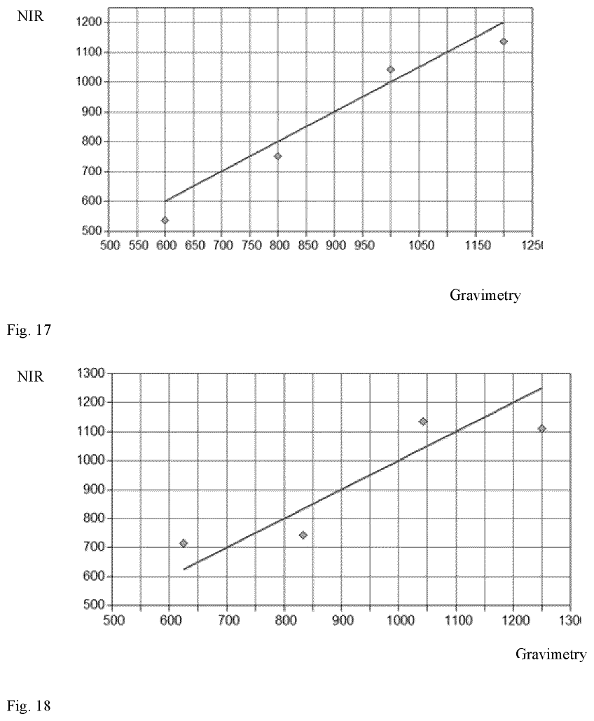

Upon spectral pretreatment and use of the first 2 main components of the method both products Scenic Gold® and Buteo Start® within the seed treatment showed an excellent correlation for NIR data versus HPLC reference analytics, ref. FIG. 17 and FIG. 18. The optimal number of main components (factors) was determined by using the procedure described in example 1.

FIG. 17 shows the correlation between the quantification for Scenic Gold® in ml/dt seed obtained by gravimetric analysis during sample preparation of OSR seeds treated as mentioned above (x-axis) and the quantification obtained using NIR cross-validation in ml/dt seeds based on the corresponding model (y-axis). R2 was found to be 93.9 and the standard deviation 55 ml/dt.

FIG. 18 shows the correlation of the quantification for Buteo Start®, applied product in ml/dt obtained by gravimetric analysis (x-axis) during sample preparation of OSR seeds treated according to example 4; and the quantification calculated based on NIR data (y-axis) in ml/dt seeds based on the corresponding model; R2 was found to be 79.6 and the standard deviation 105 ml/dt.

### Validation

Validation will confirm the usability of the method the invention compared to HPLC as reference analysis

### Example 5—Soy ATR

Based on all samples described in Example 1, ref. Table 2, a mid-infrared FT-ATR analysis routine for treated soybean seeds was established and validated using a standard seed treatment package comprising CropStar® (Imidacloprid and Thiodicarb) and Derosal Plus® (Carbendazim and Thiram).

The description of calibrations and validation samples and seed treatment procedure as used are described in example 1.

The treated soybean seeds were analyzed by mid-IR in the following sequence. A single seed was placed on the ATR crystal and fixed with a clamping mechanism. The spectral acquisition was conducted using the predefined acquisition parameters mentioned above (e.g. resolution). After completed measurement, the seed was removed from the ATR crystal and this latter was cleaned with a soft tissue for next seed measurement. Repetitive measurement with a number of different seeds, treated in the same batch, were carried out to obtain a valid averaged readout spectrum. Number of repetitions is given in calibration section below.

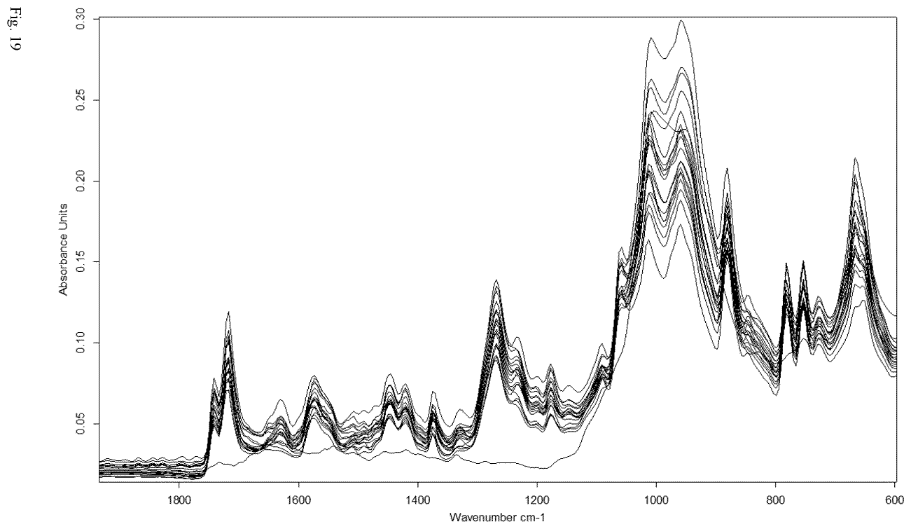

Spectral differences for non-treated and treated seeds were found to be well-defined and different loadings are reflected by amplitude changing at specific spectral ranges (FIG. 19).

The spectra show a very low level of noise. There is low impact of the soy seed as matrix component in the spectra due to the small immersion depth of the IR radiation (on a small μm scale). The influence of the active agents can clearly be seen by the difference between the sample with no active agent (signal almost zero between 1800 and 1200 cm⁻¹) and the other calibration samples. Also. the variations in concentrations of active agents in the seed dressings can be seen in the varying heights of the absorptions for the corresponding samples. This is an excellent starting point for a multivariate calibration.

FIG. 19 shows mid-IR-spectra of the calibration samples for soy treated according to example 1.

Workflow and tools used for data handling were the same for NIR and mid-IR.

### Calibration

The calibration was conducted using the acquisition parameters mentioned above. Of each sample, 25 single seeds were selected. Each of these seeds was measured one time, so 25 spectra per sample were acquired. These 25 single spectra were averaged in 3 groups (i.e. 2×8 averaged spectra and 1×9 averaged spectra) to obtain 3 derived averaged spectra.

The spectra were evaluated by using the multivariate evaluation method “Quant2” in the OPUS software of Bruker.

For Cropstar®, the spectra pretreatment with Mix/Max normalization was found to be most suitable. The spectral range of 1791 to 617 cm⁻¹ has been used. Five main components have been found to be optimal.

For Derosal Plus®, vector normalization was found to be most suitable. Spectral ranges of 1675.9 to 1198.2 cm⁻¹ and 848.2 to 609.4 cm⁻¹ have been used. Three main components have been found to be optimal.

The calibrations were rated by using cross validation.

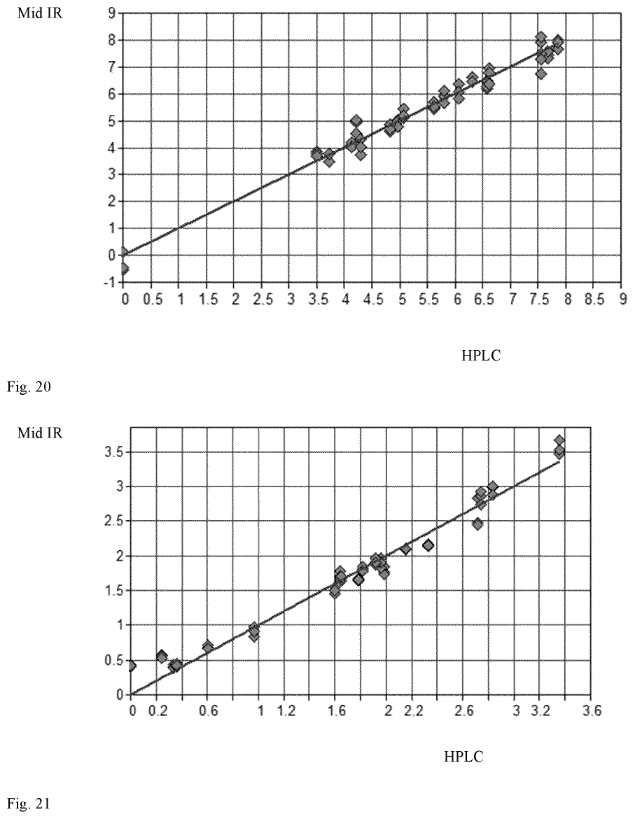

Using the spectral pretreatment of the method both products CropStar® and Derosal Plus® of the seed treatment show an excellent correlation, ref. FIG. 20 and FIG. 21 of mid-IR data versus HPLC reference analytics.

FIG. 20 shows for the soybean seeds of example 1 the correlation between the quantification in ml/kg seed obtained by HPLC reference analytics for Imidacloprid (x-axis) and the quantification of CropStar® in ml/kg seed calculated based on mid-IR spectra using the method of the invention based on the corresponding model.

R2 was found to be 97.3 and the standard deviation 0.30 ml/kg.

FIG. 21 shows for the soybean seeds of example 1 the correlation of Derosal Plus® between the quantification in ml/kg seed obtained by HPLC reference analytics for Carbendazim) and the quantification of Derosal Plus® in ml/kg seedsbased on mid-IR spectra using the corresponding model.

R2 was found to be 96.8 and the standard deviation 0.17 ml/kg.

### Validation

Using the established mid-IR calibration, the performance of said calibration was evaluated using all validation samples (ref. Table 2). The identified deviations in IR-readout vs reference analytics provided a measure for the robustness and accuracy of the calibration, ref. Table 14.

TABLE 14
Validation results mid-IR for soy seeds
treated according to example 1

Δ IR to HPLC

| Description of the | Cropstar ® | Derosal Plus ® |
|---|---|---|
| validation samples | [% abs.] | [% abs.] |
| Variety 2 | 19.97 | 9.94 |
| Variety 3 | 13.16 | 9.20 |
| Variety 4 | 14.31 | 8.96 |
| Variety 5 | 11.05 | 19.61 |
| Variety 6 | 5.34 | 0.16 |
| Variety 7 | 4.12 | 8.78 |
| Variety 8 | 2.33 | 4.58 |
| Variety 9 | 9.06 | 1.98 |
| Variety 10 | 14.37 | 13.65 |
| Variety 11 | 0.38 | 2.71 |
| low TSW (<100 g) | 6.15 | 14.98 |
| high TSW (>100 g) | 4.41 | 6.65 |
| low TSW (<100 g) | 4.12 | 3.05 |
| high TSW (>100 g) | 7.25 | 9.36 |
| Supa Moly | 3.03 | 2.22 |
| COMo Premier | 3.22 | 4.67 |
| Primer como Bio 33 | 7.47 | 1.39 |
| Fertactyl | 6.15 | 0.61 |
| Talkum Gloss | 4.73 | 8.64 |
| LabSec | 24.63 | 4.85 |
| Fluidus 028 | 11.47 | 26.33 |
| Polyseed | 5.31 | 39.76 |
| CTS500 | 4.89 | 0.75 |
| BiAgroNG | 5.91 | 16.59 |
| CTS200 | 11.58 | 12.74 |
| Booster | 0.13 | 1.97 |
| TSnCo | 8.79 | 14.24 |
| Spin | 7.96 | 10.20 |

### Example 6—Cotton Seeds NA

Another NIR analysis routine was established and validated for Cotton seeds treated with a standard seed treatment package comprising Poncho Votivo®, Allegiance FL, Gaucho®, Acceleron® D-612, Acceleron® DX-109 and Acceleron® D-510. The concentrations of the active agent in the applied seed dressings were as follows, Table 15:

TABLE 15
Active composition of applied seed dressings
on cotton; full composition is proprietary

| Applied plant protection | | |
|---|---|---|
| product | Active 1 | Active 2 |
| Poncho Votivo ® (2 active | 500 g/L Clothianidin | 100 g/L Bacillus |
| agents) | | firmus I-1582 |
| Allegiance FL (1 active | 312 g/L Metalaxyl | — |
| agent - not quantified) | | |
| Gaucho ® (1 active agent) | 487 g/l Imidacloprid | |
| Fluxapyroxad (Acceleron ® | 285 g/L Fluxapyroxad | — |
| D-612 - not quantified) | | |
| Pyraclostrobin (Acceleron ® | 204 g/L Pyraclostrobin | — |
| DX-109) (1 active agent - | | |
| not quantified) | | |
| Myclobutanil (Acceleron ® | 224 g/l Myclobutanil | — |
| D-510) (1 active agent -not | | |
| quantified) | | |

Not quantified active agents are considered components of the matrix. Influences on the spectral were evaluated in the calibration and in the validation samples.

The entire seed treatment sample matrix for cotton was established by design of experiment (DoE) as exemplarily described in example 1. Insecticides, fungicides and, if required additional products. for example, Acceleron© E007 SAT, Secure 661, E-522 and a blue pigment were applied to seed samples. The treatment was applied in 1 kg scale using a pilot scale batch treater. For high precision all products were weighed in.

In order to evaluate the influence of variations on the quantification by NIR sub-categories were established and used. Considered variables were categorized as followed: Batch variation of active products, hybrid variation (varieties), Thousand-Seed-Weight (TSW) variation, variation of polymer, pigment and drying agent.

NIR-Spectra of 115 samples were acquired using the acquisition parameters mentioned above.

The spectra were evaluated by using the multivariate evaluation method “Quant2” in the OPUS software of Bruker. Characteristics of the established calibrations are summarized in Table 16.

TABLE 16
Characteristics of calibration Cotton NA

| | | Spectral | Number |
|---|---|---|---|
| | | range(s) | of main |
| Product | Data pretreatment | [cm⁻¹] | components |
| Gaucho ® | Vector normalization | 7791.4-7598.5 | 7 |
| | | 6071.1-5419.3 | |
| | | 4752-4509 | |
| Poncho ® | 1^{st} derivative and Vector | 7791.4-7598.5 | 5 |
| | normalization | 6071.1-5419.3 | |
| | | 4752-4509 | |
| | | 4292.99-4196.56 | |

Using the calibrations of Table 16, the quantifications of Clothianidin and Imidacloprid in the seed treatment showed a strong correlation between NIR data versus HPLC reference analytics.

In addition, or alternatively to HPLC as reference analytics, the weigh-ins of all active agents containing seed dressings may be used for referencing. These weights of applied seed dressings are effortlessly accessible and showed a similarly high correlation, hence, allowing use of gravimetric referencing for NIR-based quantification of multiple active agents, ref. Table 17.

TABLE 17
Correlation results for all active agents applied according to example
6 and comparison of correlation using HPLC reference analytics with
correlation using gravimetric referencing (grav. = gravimetric).

| | R² | RMSECV | R² | RMSECV |
|---|---|---|---|---|
| Active | NIR_{(GRAV)} | NIR_{(GRAV.μg/seed)} | NIR_{(HPLC)} | NIR_{(HPLC.μg/seed)} |
| Imidacloprid | 96.86 | 16.4 | 95.85 | 16.4 |
| 0-520 μg/seed | | | | |
| calibrated | | | | |
| Clothianidin | 96.32 | 18.5 | 96.11 | 16.9 |
| 0-515 μg/seed | | | | |
| calibrated | | | | |

### Validation

The performance of the calibrations mentioned above was evaluated on 40 independent validation samples. Four different cotton varieties were selected und used for preparing 6 different samples per hybrids, giving 24 validation samples for this variation. Poncho® was not included in all validation samples to reflect the treatment offerings. Identified relative deviations in NIR-readout versus HPLC-reference provided a measure for the robustness and accuracy of the calibration, ref Table 18. In general, deviations of NIR vs HPLC-reverence were found to be low proving the insensitivity of the method against changes in the matrix.

TABLE 18
Deviation of Gaucho ® and Poncho ® NIR-
readout vs HPLC reference.

| | | Gaucho ® | Poncho ® |
|---|---|---|---|
| | | [%] Dev. | [%] Dev. |
| | | NIR- | NIR- |
| Group | Description | HPLC | HPLC |
| Higher amount of | VS 1 | 8.65 | n.a. |
| E-522 | VS 2 | 0.26 | 0.38 |
| Higher amount of | VS 3 | 0.98 | n.a. |
| Secure 661 | VS 4 | 4.63 | 4.85 |
| Higher amount of | VS 5 | 10.18 | n.a. |
| E-007 | VS 6 | 0.96 | 5.34 |
| Variations of water | VS 7 | 0.78 | n.a. |
| | VS 8 | 3.02 | 2.95 |
| | VS 9 | 2.50 | n.a. |
| | VS 10 | 3.17 | 3.71 |
| Strong overtreatment of | VS 11 | 9.45 | n.a. |
| fungicides | VS 12 | 8.99 | 3.72 |
| Higher amount of | VS 13 | 2.32 | n.a. |
| colorant | VS 14 | 0.19 | 1.01 |
| | VS 15 | 1.53 | n.a. |
| | VS 16 | 1.39 | 1.92 |
| Different hybrids, 6 | Hybrid 1 | 0.58 | n.a. |
| samples each | Hybrid 1 | 3.91 | n.a. |
| | Hybrid 1 | 0.44 | n.a. |
| | Hybrid 1 | 4.28 | 2.59 |
| | Hybrid 1 | 8.45 | 2.83 |
| | Hybrid 1 | 7.79 | 2.77 |
| | Hybrid 2 | 4.24 | n.a. |
| | Hybrid 2 | 2.91 | n.a. |
| | Hybrid 2 | 1.53 | n.a. |
| | Hybrid 2 | 4.13 | 5.16 |
| | Hybrid 2 | 1.98 | 3.21 |
| | Hybrid 2 | 7.77 | 2.73 |
| | Hybrid 3 | 3.03 | n.a. |
| | Hybrid 3 | 3.14 | n.a. |
| | Hybrid 3 | 1.42 | n.a. |
| | Hybrid 3 | 2.43 | 0.25 |
| | Hybrid 3 | 6.31 | 3.98 |
| | Hybrid 3 | 2.15 | 2.62 |
| | Hybrid 4 | 1.64 | n.a. |
| | Hybrid 4 | 3.43 | n.a. |
| | Hybrid 4 | 0.49 | n.a. |
| | Hybrid 4 | 1.43 | 4.03 |
| | Hybrid 4 | 0.87 | 2.07 |
| | Hybrid 4 | 2.31 | 3.83 |

1. A computer-implemented method for non-destructive quantification of one or more chemical substances of interest coated on bulk material in a matrix, said matrix being defined by its further coating components and said bulk material,
said method comprising the following steps:
a. acquiring one or more spectra representative of a sample of the coated bulk material, wherein said spectra are near-infrared, infrared or Raman spectra,
b. selecting one or more calibrations for multivariate data analysis based on the one or more chemical substances to be quantified, wherein the selected calibration is specific to the chemical substance to be quantified in the matrix and wherein said calibration comprises conducting spectra pretreating steps and a multivariate data analysis using a multivariate correlation model trained for computing a loading value of the chemical substance(s) based on a signature spectrum relevant for the chemical substance(s) at stake in consideration of matrix influences;
c. computing the signature spectrum relevant for the chemical substance(s) by way of running the spectra pretreating steps of the one or more calibration(s) for the one or more spectra representative of the sample;
d. computing a loading value of the chemical substance(s) using the correlation model(s) of the one or more calibrations; and
e. causing output of the computed loading value of the chemical substance(s).

2. The computer-implemented method according to claim 1, wherein mid-infrared or near-infrared spectra are used.

3. The computer-implemented method according to claim 1, wherein for the acquisition of representative spectra of the sample, more than one spectrum is acquired for the sample and spectra are averaged before computing step c) or individual computed loading values are averaged after step d).

4. The computer-implemented method according to claim 1, wherein the bulk material is coated seeds.

5. The computer-implemented method according to claim 4, wherein a sample of multiple seeds is used for the acquisition of near infrared spectra.

6. The computer-implemented method according to claim 1, further comprising validating the computed loading value of the chemical substance(s) by conducting the following steps:
computing a value for comparability between the computed signature spectrum relevant for the chemical substance(s) in the sample and the distribution of signature spectra relevant for the chemical substance(s) from a training data set; and
marking outputted loading values as invalid in case the computed value for comparability is out of an acceptable range.

7. The computer-implemented method according to claim 7, wherein the value for comparability is a mahanalobis distance describing the difference of the computed spectral signature of the sample and the distribution of the spectral signatures of a whole set of calibration samples.

8. The computer-implemented method according to claim 1, wherein the chemical substance(s) is an insecticide, a fungicide, a nematicide, a antimicrobial agent, bactericide, pesticide, fertilizer or a combination formulation thereof.

9. The computer-implemented method according to claim 8, wherein loading values for one to ten chemical substances are measured.

10. A computer-implemented method for provision of a calibration for a chemical substance to be quantified in a matrix, said matrix being defined by its further coating components and said bulk material, wherein said calibration comprises conducting spectrum pre-treating steps and a multivariate data analysis using a multivariate correlation model for the correlation of a near-infrared, infrared or a Raman spectrum signature relevant for the chemical substance in the matrix and a reference loading value for the chemical substance in said matrix in consideration of matrix influences, said method comprising the following steps:
a. acquiring a training data set comprising a plurality of spectra representative of training samples and reference loading values measured for the chemical substance in the training samples, wherein the training samples are selected using a method for design of experiments so that, the reference loading values for the chemical substance and matrix influences are distributed homogeneously within a variation room delimited by its boundaries;
b. normalizing the plurality of spectra of the training data set and selecting normalized spectrum signatures within a range of interest for the chemical substance;
c. computing a multivariate correlation model based on the normalized spectrum signatures and the reference loading values of the training data set under consideration of the matrix influences using multivariate data analysis;
d. computing a standard deviation for predictions provided by the multivariate correlation model from the reference loading values;
e. reiterating step b. to d. until minimal standard deviation for prediction is achieved; and
f. saving the normalizing steps and the trained correlation model with minimal standard deviation as the calibration for multivariate data analysis for the chemical substance to be quantified in the matrix.

11. The computer-implemented method of claim 10, wherein the multivariate correlation model is validated using a method comprising the following steps:
g. acquiring a validation data set comprising a plurality of spectra representative of validation samples and reference loading values measured for the chemical substance in the validation samples, wherein validation samples are either representative for samples collected from a production plant and/or selected by design of experiment to be at the boundaries of the variation room;
h. selecting the calibration for multivariate data analysis characteristic for the chemical substance to be quantified in the matrix;
i. computing prediction values for the loading of the chemical substance in the validation samples using the one or more calibration;
j. computing an average standard deviation between the prediction values for the loading of the chemical substance and the reference loading values measured for the chemical substance in the validation samples; and
k. reiterating step b. to j. in case the average standard deviation for the loading of the chemical substance in the validation samples is out of a predefined range.

12. The computer-implemented method according to claim 10, wherein reference loading values are acquired using chromatographic or gravimetric methods.

13. A system for non-destructive quantification of one or more chemical substances of interest coated on bulk material in a matrix, said matrix being defined by its further coating components and said bulk material, said system comprising:
a memory storing one or more instructions;
a repository storing one or more calibrations, wherein said calibration is specific for the chemical substances to be quantified in the matrix and wherein said calibration comprises conducting spectrum pretreating steps and a multivariate data analysis using a multivariate correlation model trained for computing a loading value of the chemical substance(s) based on a signature spectrum relevant for the chemical substance(s) at stake in consideration of matrix influences; and
one or more processors configured to execute the one or more instructions which, when executed by the one or more processors, cause performance of:
acquiring one or more spectrum representative of the sample, wherein said spectrum is a near-infrared, infrared or a Raman spectrum;
selecting one or more calibration for multivariate data analysis based on the one or more chemical substances to be quantified;
computing the spectrum signature relevant for the chemical substance(s) by way of running the spectrum pretreating steps of the one or more calibration(s) for the one or more spectrum representative of the sample;
computing a loading value of the chemical substance(s) using the correlation model(s) of the one or more calibrations; and
causing displaying on a user interface of the computed loading value of the chemical substance(s).

14. The system according to claim 13, wherein the one or more instructions, when executed by the one or more processors, further cause performance of:
computing a value for comparability between the computed signature spectrum relevant for the chemical substance(s) in the sample and the distribution of signature spectra relevant for the chemical substance(s) from a training data set; and
marking outputted loading values as invalid on the user interface in case the computed value for comparability is out of an acceptable range.

15. The system of claim 13, wherein the one or more instructions, when executed by the one or more processors, further cause performance of:
a. acquiring a training data set comprising a plurality of spectrum representative of training samples and reference loading values measured for the chemical substance in the training samples, wherein the training samples are selected using a method for design of experiments so that the loading values for the chemical substance and matrix parameters are distributed homogeneously within a variation room delimited by its boundaries;
b. normalizing the plurality of spectrum of the training data set by way of at least min-max normalization, first derivation, second derivation, straight line subtraction, offset correction, or a combination thereof and selecting normalized spectrum signatures within the range of interest for the chemical substance;
c. computing a correlation model based on the selected normalized spectrum signatures within the range of interest for the chemical substance and the reference loading values of the training data set under consideration of the matrix parameters using multivariate data analysis,
d. computing a standard deviation for predictions provided by the correlation model to from the reference loading values;
e. reiterating step b. to d. until minimal standard deviation of for prediction is achieved; and
f. saving in the database storing one or more calibrations the normalizing steps and the trained correlation model as a calibration for multivariate data analysis characteristic for the chemical substance to be quantified in the matrix.

16. The system of claim 15, wherein the one or more instructions, when executed by the one or more processors, further cause performance of:
g. acquiring a validation data set comprising a plurality of spectra representative of validation samples and reference loading values measured for the chemical substance in the validation samples, wherein validation samples are either representative for samples collected from a production plant and/or selected by design of experiment to be at the boundaries of the variation room;
h. selecting the calibration for multivariate data analysis characteristic for the chemical substance to be quantified in the matrix from the database storing one or more calibrations;
i. computing prediction values for the loading of the chemical substance in the validation samples using the one or more calibration;
j. computing an average standard deviation between the prediction values for the loading of the chemical substance and the reference loading values measured for the chemical substance in the validation samples; and
k. reiterating step b. to j. in case the average standard deviation for the loading of the chemical substance in the validation samples is out of a predefined range.

17. The system of claim 13, comprising one or more features selected from:
a database for storage of spectroscopic spectra;
a database for storage of results from primary analysis of reference samples;
a database for algorithms for pretreatment of spectra;
a database for storage of calibrations categorized by seed and ingredients in the coatings selected from the group active ingredients; and/or
the one or more processing units configured to cause performance of one or more of the following steps:
a design of experiments for a training data set and/or a validation data set;
averaging the spectra related to the one sample to be analyzed and/or averaging the loading values of the chemical substance(s) computed from the several spectra acquired for the one sample to be analyzed;
conducting a pretreatment of an acquired spectroscopic spectrum according to a selected calibration by way of normalizing and selecting normalized spectrum signatures within a range of interest for the chemical substance;
optimizing the pretreatment and the selected spectral range of interest by way of computing a standard deviation for the computed loading value provided by the multivariate correlation model to the reference loading values and reiterating normalization in case said standard deviation is outside of an acceptable range; and
optimizing preferences for multivariate analysis by way of selecting the main matrix influences for the multivariate analysis.

18. A computer program element for conducting a non-destructive quantification of one or more chemical substances of interest coated on bulk material in a matrix, said matrix being defined by its further coating components and said bulk material, which when executed by a processor is configured to carry out the method of claim 1.

19. A computer program element for provision of a calibration for a chemical substance to be quantified in a matrix, said matrix being defined by its further coating components and said bulk material, which when executed by a processor is configured to carry out the method of claim 10.

20. A non-transitory computer readable medium having stored the computer program element of claim 18.
